(19) United States
(12) Patent Application Publication
(10) Pub. No.: US 2026/0350108 A1
(43) Pub. Date: Nov. 5, 2026

(54) NETWORK SEARCH SYSTEM AND METHOD

(71) Applicant: AMADEUS S.A.S., Biot (FR)

(72) Inventors: Julian TROUBRIDGE, Menton (FR); Annick VANDORPE, Montauroux (FR); Nagesh Subramanya KARTHEEK, Bengaluru (IN); Rahul DABAS, Bengaluru (IN); Valeria GUIOT, Cannes (FR); Matteo DUMONT, Nice (FR)

(21) Appl. No.: 19/490,294

(22) PCT Filed: Jun. 3, 2024
(86) PCT No.: PCT/EP2024/065222

§ 371 Date: Dec. 4, 2025

(30) Foreign Application Priority Data
Jun. 4, 2023 (IN) 202341038322
Dec. 30, 2023 (IN) 202341090067
Apr. 17, 2024 (IN) 202441030876

(51) Int. Cl. G06F 16/9537; G06F 16/9538; G06Q 10/02

(52) U.S. Cl. CPC G06F 16/9537; G06F 16/9538; G06Q 10/02

(57) ABSTRACT

The present specification provides a intermediation engine designed for processing network searches related to travel activities. The engine, equipped with a processor and memory, handles redirect-connections from client devices that access content classified with travel activities on social media platforms. Upon receiving a client device identifier, the engine establishes origin parameters. It also utilizes content classifications to determine destination and activity parameters. Subsequent network searches are conducted for activity-related secondary content and geographically-linked tertiary content from travel actors, based on these parameters. The engine facilitates the generation of a graphical interface on the client device, which displays the combined search results and provides functionality for toggling between the activity-related and travel-actor related content.

### CROSS-REFERENCE TO RELATED APPLICATIONS

The present specification claims priority to Indian Patent Application number 202341038322 titled ‘Method And Apparatus For Providing Interactive Travel Assistance To A User’ filed Jun. 4, 2023; Indian Patent Application number 202341090067 titled ‘Network Search System And Method’ filed Dec. 30, 2023; and Indian Patent Application number 202441030876 titled ‘Network Search System And Method’ filed Apr. 17, 2024. The contents of all of these are incorporated herein by reference.

### FIELD

The present specification relates to a system and methods to optimize complex internet searches involving various content sources.

### BACKGROUND

A common challenge with Internet search is the need to conduct multiple searches for a single search project. For example, when researching travel options, searches regarding destination activities and travel options involve separate queries on different platforms, leading to increased bandwidth usage and substantial computer processing resources. Multiple searches may include navigations through various different websites to gather information about activities at the destination and simultaneously search for corresponding travel arrangements, such as airline flights and accommodation, which can be a cumbersome and inefficient process.

### SUMMARY

An aspect of the specification provides an intermediation engine including: a processor; and a memory storing instructions that, when executed by the processor, configure the intermediation engine to: receive a redirect connection from a client device, wherein the redirect connection is associated with a travel-activity classification of content being generated on the device; receive an identifier of the client device; establish an origin parameter based on the identifier of the client device; establish a destination parameter and an activity parameter based on the travel-activity classification; conduct a first network search for secondary content related to activities, based on the activity parameter and the destination parameter; conduct a second network search for tertiary content from travel actors, where the tertiary content is geographically associated with at least one of the origin parameter and the destination parameter; and, generate a graphical user interface on the client device, combining results from the first network search and the second network search.

An aspect of the specification provides an intermediation engine wherein the processor is further configured to: provide an input selection on the graphical interface to expand on the results of at least one of the first network search and the second network search; the selection for toggling between the secondary content and the tertiary content.

An aspect of the specification provides an intermediation engine wherein the second network search is conducted on a locally connected second intermediation engine.

An aspect of the specification provides an intermediation engine wherein the redirect connection is a selectable uniform resource locator (“URL”) or a QR-code embedding the URL connection.

An aspect of the specification provides an intermediation engine wherein the processor is further configured to store the results of the first network search in a local cache within a point of presence (POP) geographically proximate to the client device.

An aspect of the specification provides an intermediation engine, wherein the results of the first network search are configured to be accessed and utilized by a plurality of different schema generator engines that provide different tertiary content.

An aspect of the specification provides an intermediation engine, wherein the processor is configured to employ different caching strategies based on the geographic proximity of the client device to the nearest point of presence (POP), thereby optimizing response times and reducing bandwidth usage.

An aspect of the specification provides an intermediation engine, wherein the processor is configured to utilize machine learning algorithms to analyze patterns from prior network searches and user interactions, and based on this analysis, dynamically determine and update the content stored in the local cache at the point of presence (POP) to optimize cache relevance and efficiency for anticipated future searches.

An aspect of the specification provides an intermediation engine, wherein the processor is further configured to utilize interaction data from the first network search related to activity-specific content to tailor travel booking options during the second network search.

An aspect of the specification provides an intermediation engine, wherein the processor is configured to parse a uniform resource locator (URL) received via the redirect connection, the URL including multiple path segments that encode data related to the content classification, user demographics, and geographic information, which are utilized to further refine the parameters for the first and second network searches.

An aspect of the specification provides an intermediation engine, wherein the processor is configured to decrypt encrypted path segments of the URL used in the redirect connection to secure the data pertaining to user demographics and content classification during transmission over the network.

An aspect of the specification provides an intermediation engine, wherein the processor is configured to differentiate types of content classifications, including one or more of travel, sports, and cultural activities, and adjust the parameters for network searches based on the specific content type.

An aspect of the specification provides an intermediation engine, wherein the processor is configured to dynamically adapt the graphical interface based on the results of the first and second network searches, including the automatic arrangement of interface elements including tabs, buttons, or sliders, to align the retrieved content characteristics.

An aspect of the specification provides an intermediation engine, wherein the processor utilizes machine learning algorithms to learn from the search results to refine the search parameters and interface layout.

An aspect of the specification provides an intermediation engine, wherein the processor is further configured to: integrate a smell sensor capable of detecting specific scents associated with particular geographic locations, and wherein the redirect connection is based upon detecting a scent which adjusts the destination parameter to suggest travel destinations where the detected scent is prevalent.

An aspect of the specification provides an intermediation engine, wherein the processor is further configured to: receive input from a tactile sensor as part of the redirect connection, the tactile sensor for detecting textures associated with specific geographic locations or cultural artifacts, whereupon detecting a texture, adjusting the destination parameter to suggest travel destinations associated with the detected texture.

An aspect of the specification provides an intermediation engine, wherein the processor is configured to generate an engagement button in association with one or more applications; the engagement button for triggering the redirect connection and the travel-activity classification being derived from the content.

An aspect of the specification provides a computing engine including: a processor; and a memory storing instructions that, when executed by the processor, configure the computing engine to: receive a redirect connection from a client device, wherein the redirect connection is associated with a travel-activity classification; receive an identifier of the client device; establish an origin parameter based on the identifier of the client device; establish a destination parameter and an activity parameter based on the travel-activity classification of the content; conduct a first network search for secondary content related to activities, based on the activity parameter and the destination parameter; conduct a second network search for tertiary content from travel actors, where the tertiary content is geographically associated with at least one of the origin parameter and the destination parameter; generate a graphical user interface on the client device, combining results from the first network search and the second network search.

An aspect of the specification provides a computing engine wherein the processor is further configured to: provide an input selection on the graphical interface to expand on the results of at least one of the first network search and the second network search; the selection for toggling between the activities and the travel-actor options.

An aspect of the specification provides a computing engine wherein the second network search is conducted on a locally connected second computing engine.

An aspect of the specification provides a computing engine wherein the redirect connection is a selectable uniform resource locator (“URL”) or a QR-code embedding the URL connection.

An aspect of the specification provides a computing engine, wherein the processor is further configured to store the results of the first network search in a local cache within a point of presence (POP) geographically proximate to the client device.

An aspect of the specification provides a computing engine, wherein the results of the first network search are configured to be accessed and utilized by a plurality of different schema generator engines that provide different tertiary content.

An aspect of the specification provides a computing engine, wherein the processor is configured to employ different caching strategies based on the geographic proximity of the client device to the nearest point of presence (POP), thereby optimizing response times and reducing bandwidth usage.

An aspect of the specification provides a computing engine, wherein the processor is configured to utilize machine learning algorithms to analyze patterns from prior network searches and user interactions, and based on this analysis, dynamically determine and update the content stored in the local cache at the point of presence (POP) to optimize cache relevance and efficiency for anticipated future searches.

An aspect of the specification provides a computing engine, wherein the processor is further configured to utilize interaction data from the first network search related to activity-specific content to tailor travel booking options during the second network search.

An aspect of the specification provides a computing engine, wherein the processor is configured to parse a uniform resource locator (URL) received via the redirect connection, the URL including multiple path segments that encode data related to the content classification, user demographics, and geographic information, which are utilized to further refine the parameters for the first and second network searches.

An aspect of the specification provides a computing engine, wherein the processor is configured to decrypt encrypted path segments of the URL used in the redirect connection to secure the data pertaining to user demographics and content classification during transmission over the network.

An aspect of the specification provides a computing engine, wherein the processor is configured to differentiate types of content classifications, including one or more of travel, sports, and cultural activities, and adjust the parameters for network searches based on the specific content type.

An aspect of the specification provides a computing engine, wherein the processor is configured to dynamically adapt the graphical interface based on the results of the first and second network searches, including the automatic arrangement of interface elements including tabs, buttons, or sliders, to align the retrieved content characteristics.

An aspect of the specification provides a computing engine, wherein the processor utilizes machine learning algorithms to learn from the search results to refine the search parameters and interface layout.

An aspect of the specification provides a computing engine, wherein the redirect connection leads to a travel bureau platform, an airline, a hotel, or an online travel agency.

An aspect of the specification provides a computing engine including: a processor and a memory for storing instructions executable on the processor; the processor configured to: receive a redirect-connection originating from client device accessing a social media content platform; the redirect-connection responsive to social media content hosted on the platform having a travel-activity classification; receive an identifier of the client device; establish a first origin parameter based on the identifier; establish a second destination parameter based on the classification; establish a third activity parameter based on the classification; conducting a first network search for activity secondary content based on the second parameter and the third parameter; conducting a second network search for travel-actor tertiary content. The travel-actor tertiary content can include travel-actor options such as flight offers; hotels; and rental cars. The tertiary content can be geographically linked to one or more of the first parameter, the second parameter and the third parameter. The processor is further configured to generate, on the client device, a graphical interface combining results from the first network search and the second network search.

An aspect of the specification provides a computing engine wherein the processor is further configured to: provide an input selection on the graphical interface to expand on the results of at least one of the first network search and the second network search. The first network search can include activities and the second network search can include airline or hotel booking options. The option is provided to toggle between the two searches.

An aspect of the specification provides a computing engine wherein the second network search is conducted on a locally connected second computing engine.

An aspect of the specification provides a method of providing interactive travel assistance to a user. The method may comprise dynamically displaying a travel button over a media item based on one or more predefined criteria, wherein the media item comprises an image or a video of at least one travel destination. The method may also comprise receiving an input selection of the travel button, and rendering a plurality of selectable overlays over the media item in response to the selection of the travel button, wherein the plurality of the selectable overlays are associated with the at least one travel destination. The method may further comprise receiving an input selection of a selectable overlay from the plurality of selectable overlays and generating travel assistance content information corresponding to the selected overlay. Further, the method may comprise presenting the travel assistance content information to the user for planning travel to the at least one travel destination. The travel assistance content information is generated based at least in part on a profile of the user.

An aspect of the specification provides displaying a travel button over a media item based on one or more predefined criteria comprises determining whether the media item is an authenticated media item; and displaying the travel button on the media item in response to the determination that the media item is the authenticated media item.

Another aspect of the specification provides displaying a travel button over a media item based on one or more predefined criteria comprises displaying the travel button on the media item based on engagement of the user with the media item.

Another aspect of the specification provides displaying a travel button over a media item based on one or more predefined criteria comprises determining whether the media item is an authenticated media item, determining engagement of the user with the media item in response to the determination that the media item is the authenticated media item, and displaying the travel button on the media item based on the engagement of the user with the media item.

Another aspect of the specification provides displaying a travel button over a media item based on one or more predefined criteria comprises determining whether the media item is matching with the profile of the user and displaying the travel button on the media item in response to the determination that the media item is matching with the profile of the user.

Another aspect of the specification provides displaying a travel button over a media item based on one or more predefined criteria comprises: determining whether the media item is an authenticated media item, determining whether the media item is matching with the profile of the user in response to the determination that the media item is the authenticated media item, and displaying the travel button on the media item in response to the determination that the media item is matching with the profile of the user.

Another aspect of the specification provides the method further coprises receiving one or more inputs indicative of one or more actions performed by the user on the travel assistance content information corresponding to the selected overlay, and dynamically generating travel assistance content information corresponding to at least one of the plurality of selectable overlays other than the selected overlay based on the one or more actions performed by the user.

Another aspect of the specification provides displaying the media item on a computing device based on one or more of: the profile of the user; one or more search requests from the user; and geo-coordinates of the user.

Another aspect of the specification provides in response to the one or more actions performed by the user on the travel assistance content information corresponding to the selected overlay: dynamically updating the profile of the user based on the one or more actions performed by the user on travel assistance content information corresponding to the selected overlay.

Another aspect of the specification provides the method further comprises dynamically updating the profile of the user based on activities performed by the user on one or more digital platforms.

In yet another non-limiting embodiment of the present disclosure, each of the plurality of selectable overlays associated with the at least one travel destination is a hyperlink corresponding to a category selected from a group comprising: dining and cuisine, attractions and activities, accommodation, shopping, transportation, and travel period.

Another aspect of the specification provides generating travel assistance content information corresponding to the selected overlay: fetching information available for the selected overlay from one or more information servers via a universal travel adaptor, and determining the travel assistance content information from the available information based on the profile of the user.

In another aspect of the specification the profile of the user comprises one or more of: interests and/or preferences of the user, travel history of the user, web history of the user, profile of the user on digital platforms, interactions of the user with digital platforms, emotional and/or sentimental profile of the user, demographic details of the user and personal data of the user stored on one or more computing devices.

In yet another non-limiting embodiment of the present disclosure, rendering a plurality of selectable overlays comprises fetching the plurality of selectable overlays from a predefined list of selectable overlays.

In yet another non-limiting embodiment of the present disclosure, rendering a plurality of selectable overlays comprises dynamically generating the plurality of selectable overlays based on the profile of the user and/or the at least one travel destination.

Another aspect of the specification provides an apparatus for providing interactive travel assistance to a user. The apparatus may comprise a processor configured to: dynamically display a travel button over a media item based on one or more predefined criteria, wherein the media item comprises an image or a video of at least one travel destination. The processor is configured to receive an input selection of the travel button; render a plurality of selectable overlays over the media item in response to the selection of the travel button, wherein the plurality of the selectable overlays is associated with the at least one travel destination. The processor is also configured to receive an input selection of a selectable overlay from the plurality of selectable overlays. The processor is further configured to generate travel assistance content information corresponding to the selected overlay and present the travel assistance content information to the user for planning travel to the at least one travel destination. The travel assistance content information is generated based at least in part on a profile of the user.

Another aspect of the specification provides to display a travel button over a media item based on one or more predefined criteria, the processor is configured to: determine whether the media item is an authenticated media item; and display the travel button on the media item in response to the determination that the media item is the authenticated media item.

Another aspect of the specification provides to display a travel button over a media item based on one or more predefined criteria, wherein the processor is configured to: display the travel button on the media item based on engagement of the user with the media item.

Another aspect of the specification provides to display a travel button over a media item based on one or more predefined criteria, wherein the processor is configured to: determine whether the media item is an authenticated media item; determine engagement of the user with the media item in response to the determination that the media item is the authenticated media item; and display the travel button on the media item based on the engagement of the user with the media item.

Another aspect of the specification provides to display a travel button over a media item based on one or more predefined criteria, wherein the processor is configured to: determine whether the media item is matching with the profile of the user; and display the travel button on the media item in response to the determination that the media item is matching with the profile of the user.

Another aspect of the specification provides to display a travel button over a media item based on one or more predefined criteria, wherein the processor is configured to: determine whether the media item is an authenticated media item; determine whether the media item is matching with the profile of the user in response to the determination that the media item is the authenticated media item; and display the travel button on the media item in response to the determination that the media item is matching with the profile of the user.

Another aspect of the specification provides the processor is further configured to: receive one or more inputs indicative of one or more actions performed by the user on the travel assistance content information corresponding to the selected overlay; and dynamically generate travel assistance content information corresponding to at least one of the plurality of selectable overlays other than the selected overlay based on the one or more actions performed by the user.

Another aspect of the specification provides the processor is further configured to: display the media item on a computing device based on one or more of: the profile of the user; one or more search requests from the user; and geo-coordinates of the user.

Another aspect of the specification provides in response to the one or more actions performed by the user on the travel assistance content information corresponding to the selected overlay, the processor is configured to: dynamically update the profile of the user based on the one or more actions performed by the user on travel assistance content information corresponding to the selected overlay.

Another aspect of the specification provides the processor is further configured to: dynamically update the profile of the user based on activities performed by the user on one or more digital platforms.

In yet another non-limiting embodiment of the present disclosure, each of the plurality of selectable overlays associated with the at least one travel destination is a hyperlink corresponding to a category selected from a group comprising: dining and cuisine, attractions and activities, accommodation, shopping, transportation, and travel period.

Another aspect of the specification provides to generate travel assistance content information corresponding to the selected overlay, wherein the processor is configured to: fetch information available for the selected overlay from one or more information servers via a universal travel adaptor; and determine the travel assistance content information from the available information based on the profile of the user.

Another aspect of the specification provides the profile of the user comprises one or more of: interests and/or preferences of the user, travel history of the user, web history of the user, profile of the user on digital platforms, interactions of the user with digital platforms, emotional and/or sentimental profile of the user, demographic details of the user and personal data of the user stored on one or more computing devices.

In yet another non-limiting embodiment of the present disclosure, to render a plurality of selectable overlays, the processor is configured to: fetch the plurality of selectable overlays from a predefined list of selectable overlays.

In yet another non-limiting embodiment of the present disclosure, to render a plurality of selectable overlays, the processor is configured to: dynamically generate the plurality of selectable overlays based on the profile of the user and/or the at least one travel destination.

Another aspect of the specification provides an apparatus for providing interactive travel assistance to a user. The apparatus comprises means for dynamically displaying a travel button over a media item based on one or more predefined criteria, wherein the media item comprises an image or a video of at least one travel destination. The apparatus further comprises means for receiving an input selection of the travel button and means for rendering a plurality of selectable overlays over the media item in response to the selection of the travel button, wherein the plurality of the selectable overlays are associated with the at least one travel destination. The apparatus also comprises means for receiving an input selection of a selectable overlay from the plurality of selectable overlays. The apparatus further comprises means for generating travel assistance content information corresponding to the selected overlay and means for presenting the travel assistance content information to the user for planning travel to the at least one travel destination. The travel assistance content information is generated based at least in part on a profile of the user.

In yet another non-limiting aspect of the present disclosure, a method of providing interactive travel assistance to a user is disclosed. The method comprises dynamically displaying a travel button over a media item based on one or more predefined criteria. The media item comprises an image or a video of at least one travel destination. The method also comprises receiving an input selection of the travel button and rendering a plurality of selectable overlays over the media item in response to the selection of the travel button. Each of the plurality of selectable overlays is configured to provide distinct travel assistance content information related to the at least one travel destination for assisting the user in planning travel to the at least one travel destination. The distinct travel assistance content information is provided based at least in part on a profile of the user.

In yet another non-limiting aspect of the present disclosure, a computer-readable medium storing instructions to perform the steps of any one of the foregoing when executed on a computer, is disclosed.

### BRIEF DESCRIPTION OF THE FIGURES

FIG. 1 is a schematic diagram of a system for network searching.

FIG. 2 shows an example structure of the identifier objects of FIG. 1.

FIG. 3 is a block diagram of example internal components of the computing network optimization of FIG. 1.

FIG. 4 shows a flowchart depicting a method for network searching.

FIG. 5 shows a first short form video content 122-1 on a device from FIG. 1.

FIG. 6 shows a second short form video content 122-1 on a device from FIG. 1.

FIG. 7 shows a third short form video content 122-1 on a device from FIG. 1 including a redirect token.

FIG. 8 shows the system of FIG. 1 which shows a first connection between a device and one of the content platforms.

FIG. 9 shows a personally identifiable information authorization-dialogue.

FIG. 10 shows the first network search results from the method of FIG. 4 in a screen that allows toggling to the second network search results.

FIG. 11 is a variant on FIG. 10.

FIG. 12 is a variant on FIG. 10.

FIG. 13 is a variant on FIG. 10.

FIG. 14 is a variant on FIG. 10.

FIG. 15 is a variant on FIG. 10.

FIG. 16 shows the second network search results from the method of FIG. 4 in a screen that allows toggling to the first network search results.

FIG. 17 is a variant on FIG. 16.

FIG. 18 is a variant on FIG. 16.

FIG. 19 is a variant on FIG. 16.

FIG. 20 is a variant on FIG. 16.

FIG. 21 is a variant on FIG. 16.

FIG. 22 shows a variant on the system of FIG. 1.

FIG. 23 shows an example of a Traveler Centric Platform facilitating a harmonized data collection process.

FIG. 24 shows an example of various decision points for personalization on a platform.

FIG. 25 shows another example of a variant on the system of FIG. 1 and FIG. 22.

FIG. 26 shows a process flow when a device is used to access content.

FIG. 27 shows another variant on the system of FIG. 1.

FIG. 28, FIG. 28A, FIG. 28B and FIG. 28C showcases the accommodation selection process based on user preferences.

FIG. 29 shows a more detailed view of the “Explore” pathway from FIG. 28.

FIG. 30 shows two smartphone screens or displays that can be used on client devices.

FIG. 31 expands on the example of the “About” flow from FIG. 28.

FIG. 32 presents a sequence of four smartphone screens, expanding on the “Accommodation” flow from FIG. 28.

FIG. 33 illustrates four screens within the mobile application flow from FIG. 28, focusing on the selection and personalization of activities.

FIG. 34 displays a set of smartphone screens that illustrate different user interface (UI) elements for client devices and their functionality within a mobile application flow.

FIG. 35 illustrates screens for client devices that can include some “Flight” options within the “Explore” tab.

FIG. 36 displays three smartphone screens that depict various methods for configuring user preferences within a mobile application interface for client devices.

FIG. 37 presents four smartphone screens, each depicting a stage in the user journey within a travel application.

FIG. 38 shows a variant on the redirect token from FIG. 7.

FIG. 39 shows a variant on the system of FIG. 1.

FIG. 40 shows a detailed example of a redirect token.

FIG. 41 illustrates a sequence of smartphone screens that can be shown at block 440 of method 400.

FIG. 42 illustrates a sequence of smartphone screens that can be shown at block 440 of method 400.

FIG. 43 illustrates a sequence of smartphone screens that can be shown at block 440 of method 400.

FIG. 44 illustrates a smartphone screen that can be shown at block 440 of method 400.

FIG. 45 illustrates a sequence of smartphone screens that can be shown at block 440 of method 400.

FIG. 46 illustrates a sequence of smartphone screens that can be shown at block 440 of method 400.

FIG. 47 illustrates a sequence of smartphone screens that can be shown at block 444 of method 400.

FIG. 48 illustrates a network system for providing interactive travel assistance to a user in accordance with another embodiment of the present disclosure.

FIG. 49 illustrates a block diagram of the computing device of FIG. 48.

FIGS. 50-55 illustrate an interface providing interactive travel assistance to a user in accordance with various embodiments of the present disclosure.

FIG. 56 illustrates a flowchart of a method of providing interactive travel assistance to a user in accordance with various embodiments of the present disclosure.

### DETAILED DESCRIPTION

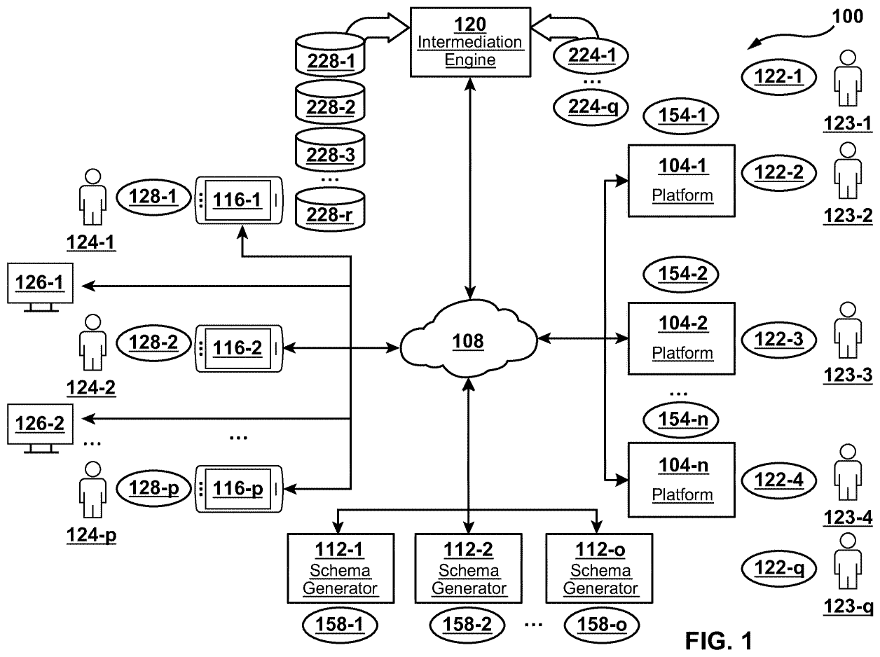

FIG. 1 shows a system for network search indicated generally at 100. System 100 comprises a plurality of content propagation platforms 104-1, 104-2 104-n. (Collectively, platforms 104-1, 104-2 . . . 104-n are referred to as platforms 104, and generically, as platform 104. This nomenclature is used elsewhere herein.) In system 100, platforms 104 connect to a network 108 such as the Internet. Network 108 interconnects content propagation platforms 104 with: a) a plurality of travel schema generators 112; b) a plurality of client devices 116; and, c) an intermediation engine 120. As will be discussed further below, intermediation engine 120 optimizes computing network resources and performs a number of processing functions on system 100.

Platforms 104 can be based on any present or future electronic media servers that publish primary content 122 for client devices 116. Each piece of content 122 can be generated by a respective content creator 123.

Client devices 116 can be any type of human-machine interface for interacting with platforms 104 and schema generators 112. For example, client devices 116 can include traditional laptop computers, desktop computers, mobile phones, tablet computers and any other device that can be used to receive content 122 via one or more of the platforms 104 that complement the input and output hardware devices associated with a given client device 116. It is contemplated that client devices 116 can include virtual or augmented reality gear complementary to virtual reality or augmented reality or “metaverse” environments that can be offered on content propagation platforms 104. Client devices 116 can be operated by different users 124 that are associated with a respective identifier object 128 that uniquely identifies a given user 124 accessing a given client device 116 in system 100.

One or more televisions 126 (or other display units, such as monitors or laptop computer screens) that are accessible to one or more users 124 may also be part of system 100.

In a present example embodiment, platforms 104 can be based on media platforms that carry primary content 122 for direct consumption by users 124 at client devices 116. Primary content 122 may be exclusive to one platform 104 or may be available across different platforms 104.

To elaborate, content propagation platforms 104 can be based on social media ecosystems such as, TikTok™, Instagram™, Facebook™ or the like which host primary content 122. Platforms 104 may embed their own secondary content (e.g. advertising of products or services available from schema generators 112) intended to divert a given client device 116 from the content propagation platform 104 towards a target platform in the form of a schema generator 112. Content propagation platforms 104 can also be based on ecosystems such as Google™, that include primary content 122 delivered via YouTube™, Google™ Maps, Google™ Search, Google™ News, while also embedding secondary content intended to direct traffic to schema generators 112. Content propagation platforms 104 can be based on television networks such as Cable News Network (CNN™), the British Broadcasting Corporation (BBC™) to name but a few of the many hundreds of television networks across the globe. Thus, primary content 122 can also be provided by content propagation platforms 104 that offer web pages, games, books, news, search results, social media posts, audio files, video files, movies, television programs such as drama series, news casts, talk shows, and the like. Content propagation platforms 104 may include tourism bureaus or destination marketing organizations. The nature of content propagation platforms 104 is thus not particularly limited. In other variants, the primary content 122 can be provided as a text message or a direct message or an email message between users 124.

Travel actors can broadly encompass different categories of all types of travel service offerings including transportation-actors; accommodation-actors and travel-activity actors. Transportation-actors can provide transportation services for users 124, such as airlines, rental car agencies, rail services, ferries, and bus lines. Accommodation-actors can provide lodging for users 124, such as hotels, vacation rentals, resorts and B&Bs (“Bed and Breakfasts”), including the lodging at the location where a user 124 arrives after receiving a transportation service. Travel-activity actors can include providers of activities near the location where a user 124 is lodging. Travel-activity actors can thus include, by way of non-limiting examples, restaurants, spas, concert venues, exhibition centers, summits, sporting event venues, fairs, conference venues, sporting arenas, museums, art galleries, tours and resort activity centers and the like.

According to the specific illustrative example discussed further below, schema generators 112 may focus on platforms 104 that transmit content 122 of interest to users 124 who are also travelers.

As will be discussed in greater detail below, according to certain embodiments, intermediation engine 120 is configured to provide secondary content in the form of a digital redirect token that is based on content 122.

Schema generators 112 can thus be part of e-commerce travel booking platforms that aggregate travel services such as Kayak,™ Expedia™, Priceline™, Orbitz™, Booking.com™ and/or concern individual travel actors such as airlines, railways, hotels, car rental agencies, restaurants, museums, etc, suitably modified to accommodate the teachings herein, with, for example, appropriate application programming interfaces (APIs).

In some embodiments, a fully-costed travel schema can be built and include payment processing. When user 124 selects the digital redirect token generated on content propagation platform 104, it provides the opportunity to complete an electronic transaction. Such a transaction can exchange electronic payment messages from a financial account linked with user identifier object 128, for electronic schema fulfillment messages. These latter messages denote a complete travel schema (or other service) tied to one or more user identifier objects 128 for use by associated user 124. This example may be referred to as “travel schema fulfillment” or “complete travel schema fulfillment” or variants thereon according to context. When the embodiments herein are applied beyond travel itineraries, “travel schema fulfillment” may be seen more broadly as “service offering fulfillment”, where service offerings may include other complete offerings, such as travel packages of flights plus hotel, admission tickets to concerts or other travel-related activities.

A full travel schema can be built upon the travel schema blueprint, based on a set of generalized schema parameters, allowing a multitude of specific travel itineraries to be chosen. For instance, the generalized schema parameters may be linked to a specific destination. The selection of transportation, accommodation, and/or activities may then dynamically vary based on the demographic information associated with identifier object 128. This demographic data and a set of proposed dates consistent with the access time of the digital redirect token are matched with offerings from various transportation providers for the chosen destination.

Digital redirect tokens and travel itineraries will be discussed in greater detail below.

Accordingly, client devices 116 are based on any suitable client computing platform operated by users 124 that may have an interest in the content 122 being provided on platforms 104 and the travel services being offered on schema generators 112. Each device 116 and its user 124 is thus associated with a user identifier object 128.

A person of skill in the art is to recognize that the form of an identifier object 128 is not particularly limited, and in a simple example embodiment, can be simply an alpha-numerical sequence that is unique in relation to other identifier objects in system 100. Identifier objects can also be more complex as they may be combinations of account credentials (e.g. user name, password, two-factor authentication token, etc.) that uniquely identify a given user 124. Identifier objects themselves may also be indexes that point to other identifier objects, such as accounts. The salient point is that they are uniquely identifiable within system 100 in association with what they represent.

Users 124 are typically individuals but may be corporate entities. Such users 124 interact, via devices 116, with both content propagation platforms 104 as well as schema generators 112. Each user identifier object 128 can be used by other nodes in system 100, including content propagation platforms 104, schema generators 112 and intermediation engine 120 to track, amongst other things: a) traffic flows between a given client device 116 and various content propagation platforms 104, including interactions (impressions as well as diversions) with a given advertising campaign; b) traffic flows between a given client device 116 and a given schema generator 112; c) diversions of traffic originated by a given client device 116 from a given content propagation platform 104 to a given schema generator 112; and d) travel-schema fulfillments arising from selection of digital redirect tokens.

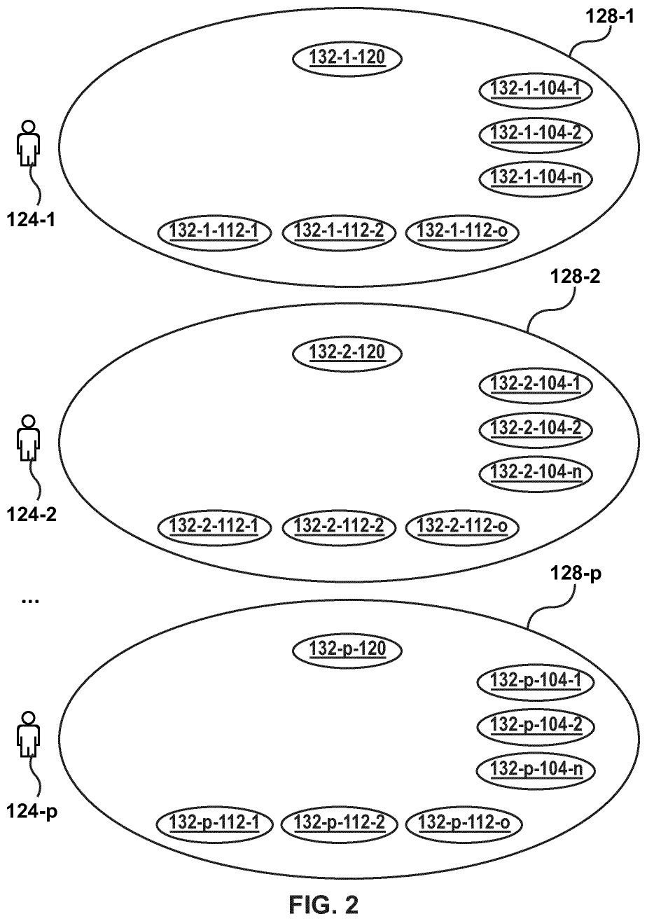

FIG. 2 shows a non-limiting example of how user identifier objects 128 can be implemented as a plurality of user identifier sub-objects 132. User identifier sub-objects 132 follow the nomenclature 132-X-Y where X corresponds to reference for a corresponding user 124 and Y corresponds to the reference for a corresponding node in system 100. (This nomenclature builds on the earlier-discussed nomenclature, since user identifier objects are referred to collectively as user identifier objects 128 and generically as user identifier object 128.) To elaborate, sub-objects 132-1-Y refer to user 124-1; sub-objects 132-2-Y refer to user 124-2; sub-objects 132-p-Y refer to user 124-p. Sub-object identifier 132-1-120 refers to the identifier for user 124-1 for intermediation engine 120. Sub-object identifier 132-1-104-1 refers to the identifier for user 124-1 for platform 104-1. Sub-object identifier 132-1-104-2 refers to the identifier for user 124-1 for platform 104-2. This nomenclature repeats for all identifier sub-objects 132 for each user 124, across each content propagation platform 104 and each schema generator 112.

Sub-objects 132 may be provided to anonymize, for privacy purposes, the specific identity (i.e. personally identifying information or PII) of the associated user 124. Some or all of those identifier sub-objects 132 may be anonymous or private to certain nodes in system 100 while being non-private to other nodes. For example, the operator of a schema generator 112 may maintain an account (a form of consumer identifier sub-object 132-X-112) respective to each user 124-X that expressly identifies the user 124-X to handle delivery and payment processing of a given purchased good or service, such as a ticket or voucher or a for a travel service. At the same time, the operator of content propagation platform 104 need not expressly identify a given user 124 in order to fulfill its function of associating content 122 with digital redirect tokens, but can instead rely upon generic demographic information respective to the user 124-X that can be configured to permit targeting of a digital redirect token to a given client device 116 while respecting the individual anonymity of the user 124-X of the client device 116.

For clarity in explaining specific embodiments, a single user identifier object 128 may be referenced for each user 124. However, those skilled in the art will understand that in certain contexts, references to identifier object 128 within system 100 could instead imply the use of a user identifier sub-object 132. Similarly, this contextual complexity showcases a technical advantage of the current specification. It becomes evident upon further reading that the diverse and often anonymous nature of identifier sub-objects 132 complicates load balancing of system 100. This challenge is mitigated by the techniques outlined in this specification.

In addition to the sub-objects 132 in FIG. 2, other techniques may be used to track diversions from platforms 104, including IP address tracking, pixels, HTTP tags, and various anonymization techniques may be applied to help protect PII such as data masking, pseudonymization, data aggregation, differential privacy and data generalization. Where required or desired, specific consent can also be requested from the relevant user 124.

Referring again to FIG. 1, persons skilled in the art will recognize that there are many different types of interactions between client devices 116 accessing platforms 104, and that there are many different ways such interactions may lead to diversions that cause a given client device 116 to access schema generator 112. The present specification elaborates further below on certain inventive embodiments for effecting such diversions.

It is contemplated that each content propagation platform 104 has a content propagation-reporting application 154 stored in non-volatile storage of the respective platform 104 and executable on its processor. The content propagation-reporting application 154 can be accessed by intermediation engine 120 to track the number of impressions and/or redirects (aka diversions) (if any) from the respective content propagation platform 104 to schema generator 112 that are associated with each user identifier object 128. The content propagation-reporting application 154 can also be used to track queries or search for a given identifier object 128 (or a given sub-object identifier 132-X-104) or the types of content 122 being accessed on the platform 104. For example, repeated searches for a travel destination for an activity at a travel destination may be recorded in application 154 for later access by intermediation engine 120 and/or content propagation platform 104 to host content 122 and/or secondary content and/or digital redirect tokens relevant to that destination.

It is contemplated that schema generators 112 also include a target-reporting application 158 stored in non-volatile storage and executable on their processors. The target-reporting application 158 can track the various stages of the sales funnel experience for a user 124 via their respective identifier object 128. Target-reporting applications 158 can also maintain historical and future travel itineraries for each identifier object 128. Notably, repeated access of the same digital redirect token by the same user 124 may allow that user 124 to resume where they left off in the sales funnel experience.

It is also contemplated that intermediation engine 120 can be configured to store a plurality of applications 224 and datasets 228. As will be discussed further below, datasets 228 can include a demographic information dataset 228-1, which can include demographic information for each user 124 by association with their respective identifier object 128. Demographic information can include any information that identifies a given user 124 that can assist in building travel itineraries tailored to that user. An example dataset is shown below for user 124-1.

Sample Demographic Information for User
124-1 (For Storage in Dataset 228-1)

| | User Identifier | | |
|---|---|---|---|
| User | Object | Field | Data |
| 124-1 | 128-1 | Name | Elias Fakénamê |
| | | Age | 37 |
| | | Residence City | Tokyo |
| | | Interests | Historic Sites |
| | | Last Travel | Osaka |
| | | Destination | |
| | | Languages | English |

Additional demographic information for all users 124 can be provided in dataset 228-1. Additional, fewer or different fields may be included. Encryption and/or anonymization and/or security and/or consent mechanisms may be added to dataset 228-1 to protect personally identifiable information (PII).

Intermediation engine 120 can also be configured to generate reports based on: a) the reports from each content propagation-reporting application 154; in combination with b) reports from target-reporting application 158. Such reports thereby simplify the process of comparing the relative progress through the sales funnel experience, including actual sales conversions, associated with a given advertising campaign on each content propagation platform 104 for a respective product. In turn, the normalized reports can be used to adjust digital redirect tokens and/or control which content 122 is associated with which digital redirect tokens, thereby reducing or eliminating wasted delivery (and associated waste of communication and other computing networks) of digital redirect tokens from content propagation platforms 104 that do not result in diversions to platforms 104 and/or do not result in completion of travel bookings on schema generators 112.

Intermediation engine 120 can also be configured to access content propagation-reporting applications 154 to note, in the aggregate, top impressions of different content 122 by users 124.

Such reports can also be used in the generation of digital redirect tokens, and respective travel itineraries and generalized schema parameters, including the potential use of machine learning, as will be discussed in greater detail below.

Intermediation engine 120 can also be configured to access target-reporting applications 158 to update demographic information dataset 228-1 with account identifier objects 128 associated their respective users 124. Where management of personally identifiable information (PII) is included in system 100, then if permission is granted by a user 124 then intermediation engine 120 may specifically identify a given user 124; or if no permission is granted, then intermediation engine 120 may only access meta-results such as generalized demographic data for the user 124.

(Other means of implementing the functionality of applications 154 and applications 158 will occur to those of skill in the art. For example, where a global distribution system (GDS) such as Amadeus is part of system 100, then Passenger Name Records (PNR) for each user 124 may be recorded for past trips as part of their demographic information within dataset 228-1, and PNRs that are generated for itineraries that are created according to the present teachings can be recorded by the GDS and made directly available to engine 120, without the need for involving applications 154 or applications 158. At this point it can be noted that engine 120 itself can be incorporated directly into a GDS.)

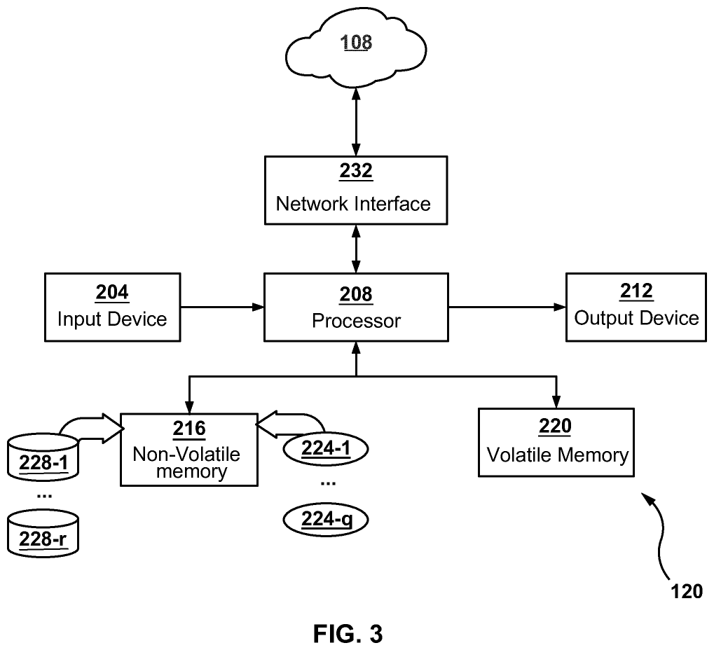

Having described an overview of system 100, it is useful to comment on the hardware infrastructure of system 100. FIG. 3 shows a schematic diagram of a non-limiting example of internal components of intermediation engine 120. The intermediation engine 120 is named for its role in facilitating communications between various other nodes of system 100, and thus can also be referred to more generically as a computing engine.

In this example, intermediation engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable medium. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or datasets 228 are maintained in non-volatile memory 216 for use by applications 224.

The infrastructure of intermediation engine 120, or a variant thereon, can be used to implement any of the computing nodes in system 100, including platforms 104 and schema generators 112. Furthermore, intermediation engine 120, platforms 104 and schema generator 112 may also be implemented as virtual machines and/or with mirror images to provide load balancing. Functions of intermediation engine 120 may also be distributed amongst or combined with different schema generators 112 and/or platforms 104, thereby obviating the need for a centralized intermediation engine 120. By the same token, a plurality of engines 120 may be provided.

Furthermore, a person of skill in the art will recognize that the core elements of processor 208, input device 204, output device 212, non-volatile memory 216, volatile memory 220 and network interface 232, as described in relation to the server environment of intermediation engine 120, have analogues in the different form factors of client machines such as those that can be used to implement client devices 116. Again, client devices 116 can be based on computer workstations, laptop computers, tablet computers, mobile telephony devices or the like.

Likewise, televisions 126 can be based on architectures analogous to the architecture of intermediation engine 120, and televisions 126 can be Smart TVs, desktop computer monitors, laptop monitors and any other device otherwise capable of displaying content 122.

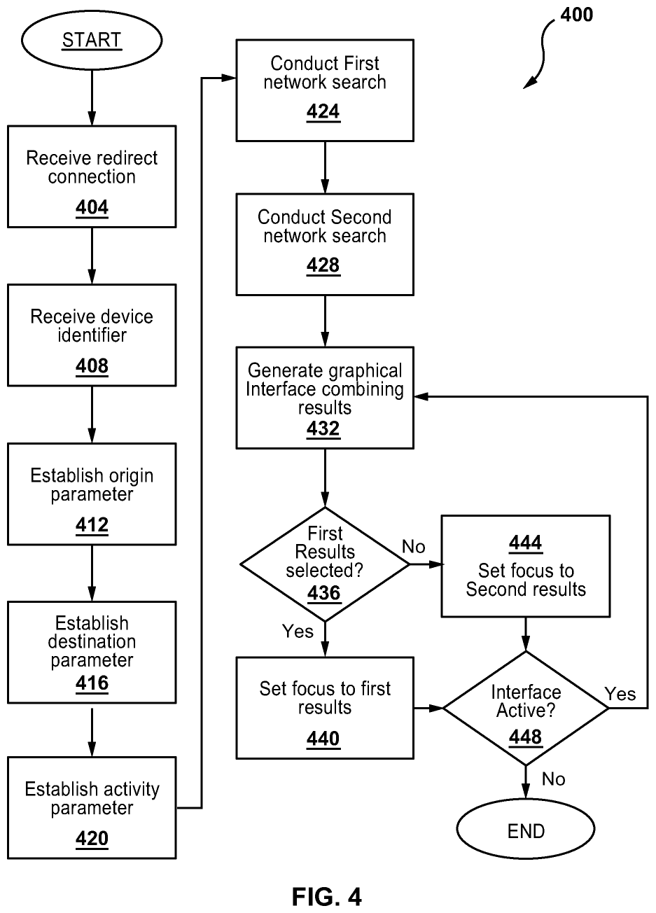

FIG. 4 shows a flowchart depicting a method for network search indicated generally at 400. Method 400 can be implemented on system 100. Persons skilled in the art may choose to implement method 400 on system 100 or variants thereon, or with certain blocks omitted, performed in parallel or in a different order than shown. Method 400 can thus also be varied. However, for purposes of explanation, method 400 will be described in relation to its performance on system 100 with a specific focus on treating method 400 as, for example, application 224-1 can be maintained within and executed by intermediation engine 120, interacting with other nodes in system 100.

Block 404 thus comprises receiving a redirection connection. According to an illustrative example, the redirection connection is received at intermediation engine 120. The redirection connection can be from a client device 116 accessing content 122 on one of the content propagation platforms 104. Content 122 can include a link or other redirect token that can be accessed on client device 116 from within the content 122 and which causes the browser or whatever application is being used by device 116 to connect to intermediation engine 120.

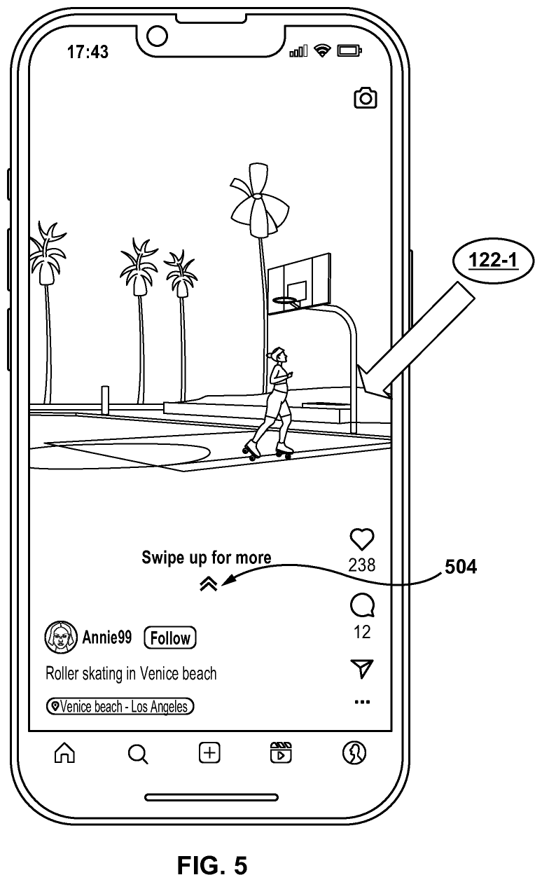

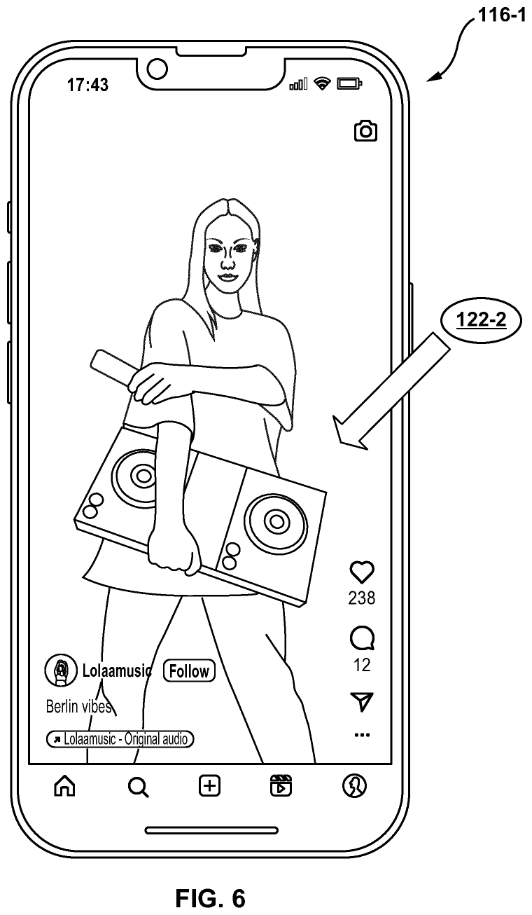

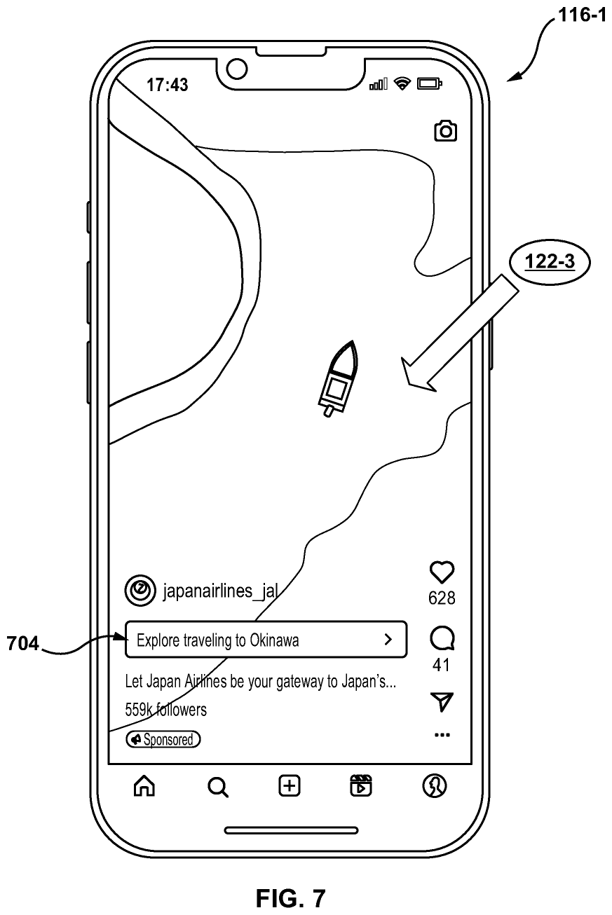

Example performance of block 404 is shown across FIG. 5, FIG. 6 and FIG. 7. It is to be understood that in the context of system 100 and method 400, the type of content 122 is not particularly limited. However, according to the illustrative example in FIG. 5, FIG. 6 and FIG. 7, it is contemplated that short-form videos are being shown, such as one might find on TikTok™. Accordingly, it can be assumed that content propagation platforms 104-1 is showing short-form videos and that content is being accessed on device 116-1 by user 124-1. FIG. 5 shows a first short form video content 122-1 on device 116-1, which includes a swipe-control 504 that can be activated on device 116-1 to advance to the next content 122. FIG. 6 assumes that the swipe-control 504 on FIG. 5 has been activated and thus second short form video content 122-2 is now being shown on device 116-1. The label for Swipe-control 504 is now hidden in FIG. 6, but is still available. FIG. 7 assumes that the swipe-control 504 (not shown in FIG. 6) has been activated and thus third short form video content 122-3 is now being shown on device 116-1.

Notably, content 122-3 includes a short video depicting ocean activities off the coast of Okinawa, Japan and also includes a redirect token 704 which invites user 124-1 to “Explore travelling to Okinawa”.

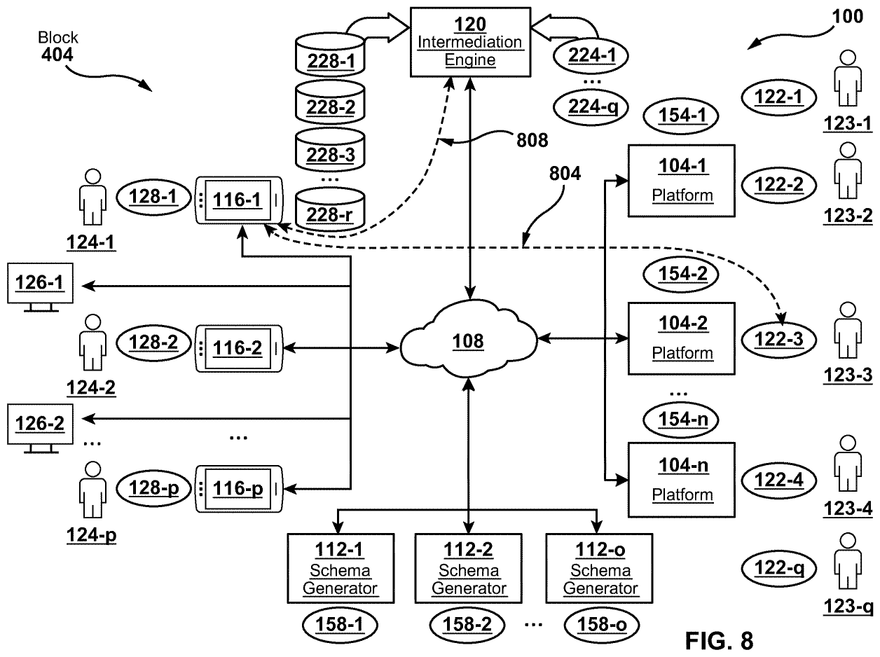

Thus, as part of example performance of block 404, it is assumed that token 704 is accessed and thus a connection between device 116-1 and engine 120 is established. Performance of block 404 is represented in FIG. 8 which shows a first connection 804 between device 116-1 and platform 104-1 accessing content 112-3. Activation of token 704 leads to the redirection of device 116-1 and results in a second connection 808 being established between device 116-1 and engine 120. The redirection connection can thus be associated with a travel-activity classification of content being generated on the client device 116.

The travel-activity classification of content refers to a systematic categorization of content based on the type of travel activities it promotes or describes. This classification can be assigned directly as an electronic flag to the content being generated upon inclusion of token 704, or dynamically generated using algorithms that analyze the visual and textual elements of the content to identify themes, keywords and/or destinations associated with specific types of travel experiences. For instance, videos showcasing beaches, historical tours, adventure sports, or local cuisine are classified accordingly, allowing the intermediation engine 120 to tailor the search and interaction strategies based on these classifications.

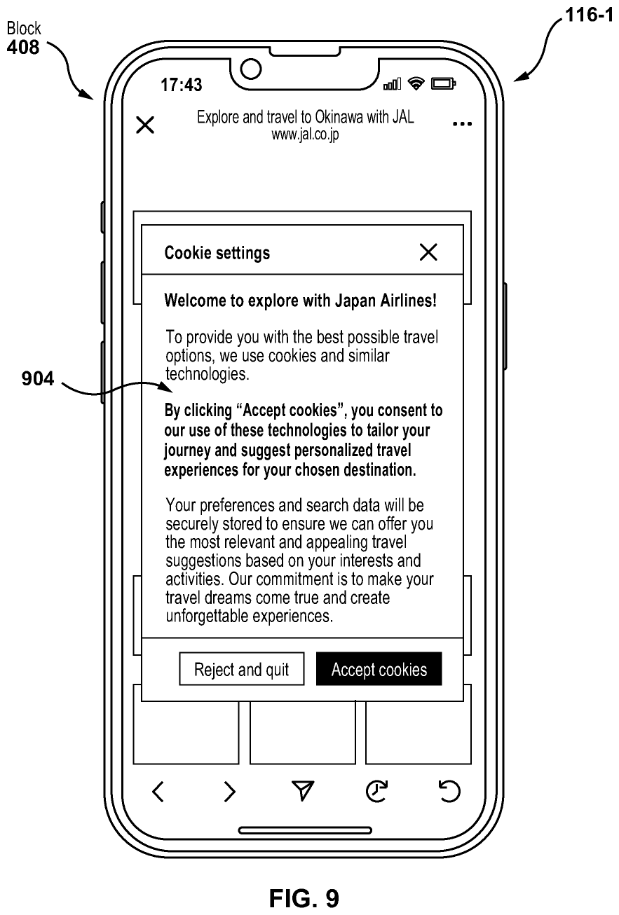

Block 408 comprises receiving an identifier of the client device. Depending on PII protocols for system 100, authorization for providing the identifier can be implicit and/or automatic. Alternatively, express authorization from user 124-1 can be sought, as represented by an authorization-dialogue 904 in the form of a cookie consent pop-up that specifically asks user 124-1 to approve tracking of activity on device 116-1. While authorization-dialogue 904 is shown in the form of a cookie consent pop-up in FIG. 9, the authorization-dialogue 904 can be any form that satisfies appropriate PII approval from users 124. Assuming authorization occurs, either implicitly or explicitly, then all or part of identifier object 128-1 (and/or identifier sub-objects 132-1) can be made available to engine 120.

Block 412 comprises receiving an origin parameter. Depending on the PII authorizations that are available to intermediation engine 120, the origin parameter can be derived from the device identifier received at block 408. It can also be based on an express request to device 116-1 with the user 124-1 responding. The origin parameter can also be based on access to a global positioning system (GPS) measurement taken by device 116-1 and delivered to engine 120. Other means of establishing an origin parameter will occur to those skilled in the art.

Block 416 comprises establishing a destination parameter. The destination parameter can be derived from a classification and/or other meta-data associated with content 122-3 that was being accessed at the time block 404 was invoked. Since the example content 122-3 was about activities off the coast of Okinawa, Japan, the destination parameter that would be derived in this example is Okinawa.

Block 420 comprises establishing an activity parameter. The activity parameter can be derived from a classification and/or other meta-data associated with content 122-3 that was being accessed at the time block 404 was invoked. Since the example content 122-3 was about activities off the coast of Okinawa, Japan, the activities parameter can include popular tourist activities within the area of Okinawa, Japan.

Block 424 comprises conducting a first network search, which may include locating content based on parameters from block 412, block 416, or block 420. In the current embodiment, the first network search is for content related to travel activities, specifically popular tourist activities in the area of Okinawa, Japan, based on the activity parameter from Block 420. The search can be conducted on platforms 104 or other information servers (not shown) connected via network 108. This search is designed to encompass a comprehensive range of travel-related content, going beyond traditional tourist activities to include a wide spectrum of informational and experiential content relevant to the destination. Specifically, the content located through this search may include but is not limited to: local highlights, attractions, journey planning resources, destination-specific activities, sightseeing opportunities, cultural events, local adventures, vacation ideas, and cultural experiences. Additionally, the search can extend to practical information such as local weather conditions, safety advisories, and optimal travel times, enriching the travel planning process with essential contextual details.

The search can be conducted on platforms 104 or other information servers (not shown) connected via network 108. The results of this search are intended to be comprehensive and multifaceted, aiming to provide users with a rich tapestry of options that enhance their understanding and appreciation of the destination, thereby aiding in their decision-making process.

The search at block 424 generates “secondary content”, in other words, content that is secondary to the content that associated with the original redirect connection at block 404.

Block 428 comprises conducting a second network search. This search can involve locating schemas or outlines of schemas for travel between the origin established in block 412 and the destination from block 416. Such schemas can be searched on schema generators 112. These schemas are electronic representations of travel itineraries matching the origin and/or destination outlined in blocks 412 and 416. A complete itinerary or travel schema may be provided if sufficient data is available, or alternatively, a partial schema might be offered, which includes elements like origin and destination but prompts the user 124-1 of device 116-1 to input additional information, such as the number of travelers and preferred travel dates.

The search at block 428 generates “tertiary content”, in other words, content that is tertiary to: a) the content that is associated with the original redirect connection at block 404, and; b) the secondary content generated at block 424.

Block 432 comprises generating a graphical interface that combines the search results from block 424 and block 428. Block 436 is a decision block to determine which set of results is selected. Block 440 invokes the display of the first set of results, while block 444 invokes the display of the second set of results.

Block 448 is another decision block to determine whether the interface generated at block 432 is still active. If “yes”, the method 400 returns to block 432, but if “no” then method 400 ends.

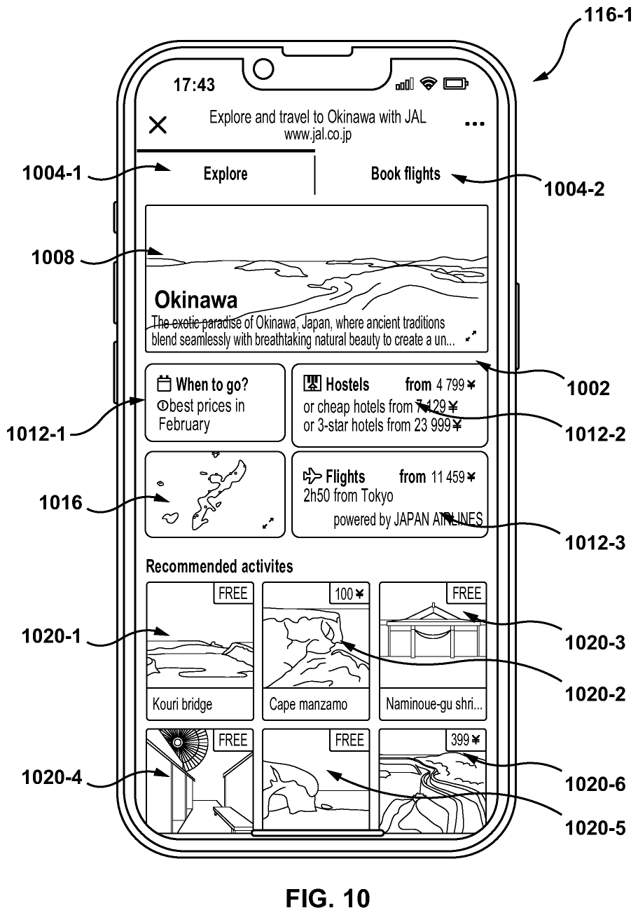

Continuing with the example from FIG. 9, example performance of block 432, block 436, block 440 and block 444 are shown in FIG. 10 through FIG. 21. Notably those Figures show how a graphical interface 1002 as contemplated by block 432 is shown on device 116-1.

Interface 1002 in FIG. 10 represents the initial performance of block 432. Interface 1002 combines the search results from block 424 and block 428 in specific manner, namely, by providing an activity tab 1004-1 labelled “Explore” and a schema tab 1004-2 labelled “Book Flights”. Activity tab 1004-1 includes interactive content regarding activities as derived from the search at block 424.

The label “Explore” on tab 1004-1 is exemplary and other labels can be used to describe the search results from block 424, such as “Discover”; “Local Highlights”; “Attractions”; “Journey Planner”; “Destination Activities”; “Sightseeing Guide”; “What's On”; “Explorer's Guide”; “Things to Do”; “Tourist Hotspots”; “Local Adventures”; “Vacation Ideas”; and, “Cultural Experiences”. Other labels will occur to those skilled in the art and can include “Weather”, “Safety”, “When to Go”, as discussed further below in relation to various specific examples.

The label “Book Flights” on tab 1004-2 is also exemplary and other labels can be used to describe the search results from block 424, such as “Flight Reservations”; “Secure Your Seat”; “Airfare Deals”; “Journey Booking”; “Sky Travel”; “Book Your Journey”; “Find Flights”; “Air Tickets”; “Travel Bookings”; “Flight Finder”; and, “Airline Reservations”. Other labels will occur to those skilled in the art. (Notably, tab 1004-2 contemplates an airline-actor, but tab 1004-2 could also be part of an accommodation-actor, or a car-rental actor. Additional tabs 1004 can also be provided for all of these actors).

Also note that the example in FIG. 10 and following use tabs 1004, but other ways of generating a graphical interface at block 432 which combine the results of the searches from block 424 and block 428 will occur to those skilled in the art. For example:

Dropdown Menus: These allow users to select different content categories or pages from a list. It's a space-efficient way to navigate through extensive options.

Sidebar Navigation: A vertical menu on the side of the interface, often used in dashboards and complex websites. It can be collapsible for space efficiency.

Accordion Menus: Similar to dropdowns but often vertical, these menus expand and collapse sections of content, useful for organizing large amounts of information in a limited space.

Sliding Panels/Carousels: Panels or carousels slide horizontally to reveal different content areas, often used for image galleries, news sliders, or product showcases.

Breadcrumb Navigation: This allows users to keep track of their locations within programs or documents. It's particularly useful for hierarchical websites.

Modals/Pop-ups: Used for focusing attention on a specific task or content, like forms, without navigating away from the current page.

Scrolling (Vertical or Horizontal): Infinite scrolling or distinct section scrolling within a single page can present different content areas. Horizontal scrolling is less common but can be used effectively for certain types of content.

Buttons and Links: Simple but effective, buttons or hyperlinks can redirect to different content sections or pages.

Swipe Gestures: On touch devices, swiping left or right can be a natural way to navigate between content sections, similar to flipping pages in a book.

Pills: Similar to tabs but styled as rounded “pill” buttons, often used for filtering content or switching between categories.

Steppers: Often used in forms or processes, steppers show progress through a series of steps and allow navigation between these steps.

Switches: Best for switching between two views or modes, like changing from list view to grid view.

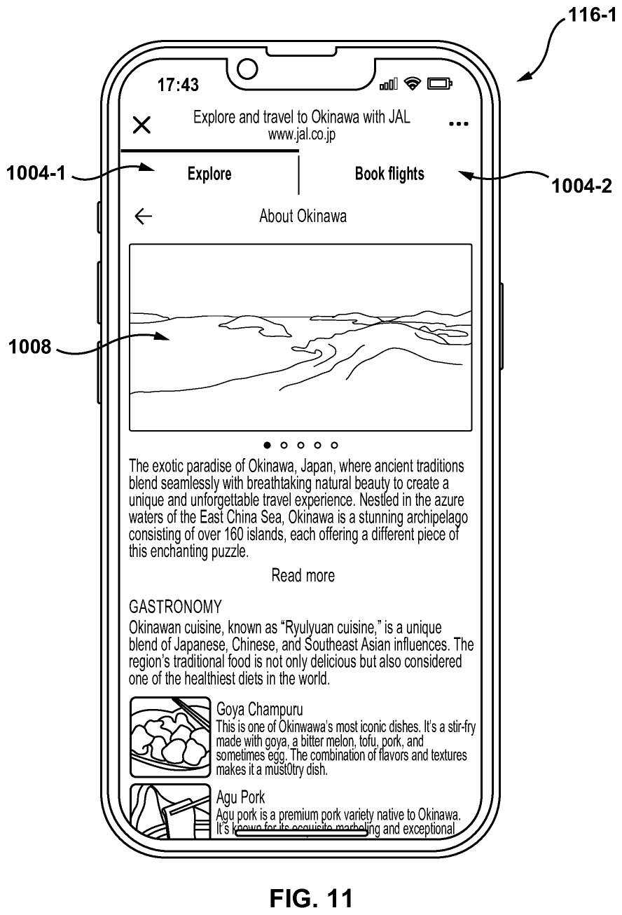

Referring again to FIG. 10, tab 1004-1 is shown as active, with tab 1004-2 as inactive. FIG. 10 shows a ‘home screen’ for tab 1004-1 that includes travel information sections 1012 and a map section 1016. Home section 1008 is shown on tab 1004-1 which provides an overview of the destination from block 416. Section 1008, when selected, leads to the interface in FIG. 11, which expands on the title and overview from section 1008 on FIG. 10.

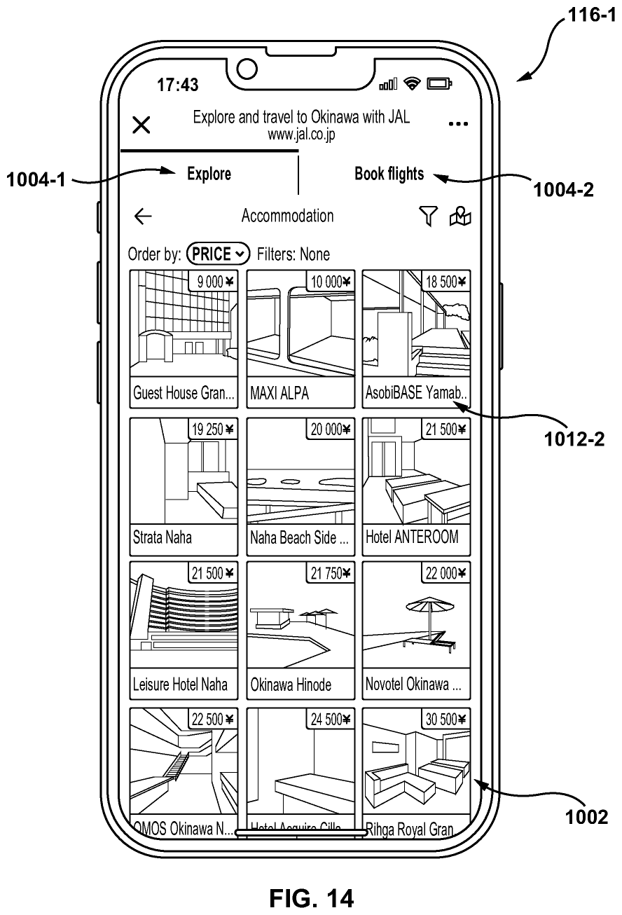

Also in FIG. 10, travel information sections 1012 can lead to the same sort of interactions available under tab 1004-2. Travel information section 1012-1 provides a calendar with rough indications of pricing over certain date ranges. Travel information section 1012-2 provides a list of accommodation actors, which when selected leads to the example screen of FIG. 14. Travel information section 1012-3 provides flight booking information and in the present embodiment, invokes tab 1004-2.

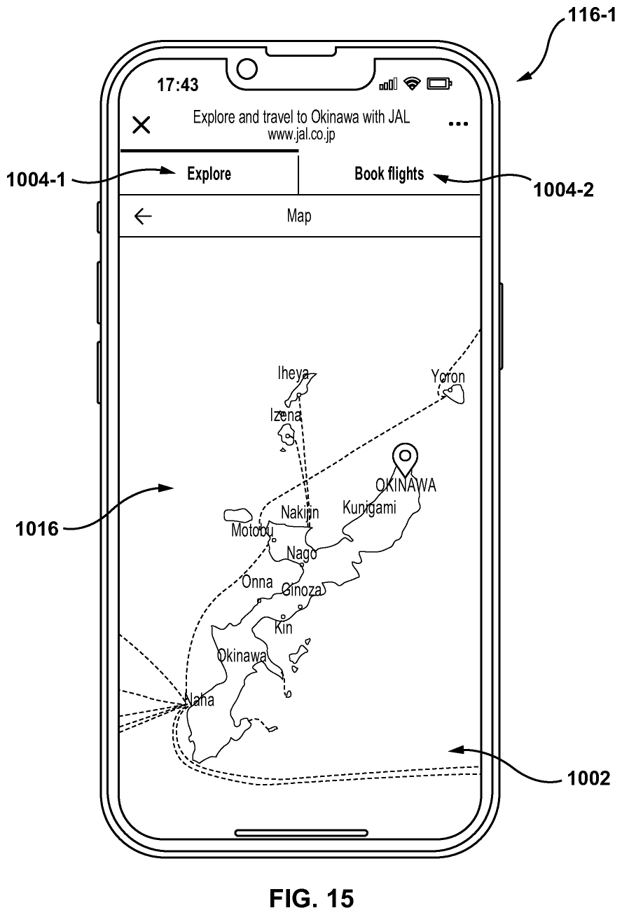

Map section 1016 is also pre-curated to allow visualization of the geography relevant to the searches, and can include full map functionality of Google maps or Bing maps or similar services, entirely within interface 1002. Selection of map section 1016 can lead to the interface shown in FIG. 15, for example.

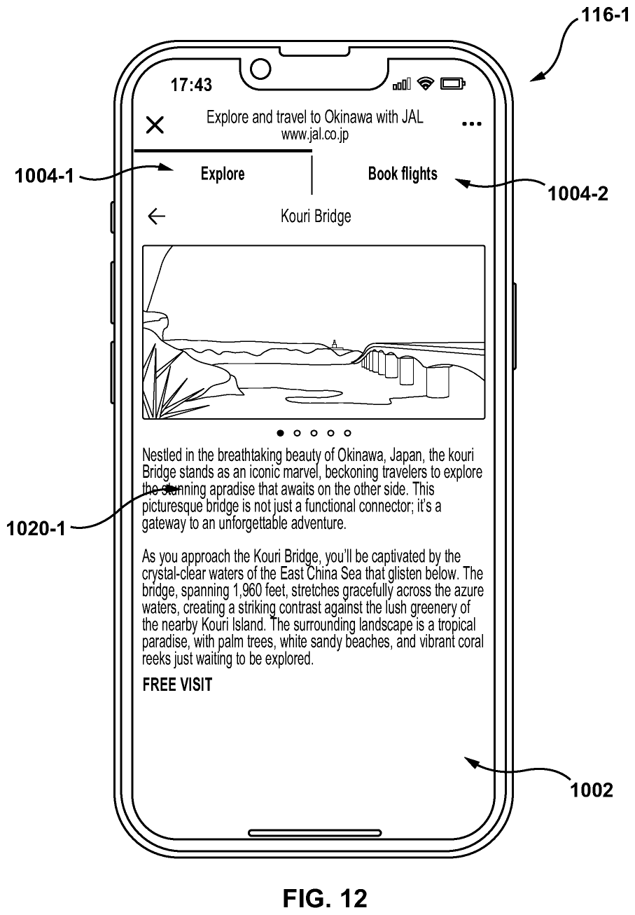

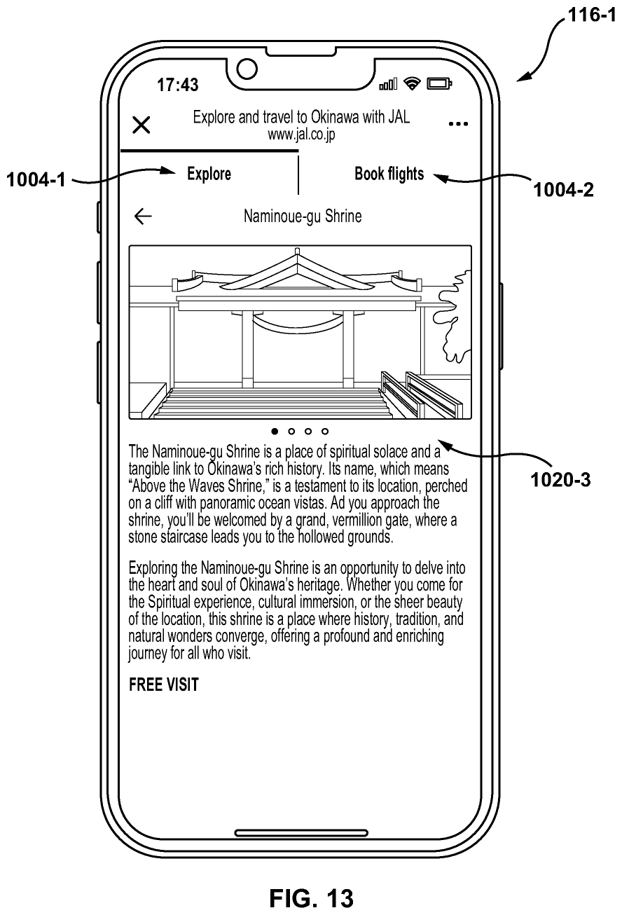

Tab 1004-1 of FIG. 10 also includes a plurality of activity sections 1020, each activity being curated to being relevant to travel within the context of the content 122-3 that lead to the redirect at block 404, including activities that are near the destination determined at block 416 as relevant to the activity parameters from block 420. As examples, selection of section 1020-1 leads to the interface in FIG. 12, describing the Kouri Bridge. The selection of section 1020-3 leads to the interface in FIG. 13, describing the Naminoue-gu Shrine.

A person skilled in the art will now recognize that, generally FIG. 10 through FIG. 15 correspond to example performance of block 440. However, these are non-limiting examples as will also be recognized.

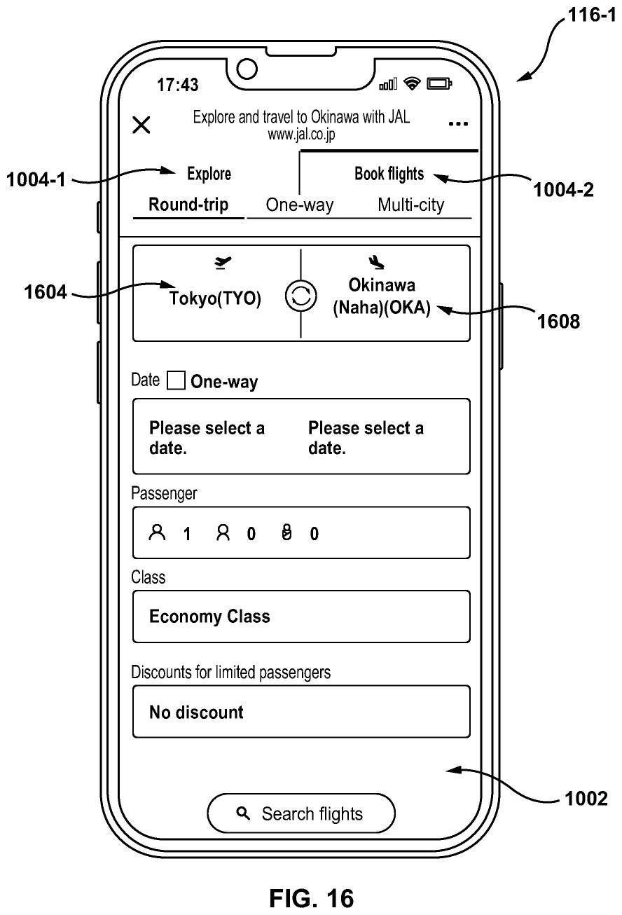

Likewise, selecting tab 1004-2 in FIG. 10 (or section 1012-3) leads to block 444. Generally, FIG. 16 through FIG. 21 correspond to example performance of block 444. Notably, in FIG. 16, a partial schema representing a travel itinerary partially populates a flight searching tool. Origin field 1604 is prepopulated with the origin “Tokyo” based on block 408 and block 412, accessing, for example, dataset 228-1 in association with identifier object 128-1. FIG. 16 thus prepopulates the flight searching tool with as much information as possible based on identifier object 128-1 and any other authorized source of PII, such as the number of passengers, expected class of ticket, etc.

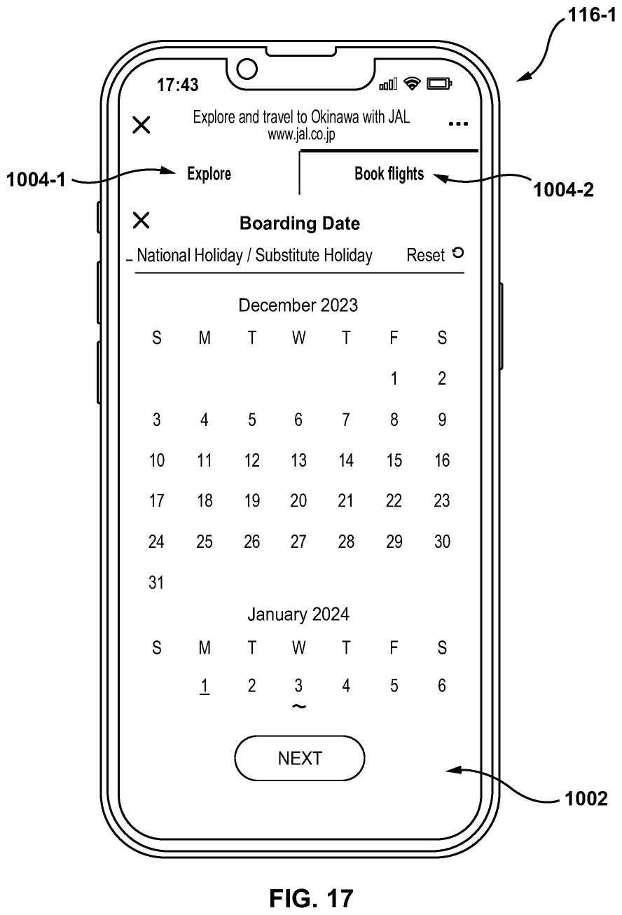

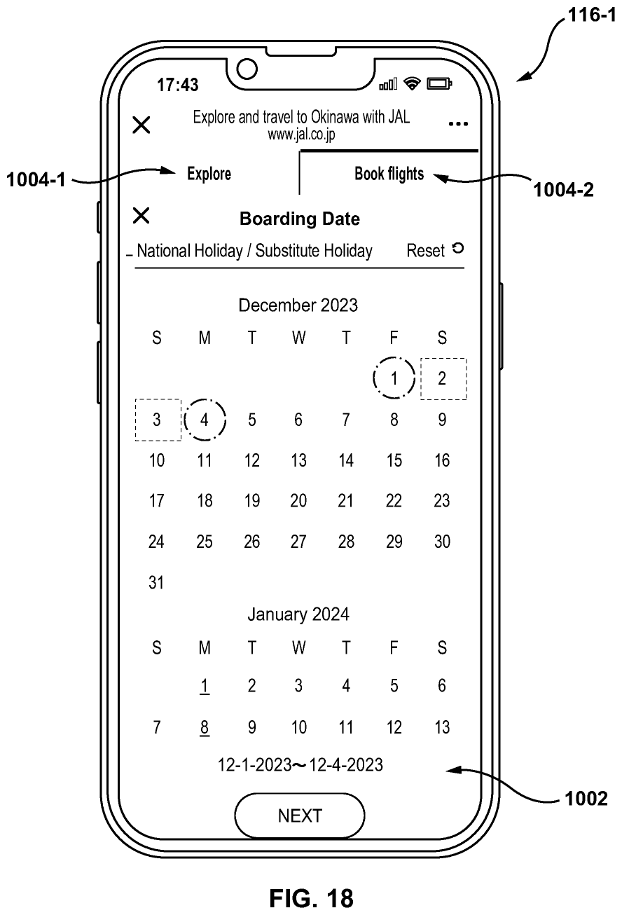

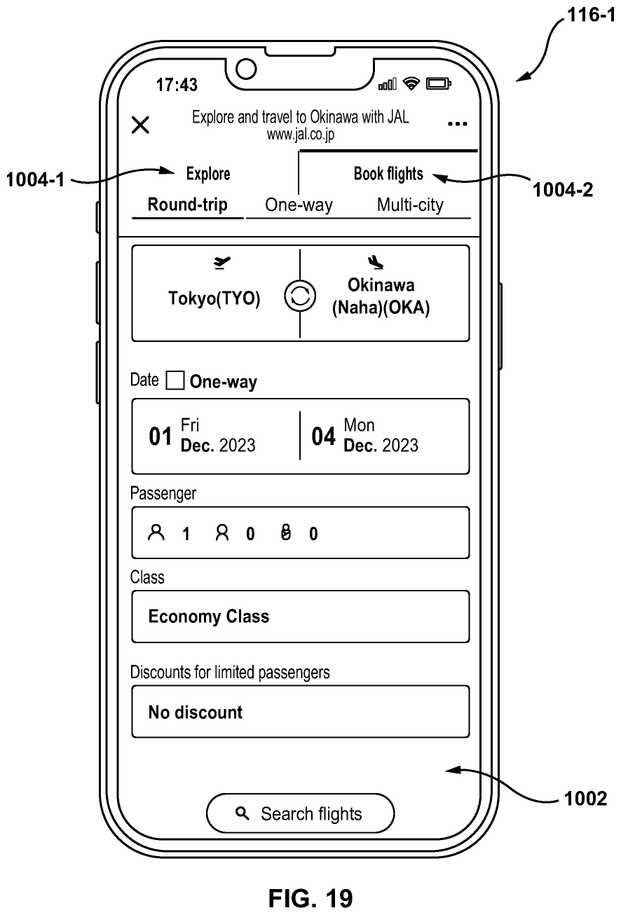

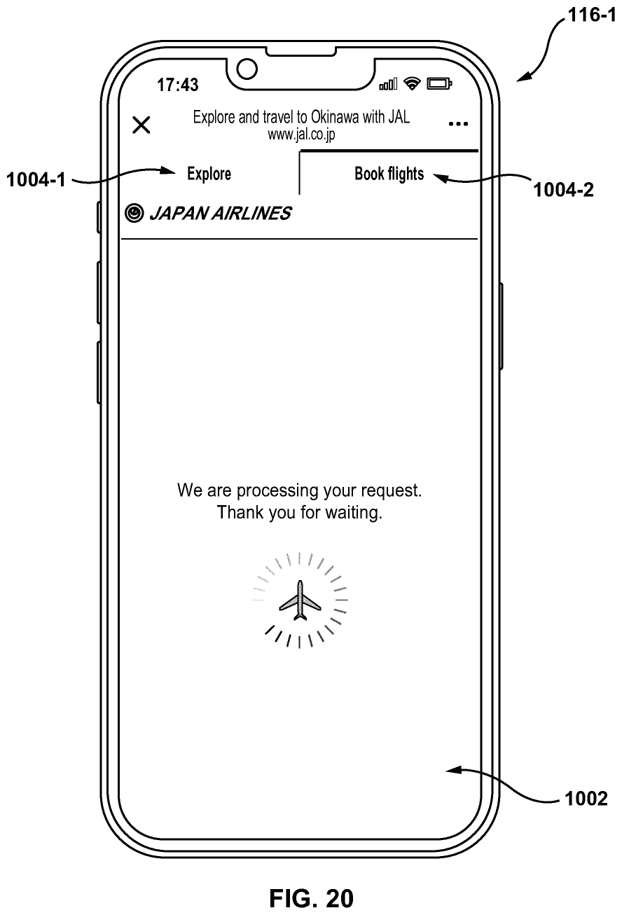

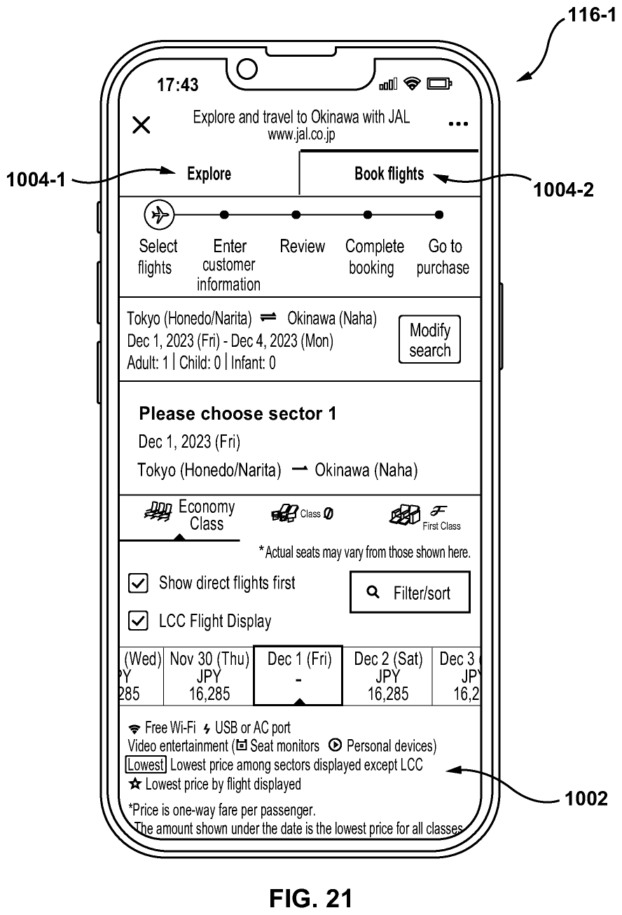

FIG. 17, FIG. 18, FIG. 19 and FIG. 20 thus show all example performances of block 444 where flight options consistent with tab 1004-1 can be searched and even booked. Once those parameters are selected, FIG. 21 shows an example of flow of flight options which can lead to further interactions to actually complete the flight booking.

(In a variant, FIG. 16 through FIG. 20 could be omitted if sufficient parameters are known, and FIG. 21 could be immediately invoked from FIG. 10. In another variant, a “book now” button can be provided where a complete proposed flight schema or itinerary is automatically generated at block 428.)

It is to be understood that when interface 1002 is generated on a client device 116, tabs 1004 can be configured so that toggling between them results in preservation of the state of the background tab 1004. In other words, search on conducted on the Explore tab 1004-1 can be saved when user 124-1 access goes to the Book Flights tab 1004-2, such that those original results are available upon reactivation of the Explore tab 1004-1. The opposite is also true, in that any flight or other travel-actor search information on Book flights Tab 1004-2 can be preserved during navigation to the Explore tab 1004-1.

It is to be understood that intermediation engine 120 can be hosted independently from all other nodes in system 100, or intermediation engine 120 can also host one more schema generators 112 on behalf of different travel actors. For example, intermediation engine 120 can be hosted by a Global Distribution System (GDS), or as an online travel agency interface, or as an airline interface, or as a hotel interface or other type of travel actor interface. The flight search can happen on a GDS such as Amadeus or on the travel-actor provider infrastructure including a travel schema generator 112.

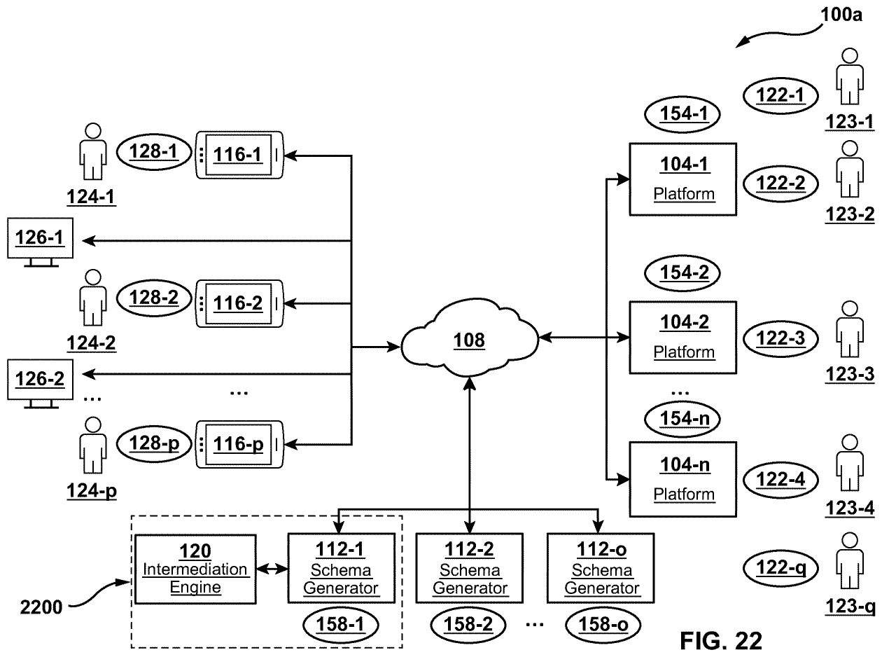

To illustrate the flexibility of placement of intermediation engine 120, another variant of system 100 is shown in FIG. 22 as system 100a. System 100a is substantially the same as system 100, except that an intermediation engine 120a, which is substantially the same as intermediation engine 120, is co-located with schema generator 112-1 and makes schema-generator 112-1 function as a locally connected second intermediation engine. The co-location can be virtual or physical. In system 100a, intermediation engine 120a and schema generator 112-1 are part of a single travel-actor engine 2200. In our examples from FIG. 10 to FIG. 21, a single airline, Japan Airlines was identified as the relevant travel-actor for tab 1004-2. Travel-actor engine 2200 can thus belong to a single travel actor, such as Japan Airlines, so that searches at block 428 are conducted more efficiently due the co-location of engine 120a with the schema generator 112-1 itself.

Expressed in other words, in the architecture of system 100a, engines 120a and generator 112-1 serve distinct functions for the same travel-actor engine 2200. Engine 120a is dedicated to conducting broader searches over network 108 as per block 424, while generator 112-1 is the traditional airline booking engine. When engine 120a and generator 112-1 are co-located, whether physically in the same data center or virtually through optimized network infrastructure, there is an enhancement in inter-server communication efficiency. This co-location enables faster and more efficient data exchange and search query processing between the engine 120a and generator 112-1, compared to a configuration where they operate independently over the broader internet. Such an arrangement can reduce network latency and maximizes throughput, leading to a more responsive and efficient overall performance of system 100a. The proximity, either physical or virtual, allows for seamless integration and rapid data retrieval.

It is to be emphasized that system 100a is a non-limiting variant however, because both system 100 and system 100a reduce network searching and wasted computation, such waste mitigation due at least in part to the pre-curation of destination activity options and their alignment with travel booking options generated within a single interface, such options being further searchable and navigable from within the interface 1002 or its variants . . . .

This specification incorporates the application of machine learning (ML) techniques and algorithms. For example, block 424 and block 428 can employ ML-enhanced search strategies that evolve based on historical usage data of Method 400. For instance, negative outcomes (e.g. ‘No’ decisions at block 448), indicating the termination of Method 400 (including, for example, a failure for there to be a completion of a booking under tab 1004-2) can inform the ML model to adjust its inferences. This adjustment could lead to a reduction in the frequency of similar results from block 424 and/or block 428 in future iterations under similar conditions. Conversely, positive outcomes (‘Yes’ decisions) at block 448 would reinforce the selection criteria used in these blocks. The ML algorithms are designed to identify patterns where identical content (e.g. content 122-3) triggers a redirect at block 404 across different users 124 with shared characteristics. These instances are clustered algorithmically, suggesting a level of similarity in user behavior or preferences. Consequently, the search strategies and the resultant outputs at block 424 and block 428, either individually or in combination at block 432, are dynamically refined by the ML model. This adaptive approach aims to increase the likelihood of positive user responses (‘Yes’ decisions) at block 448 by continuously learning and adjusting to user interactions and feedback.

Note that one or more of the applications 224 may thus include such machine learning and/or deep-learning based algorithms and/or neural networks, and the like, which are trained to improve the search results from block 428 and block 432. (Hereafter machine learning applications 224). Furthermore, in these examples, the machine learning applications 224 may be operated by the engine 120 in a training mode to train the machine learning and/or deep-learning based algorithms and/or neural networks of the machine learning applications 224 in accordance with the teachings herein.

The one or more machine-learning algorithms and/or deep learning algorithms and/or neural networks of the machine learning applications 224 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. To be clear, any suitable machine-learning algorithm and/or deep learning algorithm and/or neural network is within the scope of present specification.

The machine learning model training can be based on data from reporting application 154 and reporting application 158, as well as identifier objects 128 (as permitted), in order to ascertain which itineraries, content and digital redirect tokens lead to improved efficiencies by reducing the number of wasted redirects and increasing the number of actual travel bookings, to thereby constantly refine the determinations made at block 424 and block 428 to further improve the use of networks of network 108 and the nodes of system 100, reducing the amount of churn and wasted searches.

In general, whether ML is used or not, the present specification tackles several technical problems. One problem is the constant amount of churn as devices 116 are used to access network 108 to conduct destination activity searches and to pair those destination activity with searches for schemas or travel itineraries. One technical solution to the problem is the automatic searching of both activity content and schema content on an indication of intent during access of content 122, and pre-curating those results on device 116. Another technical solution is the use of ML to further improve the relevance and reliability of search results based on prior searches within similar contexts. Without system 100 and method 400, devices 116 are constantly switching between browsers and/or applications, with users 124-1 trying to generate bespoke search queries, and often having to refine and repeat the, leading to significant processing utilization of devices 116, schema generators 112 and platforms 104 and accompanying bandwidth usage. The teachings also incorporate curated map searches, thereby reducing a further set of complex interactions that consume processing and memory resources. The present teachings reduce such wastage.

In view of the above it will now be apparent that variants, combinations, and subsets of the foregoing embodiments are contemplated. For example, content 122 can be an audio file, (e.g. music) where the call to action may be an audio signal injected into the audio file as an audio version of token 704. Accordingly, content 122 in general should be viewed expansively; another example is to consider content 122 generated by content creators 123 who are influencers, who may be brand ambassadors for travel actors who own schema generators 112.

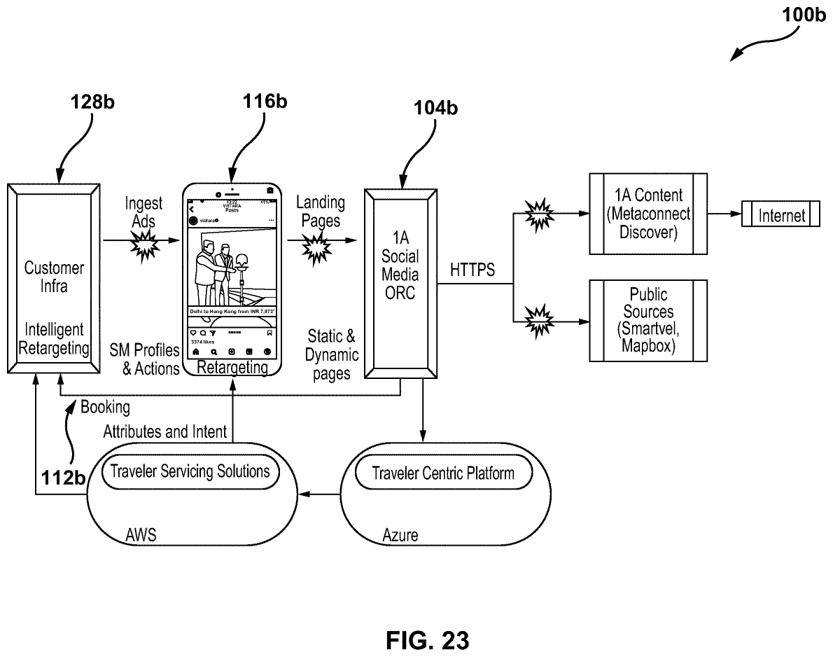

The intermediation engine 120 (and its variants) can provide a novel travel exploration journey, beginning with integration into social media. The intermediation engine encompasses the development of unique landing pages, such as a Digital Travel Storefront, as will be explained later on, tailored and tested across various customer segments. A feature of the intermediation engine is its ability to track and capture the user journey during their exploration, appropriately considering customer consent. This tracking can align with a data model of a Traveler Centric Platform (TCP), or system 100b, a variant on system 100 and system 100a, as shown in FIG. 23, facilitating a harmonized data collection process.

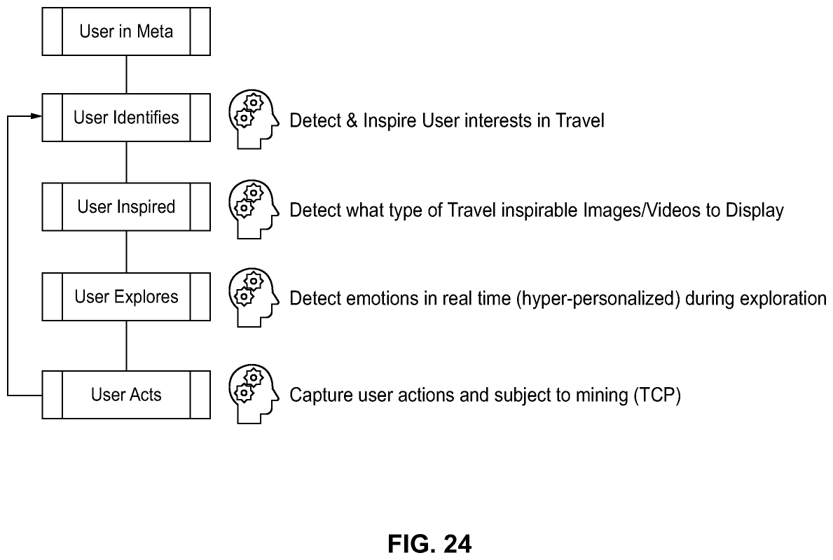

FIG. 24 shows an example of various decision points for personalization on a platform 104 such as Tiktok, Facebook or Instagram other Meta properties.

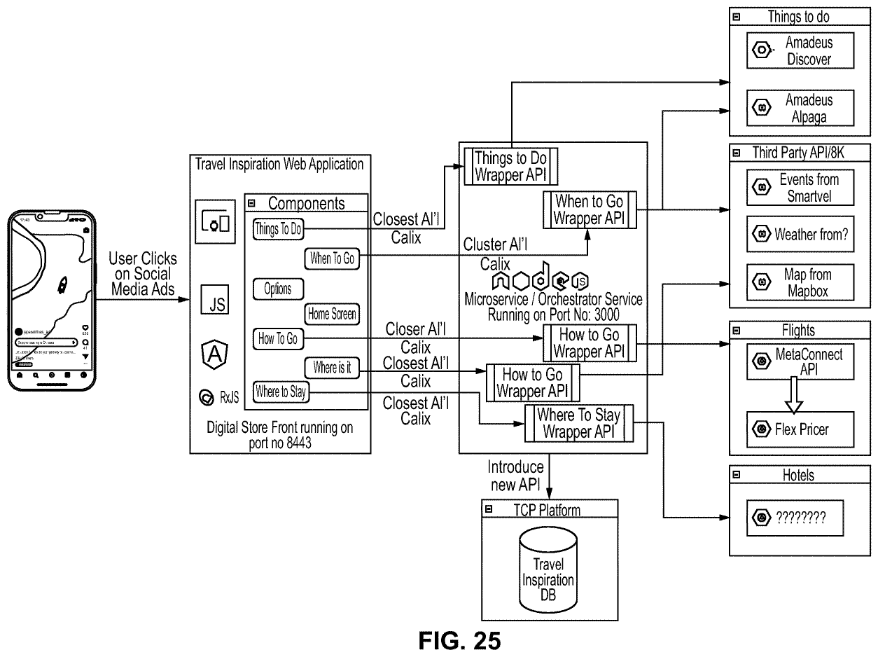

FIG. 25 shows another example of a variant on system 100 and system 100a that shows a flow of an experience when a device 116 is used to select a token such as token 704.

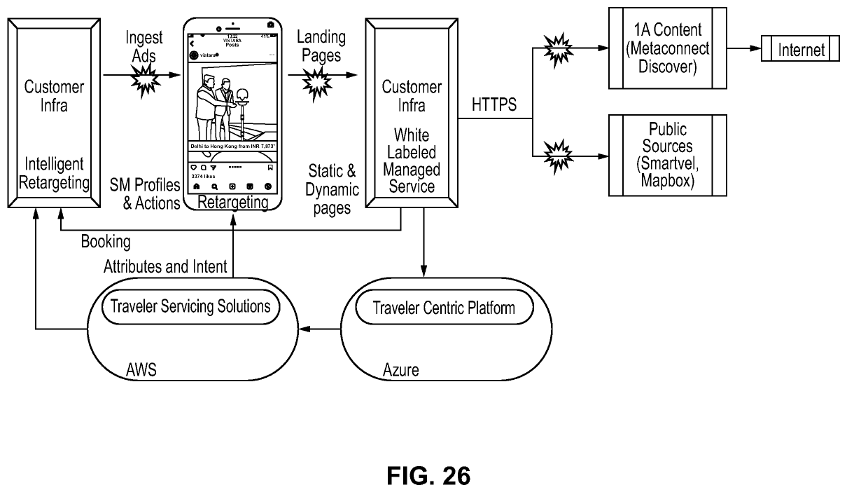

FIG. 26 shows a process flow when device 116 is used to access content 122 and eventually select a token such as token 704.

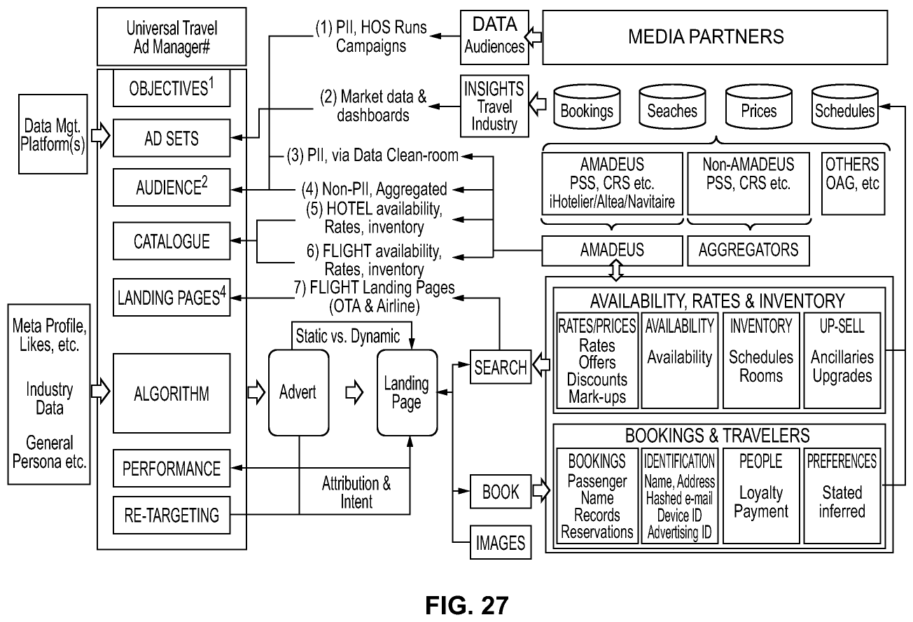

FIG. 27 shows another variant on system 100 that includes a universal advertisement manager (UAM) that is used to generate tokens such as token 704 within content 122. The UAM, in turn, based on available personally identifiable information in user identifier objects 128, is to curate a navigation experience on one or more client devices 116 such as those shown in FIG. 10 through FIG. 21 or variants thereon.

It is to be understood that a model for a typical user 124 that is based on user identifier object 128 and/or incorporated into user identifier object 128 can be derived based on historical navigation through experiences such as those shown in FIG. 10 through FIG. 21, using, for example, the aforementioned machine learning techniques, in order to generate a further refined model (e.g. a traveler data model) that leads to decreased time between accessing token 704 and completing a travel booking via a travel booking tab such as tab 1004-2, thereby further reducing wasted resources of processing, memory and communication.

The data harvested via the TCP can be leveraged to generate insightful analytics. These insights can be used to create Intelligent Personalized Ads, offering a bespoke advertising experience based on user preferences and behavior. The architectural design of the intermediation engine can be planned to address immediate needs in the pilot phase, Minimum Viable Product (MVP) stage, and also possess the scalability to cater to long-term operational flows. A holistic approach can also prepare the system to be adaptable for future advancements in the travel industry.

The present specification can provide systems and methods to enhance the travel inspiration process derived from social media platforms. This can be achieved by introducing an ‘explore tab’ feature, designed to provide a user experience for individuals seeking detailed information about travel destinations. The functionality of this feature extends to allowing users to search for destinations and facilitate booking options. In addition to its core capabilities, the teachings herein can include the development of a white-label version that can be used by different schema generators 112 and/or travel actors operating those schema generators 112. A standard library for User Interface (UI) components can be provided for use by different schema generators 112. The white-label aspect of this solution can allow for customization and branding by different schema generators 112 and associated travel actors, making the tool versatile and adaptable to various business needs within the travel industry.

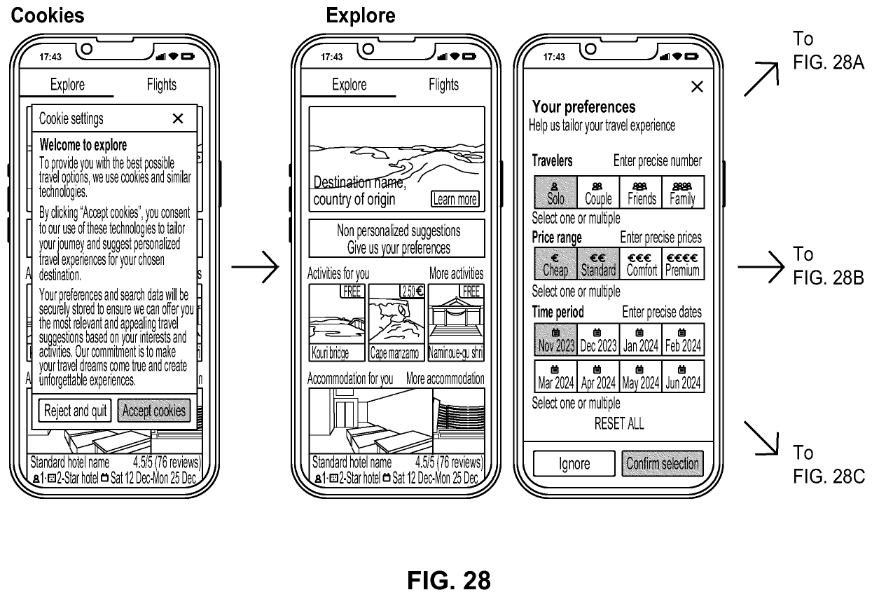

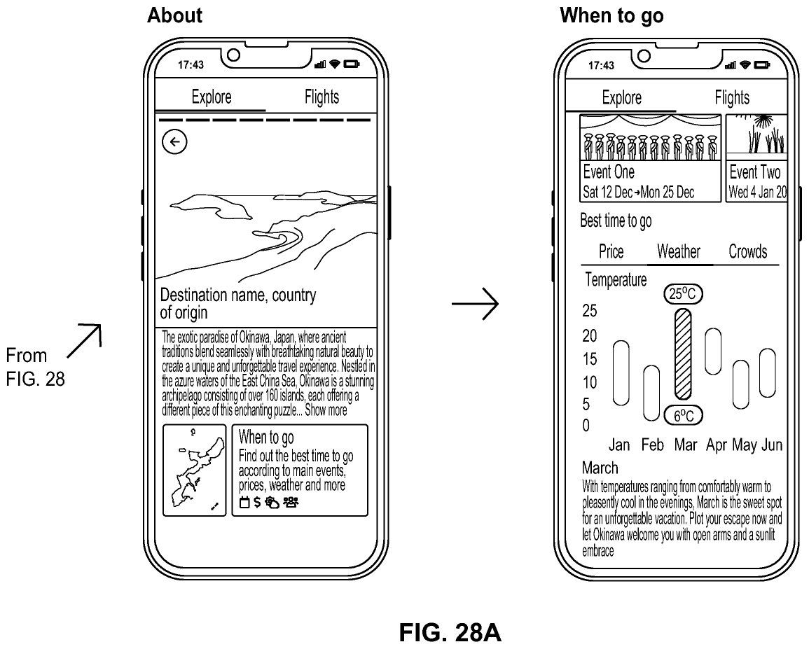

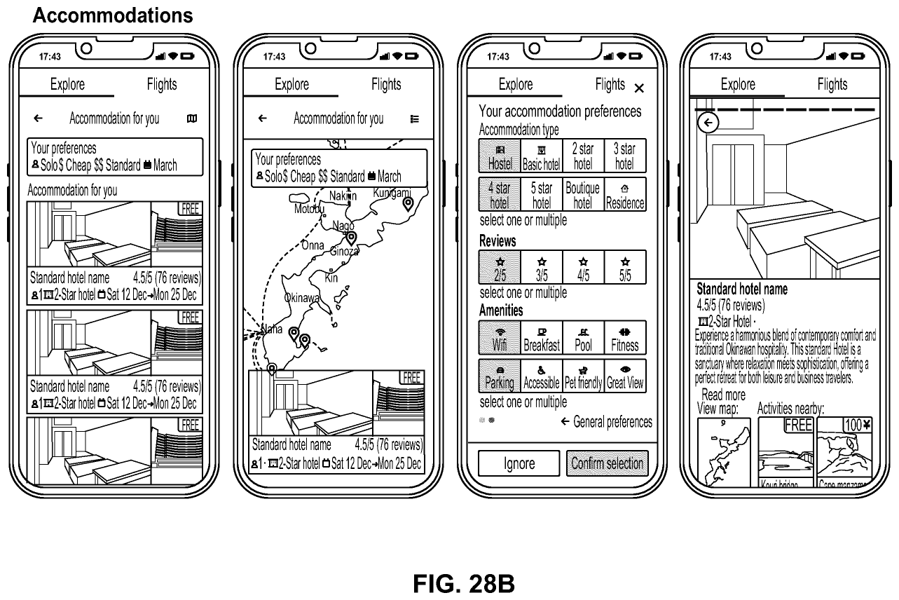

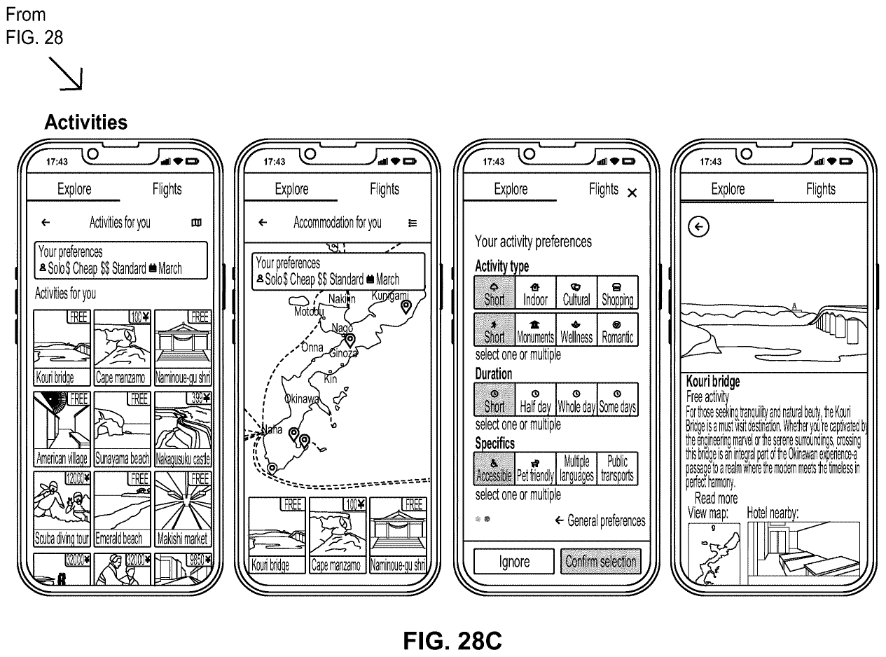

FIG. 28, FIG. 28A, FIG. 28B, and FIG. 28C show an example structure that can be used as a variant on the previous discussion in relation to FIG. 10-FIG. 21. Collectively, FIG. 28, FIG. 28A, FIG. 28B, and FIG. 28C are referred to simply as FIG. 28 elsewhere herein.

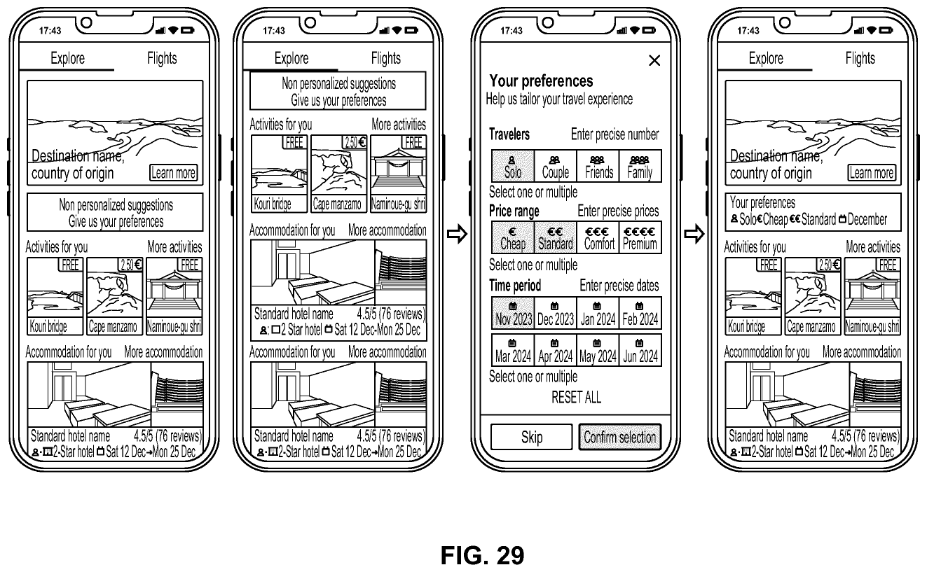

FIG. 29 shows a more detailed view of the “Explore” pathway from FIG. 28.

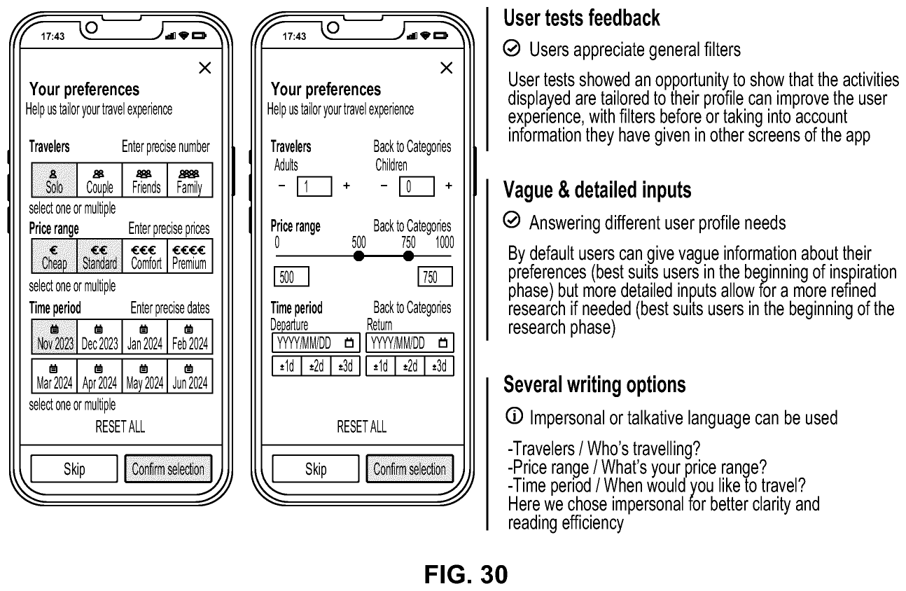

FIG. 30 shows a more detailed view of examples for how preferences for user 124 can be established and placed within user identifier object 128, expanding on the flow from FIG. 28. FIG. 30 shows two smartphone screens that can be used on client devices 116, displaying a user interface for preference settings. On the left screen, the preference options are presented in a more categorical format with blue buttons, while the right screen shows a more numeric and slider-based interface.

Starting from the top, both screens have a title “Your preferences” with a subtitle prompting to help tailor the travel experience. Below this, the left screen has a “Travelers” section with options for “Solo,” “Couple,” “Friends,” and “Family,” allowing the user to select one or multiple categories. The right screen displays a more specific input method where the number of “Adults” and “Children” can be adjusted using plus and minus buttons.

Moving to the “Price range” section, the left screen uses a range from “Cheap” to “Premium,” indicated with euro signs, suggesting a selection of general price categories. Conversely, the right screen provides a slider allowing the user to set an exact price range between minimum and maximum values, which are numerically displayed.

In the “Time period” section at the bottom, the left screen presents a selection of months across two years, from December 2023 to June 2024, which the user can select from. On the right, there are input fields for “Departure” and “Return” dates with the option to add or subtract days, indicated by “+1d,” “+2d,” “+3d,” etc., suggesting the user can adjust their travel dates by these increments.

Both screens have a “RESET ALL” option to clear selections and a final action button to either “Skip” or “Confirm selection,” allowing the user to either bypass the preferences or confirm their choices. The overall design suggests an application focused on customizing travel plans according to user preferences, with two different approaches to input methods.

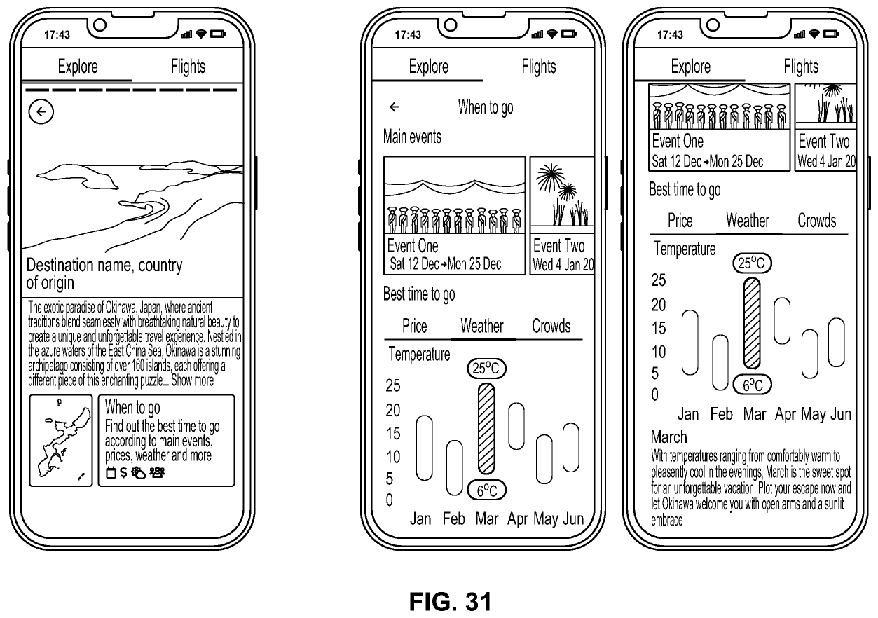

FIG. 31 expands on the example of the “About” flow from FIG. 28. FIG. 31 showcases three smartphone screens, each displaying a different part of the flow from FIG. 28. The first screen on the left shows the main ‘Explore’ tab, featuring a scenic landscape view, likely serving as a visual introduction to a specific destination. The text suggests the image is related to Okinawa, Japan, describing it as an “exotic paradise” where “ancient traditions blend seamlessly with breathtaking natural beauty.” There is also an interactive map and a list of elements that can be explored further, such as “Best time to go,” “Events,” “Prices,” “Weather,” and “Crowds.” A ‘Read more’ option implies that additional information is available.

The middle screen is titled “When to go” and provides details on “Main events” with images and date ranges for two events, labeled “Event One” and “Event Two.” Below, there is a segmented control with options for “Price,” “Weather,” and “Crowds,” with the “Weather” segment currently selected. The interface displays a bar graph showing temperature variations across different months, highlighting optimal travel times based on weather conditions.

The third screen on the right shows an expanded view of the “Best time to go” section, focusing on the “Weather” tab as well. It presents a similar bar graph for temperature, emphasizing a specific month, March, with a descriptive text at the bottom explaining why March is an ideal time for visiting. The text notes that temperatures are comfortably warm, making it a sweet spot for an unforgettable vacation. Additionally, there is an encouragement to “Plan your escape now” and a playful remark about welcoming the traveler with “open arms and a suntan embrace.”

All three screens are part of a cohesive application designed to provide potential travelers with comprehensive information to help them plan their trips, including details about local events, weather patterns, and the best times to visit based on various preferences.

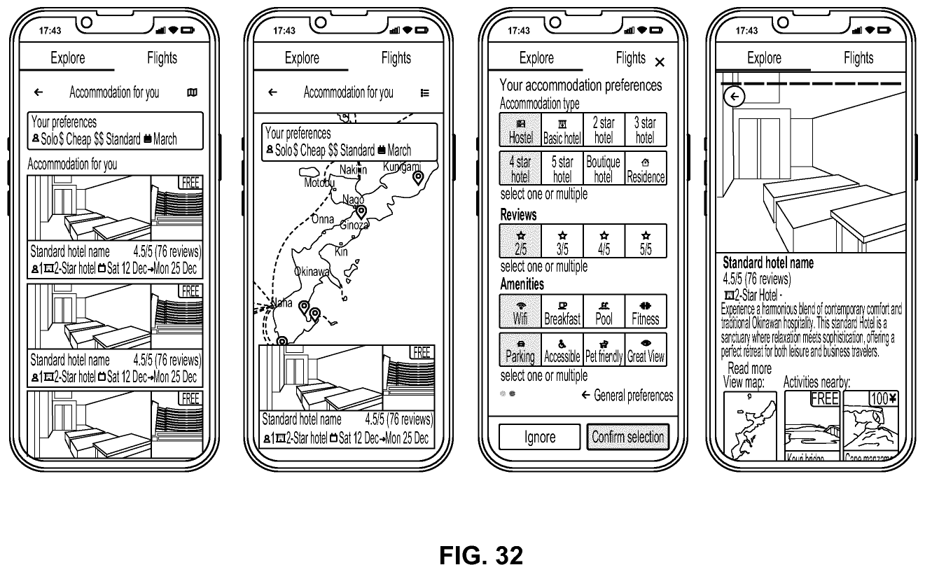

FIG. 32 presents a sequence of four smartphone screens, expanding on the “Accommodation” flow from FIG. 28. FIG. 28 showcases the accommodation selection process based on user preferences.

The first screen on the left displays a list of accommodations under the heading “Accommodation for you,” which seems to be personalized based on the preferences listed at the top: “Solo,” “Cheap,” “Standard,” and “March.” Below this, there are images of various hotel rooms labeled as “Standard hotel name,” with a rating of 4.5/5 and the number of reviews. Each listing includes a date range for a stay and a prominent “FREE” tag, possibly indicating a special offer or reward.

The second screen features a map with location pins over Okinawa, suggesting that the accommodations shown on the first screen are situated in this region. The preferences are reiterated at the top of the screen, and the map appears interactive, likely allowing the user to explore different areas or properties.

In the third screen, the application allows the user to fine-tune their accommodation preferences in detail. Options for “Accommodation type” range from “Hostel” to “Residence,” covering various hotel stars and other lodging types. Additionally, the user can filter by “Reviews” and “Amenities” such as Wi-Fi, breakfast, and more. Two action buttons at the bottom, “Ignore” and “Confirm selection,” enable the user to disregard or save their choices.

The fourth screen appears to be a detailed view of a selected accommodation. It provides a high-quality image of a hotel room, the name “Standard hotel name,” and the same 4.5/5 rating seen previously. A brief description suggests that the hotel offers a blend of contemporary comfort and traditional Okinawan hospitality. Additional links for “Read more,” “View map,” and “Activities nearby” suggest further engagement options within the application.

Collectively, FIG. 32 demonstrates the user interface for the Accommodation flow, which aids users in customizing and selecting accommodations based on their individual preferences, with a variety of filters and detailed information to inform their decision-making process. The curated flow reduces the overall processing burden on system 100 and its variants, by mitigating repeated search queries that manually iterate towards an interaction with system 100 representing a booking of an itinerary based on a travel schema.

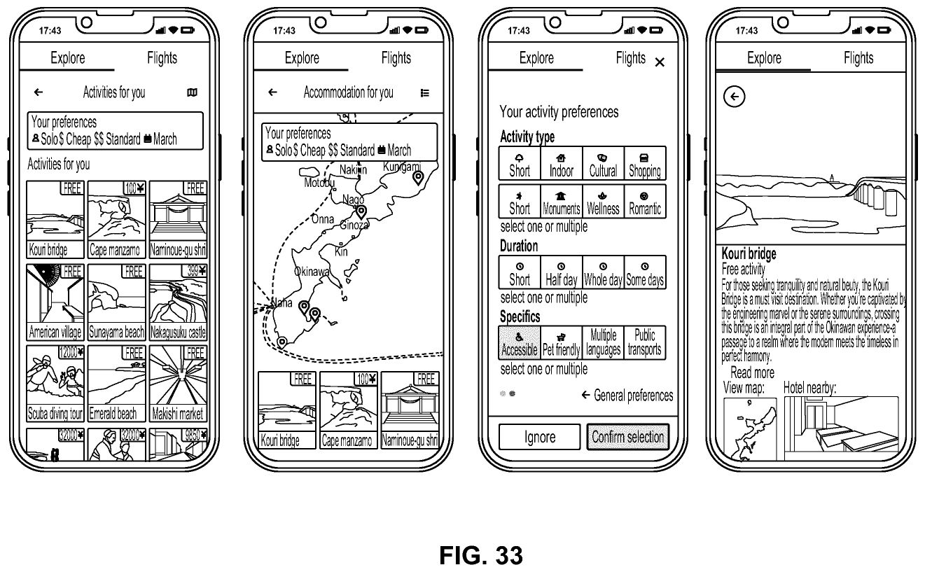

FIG. 33 illustrates four screens within the mobile application flow from FIG. 28 for client devices 116, focusing on the selection and personalization of activities for a solo traveler.

The first screen on the left provides a curated list of “Activities for you,” reflecting the user's preferences stated above as “Solo,” “Cheap,” “Standard,” and “March.” A variety of activities are shown through thumbnail images, each labeled with the activity name and price status, such as “Free” or a specific cost. Examples include “Kouri bridge,” “Cape manzamo,” and “Naminoue shrine,” amongst others.

The second screen displays a map with several points of interest highlighted in Okinawa. The same user preferences are reiterated at the top, and the map appears to serve as an interactive feature for exploring activities by location.

In the third screen, the flow allows for a detailed customization of “Your activity preferences.” Users can select the type of activities they're interested in, such as “Outdoor,” “Indoor,” “Cultural,” and “Shopping.” There are also options to choose the duration of the activities—ranging from “Short” to “Some days”—and specific needs like “Accessible,” “Pet friendly,” and “Multiple languages.” At the bottom, two buttons offer the choice to either “Ignore” or “Confirm selection.”

The final screen on the right spotlights a single activity, the “Kouri bridge,” which is described as a “Free activity.” A descriptive text provides context, describing the bridge as an integral part of the Okinawan experience, blending modernity with the timeless in harmony. A “Read more” link promises additional information, and further interactive elements suggest that the user can view the location on a map or explore hotels nearby.

Overall, FIG. 33 presents a flow within a mobile application designed to curate searches for activities according to their preferences and needs, reducing processing and communication burden in travel schema generation by prepopulating relevant options and detailed information seamlessly.

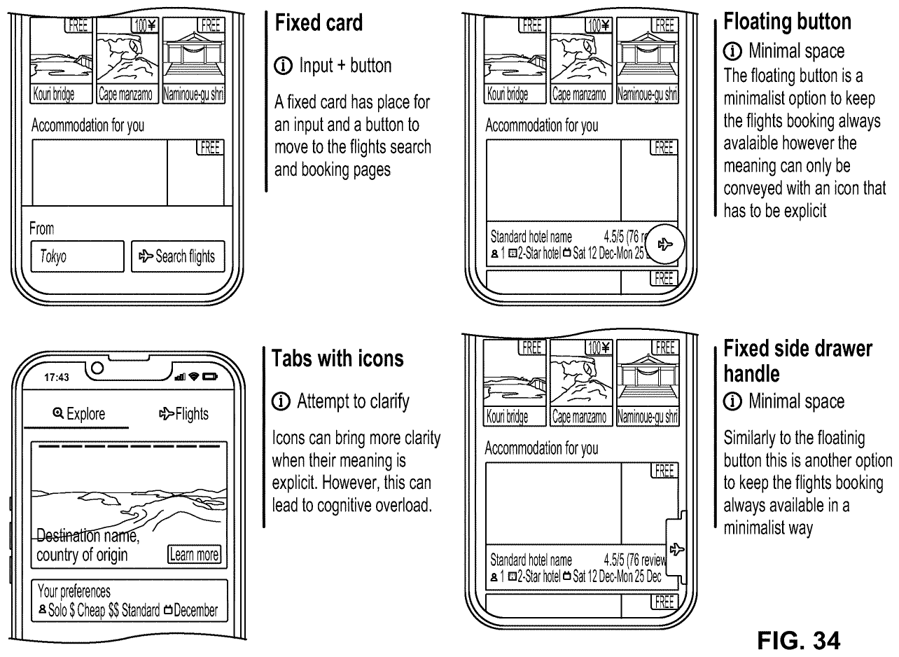

FIG. 34 displays a set of smartphone screens that illustrate different user interface (UI) elements for client devices 116 and their functionality within a mobile application flow. They show various links between the “Explore” tab (e.g. tab 1004-1) and “Flights” (e.g. “Book Flights” tab 1004-2)

The top left screen features a “Fixed card” UI component. This element contains an input field and a button within a stationary card layout. The card provides space for users to enter information, such as a departure city, and includes a “Search flights” button that presumably navigates users to flight search and booking pages.

Adjacent to it, on the top right, is a screen with a “Floating button” design. This Ul element occupies minimal screen space and is intended to offer a minimalist approach to keeping flight booking options readily accessible. The description notes that the button's function is dependent on the clarity of the icon used, which must convey its purpose without text.

Below on the bottom left, there's a screen that employs “Tabs with icons,” (and/or these could just be icons or tokens like token 704) which aims to clarify navigation through iconography. This method highlights the potential for icons to enhance clarity when their meaning is explicit but also cautions about the risk of causing cognitive overload if too many icons are used or if they are not clear.

The bottom right screen shows a “Fixed side drawer handle” feature. This design is similar to the floating button in its minimalist use of space and provides an alternative method for accessing the flight booking feature. It is depicted as a handle on the side of the screen, suggesting a drawer-like functionality that can be pulled out without taking up the main screen area.

Overall, FIG. 34 serves as a comparative analysis of different UI elements that can be used to optimize space and clarity in the mobile application design, each with its advantages and considerations in relation to the interplay between “Explore” and “Flights”.

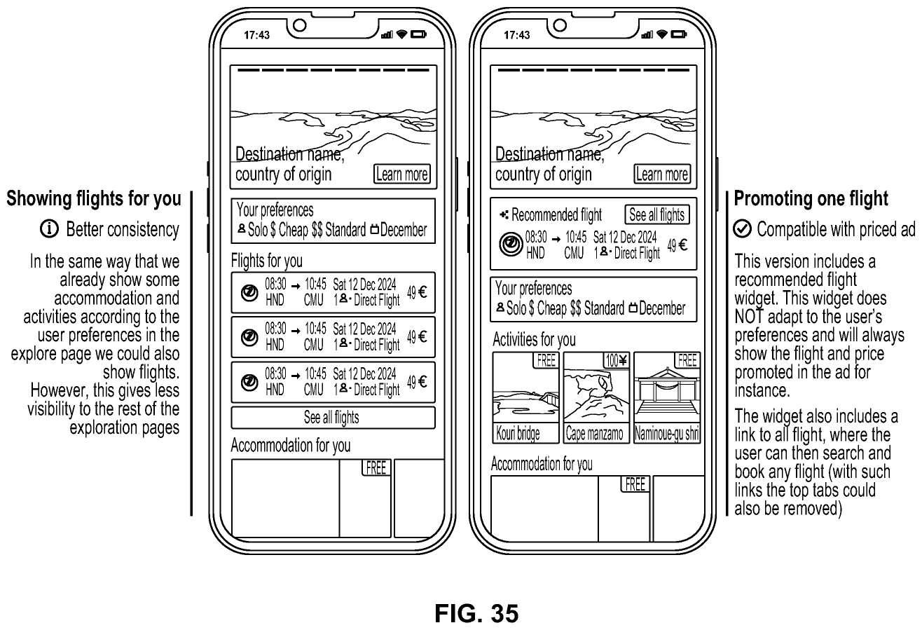

FIG. 35 illustrates screens for client devices 116 that can include some “Flight” options within the “Explore” tab. FIG. 35 illustrates that despite two unique tabs 1004, it is possible to include a portion of elements from one tab inside the other. FIG. 35 thus specifically shows different user interface strategies for presenting flight options within a mobile application.

In FIG. 35, the screen on the left demonstrates the concept of “Showing flights for you,” emphasizing better consistency. This approach is based on the premise that just as the app already customizes some accommodation and activity options based on user preferences, it could similarly personalize flight suggestions. This design aims to provide a tailored experience by aligning flight options with the user's stated preferences, such as travel as a solo, seeking cheap options, and preferring standard accommodations in December. A list of flights with departure times and prices is shown, with the option to view all flights. However, the note suggests that this method may offer less visibility to other exploration pages within the app.

On the right, the screen displays a strategy of “Promoting one flight,” which is noted to be compatible with priced advertisements. This version features a recommended flight widget that does not adapt to user preferences but instead always shows a specific flight and price, similar to a promotional ad. The widget also provides a link to view all flights, offering the user the option to explore further and book any flight. The text accompanying this design mentions that with such links, the top tabs of the app could potentially be removed for a streamlined experience.

Both screens represent different methodologies for integrating flight information into the app's flow: one focusing on personalization and the other on promoting specific flights, with each approach having distinct implications for user engagement and the app's overall interface design.

Again, with the use of machine learning and other techniques, the various layouts of tabs 1004 may be tweaked over time, automatically or manually, to reduce the amount of time between selection of token 704 and a booking of a travel schema, and thereby reduce the processing, communication and memory burdens on system 100.

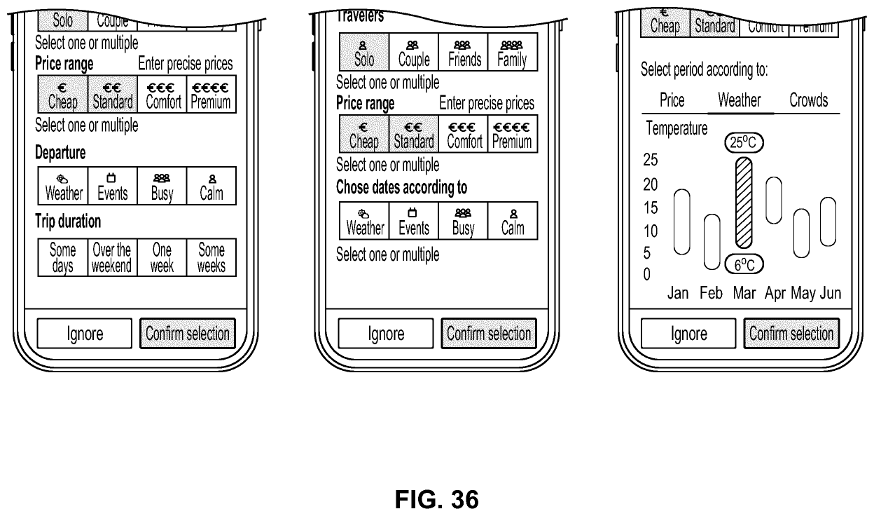

FIG. 36 displays three smartphone screens that depict various methods for configuring user preferences within a mobile application interface for client devices 116.

The left screen provides options for selecting a price range with tags such as “Cheap,” “Standard,” “Comfort,” and “Premium,” followed by choices for “Departure” ranging from “In some days” to “In some months,” and “Trip duration” with options like “Some days,” “Over the weekend,” “One week,” and “Some weeks.” The intent is to allow users to tailor their search based on budget, departure timeframe, and length of trip.

The middle screen offers a different set of preference selectors, starting with the type of traveler-options include “Solo,” “Couple,” “Friends,” and “Family.” It then allows users to choose the price range, similar to the first screen. Additionally, it provides a unique feature that lets users choose dates according to factors such as “Weather,” “Events,” “Busy,” or “Calm,” suggesting that the app can recommend travel dates based on these preferences.

The right screen focuses on selecting the period according to “Price,” “Weather,” and “Crowds,” with a bar graph displaying temperature trends over months, providing users with a visual representation of the expected weather conditions. This can help users make informed decisions about when to travel based on their comfort with temperature variations and crowd levels.

Based on these preferences, the curation of searches can be improved so to reduce the amount of time (and associated computing resource burden) between selecting token 704 and a final selection of a travel schema or itinerary. Furthermore, using ML techniques, commonalities between such preferences can be used across different user identifier objects 128 to even further curate search results and mitigate overall processing burden.

All screens include “Ignore” and “Confirm selection” buttons at the bottom, offering the user the option to either disregard the current selection of preferences or confirm and proceed with the tailored options. This setup indicates a highly customizable approach to planning travel, allowing users to specify their preferences in detail to enhance their search and booking experience within the application.

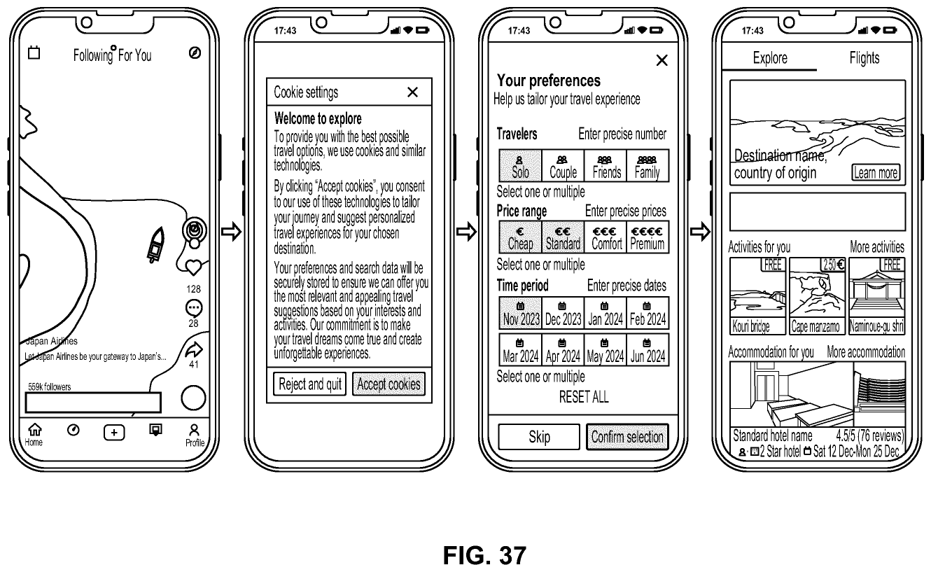

FIG. 37 presents four smartphone screens, each depicting a stage in the user journey within a travel application. FIG. 37 generally corresponds to the views from FIG. 7 (first screen on far left), FIG. 9 (second screen from the far left) and FIG. 10 (the fourth screen from the far left, i.e. the screen on the far right.). The third screen from the far left shows the capability/variant of seeking preferences of user 124 for use in user identifier object 128 before showing the view in FIG. 10. FIG. 37 is thus, itself, a variant.

Thus, the third screen features “Your preferences,” which allows the user to customize their travel experience. The interface includes options for the type of traveler (Solo, Couple, Friends, Family), a price range (Cheap to Premium), and a time period with specific months selectable. The bottom of this screen has buttons for the user to either “Skip” or “Confirm selection” after setting their preferences.

Overall, FIG. 37 demonstrates a sequential user experience flow on client devices 116, from initial engagement with personalized content on a map, through privacy settings and preference customization, to the presentation of tailored travel suggestions.

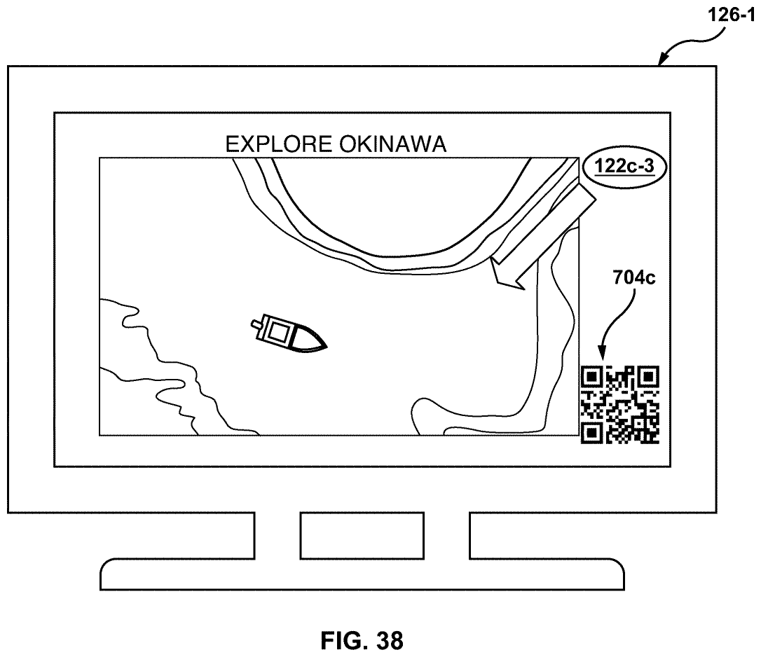

FIG. 38 shows another variant. According to this variant, token 704 can be implemented as a QR-code token 704c, as shown in FIG. 38. Content 122-3 is thus shown as content 122c-3 on television 126-1. Content 122c-3 can be part of a television program or streaming video, with QR-code token 704c generated alongside it. QR-code token 704c can be scanned by client devices 116 at block 404, and the remaining blocks of method 400 can proceed substantially as previously described. The QR-code token 704c can be generated on other media other than a television 126-1, including print media.

QR-code token 704c can be used in several different contexts. For example, the redirect token 704c can lead to a Digital Travel Storefront which can be implemented as a website, or an application, with entry point and exit. The entry point can be the initial landing page or screen where the user first interacts with the content. Examples of exit points include the website or proprietary app of a given schema generator 112 such as an online travel agency (OTA), airline, hotel, or destination marketing organization (DMO). This can provide a seamless user journey from the point of scanning the QR-code token 704c to accessing the relevant schema generator 112. Likewise, such a seamless journey can be experienced from activation of other types of tokens such as token 704.

The Digital Travel Storefront (“DTS”) can be complemented by a series of orchestrated application programming interfaces (“APIs”) designed to engage users 124 during the mid to upper funnel phases of travel planning. This solution may collect data on user intent and preferences through digital interactions, optimizing the conversion process initiated by digital calls to action, such as those encountered in social commerce environments. The DTS can allow users 124 to explore destinations featured in various digital touchpoints by providing information seamlessly integrated into an immersive user interface. This can include answers to common travel queries that are otherwise associated with the search at block 424, which to reiterate, can include such non-limiting examples as the data about the location of the destination, activities available, optimal visitation times, visa requirements, typical weather conditions, health & safety risks and other data discussed elsewhere herein. The DTS can also be extended to support advanced features like social exploration, where users can invite friends to plan together, and the integration of authentic, video-first user-generated content to enhance the decision-making process. This immersive experience can be optimized for mobile versions of client devices 116, offering a superior alternative to traditional travel websites, which may not be well-adapted to smaller screens and can be challenging to navigate. The DTS may be deployed in social media channels and/or can be extended to any ‘call to action’ such as Google or other digital advertising touchpoints.

Returning to QR-code token 704c, as an example QR-code token 704c can be generated on content 122d that includes a Netflix documentary on Norway, and the QR-code token 704c can be used to redirect user to a “Visit Norway” website where that website is an engine hosted by a Direct Marketing Organizations. (See discussion below on Direct Marketing Organization or DMO). QR-code token 704c could also be placed on merchandise, such as a perfume box or other merchandise. For example, an airline may give away perfume boxes in the business lounge of an airport in a given city, so demographic inferences can be made when such QR-code tokens 704c are scanned; system 100d knows the user 124d is a business traveler and has visited the airport of that city.

These examples of QR-code token 704c are a variant on token 704 which can come as a link within social media feed content 122 such as the example given with content 122-3.

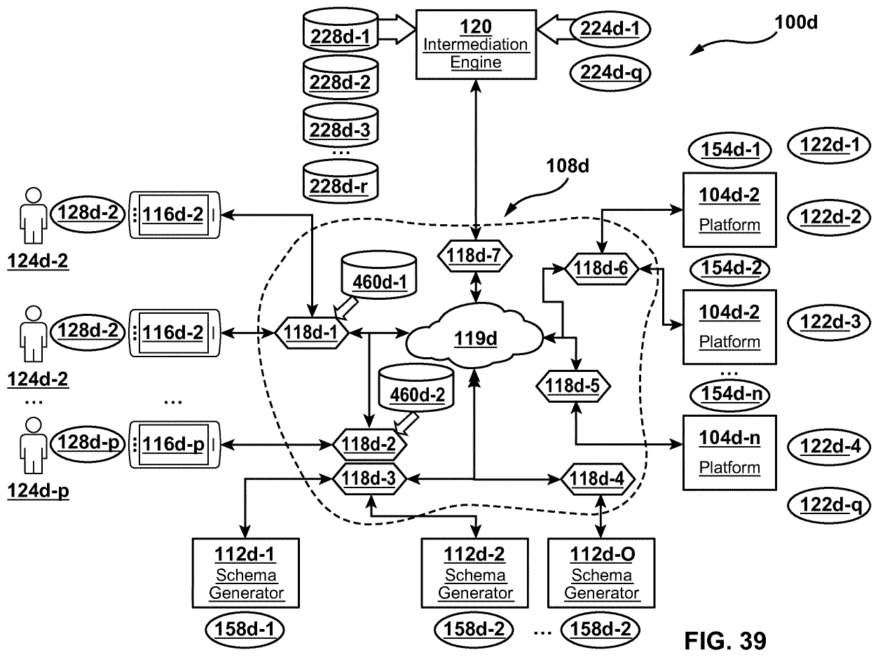

FIG. 39 shows another variant. According to FIG. 39, system 100d is shown as a variant on system 100. In system 100d, network 108 is shown with greater granularity and labelled as network 108d. In network 108d, a plurality of points of presence (POP) 118d are shown. POPs 118d are physical access points or interface locations that connect the core network 119d to devices 116d, schema-generators 112d, platforms 104d, intermediation engine 120d and any other Internet resources. Each POP 118d can thus be part of a local Internet Service Provider's (ISP) network. The core network 119d thus collectively represents the other elements of the Internet. Each POP 118d acts as a gateway for accessing a respective ISP's network infrastructure. System 100d can be combined with the other systems discussed herein. For example, system 100d can also be applied to system 100b where intermediation engine 120d is local to one or more schema generators 112d.

According to system 100d, copies of the first set of search results 460d, as per block 424 and block 440, can be stored locally at POPs 118d respective to their corresponding client devices 116d. Note that results 460d are stored in a hardware device such as a file server. To elaborate, for example, recall that FIG. 10 through FIG. 15 represented example performances of block 440 of method 400. Thus, the pages in FIG. 10 through FIG. 15, as per this example, can be cached and stored as search results 460d-1 within POP 118d-1. Thus, in this example, block 424 can be effected by accessing cached search results 460d-1 that are stored at POP 118d-1.

Likewise, variants on FIG. 10 through FIG. 15 can be cached and stored as search results 460d-2 within POP 118d-2. According to this example, cached search results 460d-1 represent a performance of block 424 prior to the invocation of method 400 itself, based on predictions of devices 116d accessing token 704. Such a prediction can be made based on the generation of content 122-3, and prior to the dissemination of that content 122-3 on a given platform 104. Therefore, when method 400 is executed on system 100d, the initial network search results can be pre-loaded as results 460d for use in block 440.

Each set of cached search results 460d can thus be tailored according to the geographic origins of respective devices 116d, as per the origin parameter from block 412. To help further elaborate, assume that POP 118d-1 serves Tokyo, Japan, while POP 118d-2 serves Bangalore, India. Accordingly, device 116d-1 and device 116d-2 accessing POP 118d-1 during method 400 will be served cached search results 460d-1 at block 440, while device 116d-p will be served cached search results 460d-2 at block 440. The level of customization of each set of search results 460d is not particularly limited. As a simple example, however, search results 460d may be unique to the local first language. Thus, continuing with the example of FIG. 10 through FIG. 15, results 460d-1 may include the pages of FIG. 10 through FIG. 15, except stored in the Japanese language due to POP 118d-1 being near Tokyo, while results 460d-2 may include the same pages from FIG. 10 through 15, except stored in the Kannada language due to POP 118d-2 being near Bangalore, India.

Still further customizations of results 460d for each local POP 118d are contemplated beyond language (e.g Japanese vs Kannada) to encompass any generalizations that are common to the population operating devices 116d that are local to a given POP 118d. For example, generally understood preference for food, activities, accommodation, safety concerns and/or travel requirements such as visa requirements for the point of origin from block 412 and/or location of POP 118d that correspond to a given destination from block 416, can be incorporated into the local copy of search results 460d. For example, no travel visa would be required from Tokyo (the location of POP 118d-1) to travel to Okinawa, whereas a travel visa may be required from Bangalore (the location of POP 118d-2) to travel to Okinawa, Japan. Thus, for example, the variations of versions of pages from FIG. 10 through FIG. 15 may be provided accordingly, with: a) travel visa requirements being part of the display of results 460d-2 on device 116d-p at block 440, and; b) no travel visa requirements being part of the display of results 460d-1 on device 116d-1 and device 116d-2 at block 440. These customizations can further reduce overall search burden of processing, memory and network resources by tailoring each set of results 460d according the local commonalities of users 124d accessing those results 460d. In other words, by populating the cached results 460d according to understanding of users 124d, system 100d reduces the overall size of the search domain. For example, if content 122d includes a redirect token 704 for users 124 who are of “Generation Z” on trips from New York to Hawaii, then results 460d will have very specific data tailored to those “Generation Z” users 124d.

Furthermore, data gathered during the exploration phase (i.e. Block 440) can be used to populate results 460d. Updating results 460d can be an offline process where, after a number of explorations at Block 440, or after a predefined time period, results 460d are updated. Criteria for updating may include: popularity, seasonality, or volatility. Alternatively, updating results 460d can be real-time, such as when a dynamic search is performed instead of a cached search, with the dynamic search result being flowed into the cached results 460d. Dynamic segmentation can also be performed, whereby cached results 460d can be updated during different periods of the day; for example, updates to the results 460d maybe limited to the time of a popular cricket match between 5 μm and 7 μm, when the match is being generated as content 122 that can have a token 704 associated therewith. In general, the cache may thus be smartly updated and have different data at different moments, triggered by events, seasonality, weather, etc.

Note that the fact that results 460d are also geographically close to respective devices 116d results in reduced latency on devices 116d themselves.

Still further customizations of results 460d for each local POP 118d are contemplated. Results 460d themselves may include different versions based on the demographic information of a given user 124 as stored in dataset 228-1 and associated user identifier object 128. For example, user 124d-1 may be age 37 (as per Table 228-1), whereas user 124d-2 may be age 21 (this example is new). Thus, while user 124d-1 using device 116d-1 and user 124d-2 using device 116d-2 are both invoking method 400 on intermediation engine 120d via POP 118d-1, the results of block 424 may be tailored to be slightly different based on the age differences. As a simple example, the 21-year-old user 128d-2 may be presented with lower budget accommodations in block 440 that include youth hostels within the Okinawa region, while the 37-year-old user 128d-1 may be presented with more middle or high-end accommodations in block 440, more commonly utilized by middle-aged adults. These variants can still be stored locally within results 460d-1 at POP 118d-1, or they can be dynamically searched at block 424. Thus, in another variant, it should be understood that some results from block 424 may be returned from cached results 460d, while some results may be obtained over network 108d in real time.

In another variant, machine learning feedback can be used to dynamically update results 460d. For example, processor 208 can be configured to utilize machine learning algorithms to analyze patterns from prior network searches and user interactions, and based on this analysis, dynamically determine and update the results stored in the local cache results 460d at the respective point of POP 118d to optimize cache results 460d relevance and efficiency for anticipated future searches. The various iterations of method 400 across all users 124d, taking into consideration browsing activities within block 440 vs block 444 of each user 124d, and noting which results 460d are correspond to actual bookings of a flight, accommodation or other travel-actor activity at block 444. In this fashion computing resource efficiency is further increased as the amount of time within block 444 is reduced and/or leads to an actual booking. Thus the toggling between block 444 and block 440 can be archived and fed into a machine learning studio platform. The studio allows to train a machine learning algorithm. The machine learning algorithm, can for example, generate a new version of the each results 460d. Then the updated results 460d can be deployed across system 100d and made available block 424.

Accordingly, in this variant, one or more of the applications 224 may include the machine learning studio platform with any desired related machine learning deep-learning based algorithms and/or neural networks, and the like, which are trained to improve the results 460d (Hereafter machine learning applications 224). Furthermore, in these examples, the machine learning applications 224 may be operated by the processor 208 in a training mode to train the machine learning and/or deep-learning based algorithms and/or neural networks of the machine learning applications 224 in accordance with the teachings herein.

The one or more machine-learning algorithms and/or deep learning algorithms and/or neural networks of the machine learning applications 224 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like.

The reader is reminded at this point that system 100 and its variants such as system 100d scale globally to millions of different devices 116d and POPs 118d all over the world, and thus various copies of results 460d can be stored at those POPs 118d. In actuality, each POP 118d may be associated with hundreds, thousands, or millions of different devices 116d.

Furthermore, a person of skill in the art will remain appreciative of the fact that prior art travel searches typically include booking searches (corresponding to block 444) that are separate from the full range of so-called “explore” or “inspirational” searches (corresponding to block 440) and, as user 124 toggles between different search engines, web pages, and apps, significant computing resources are consumed in the form of local processing and memory on devices 116, not to mention the traffic resources of network 108 and the constant pinging of search results on schema generators 112 and content platforms 104. Accordingly, method 400 on system 100 provides certain technological advantages by automatically inferring and creating searches at block 424 that correspond to such “explore” or “inspiration” or destination activities. Furthermore, method 400, as applied to system 100d, can provide even further technological advantages through cached results 460d, which obviate or mitigate the need for broader searching over network 108d altogether. Thus one technical problem being addressed by the present specification is the repeated and unfocused searching that corresponds to results 460d, and the problem is addressed by automatically inferring, at the time of generating content 122-3 itself, and performing what types of search results as per block 424 that are likely to be requested based on the origin parameter from block 412 and the destination parameter from block 416, with the potential for further enhancement based on demographic information from block 408 should user consent be provided to access user identifier object 128. However, even without access to user identifier object 128, system 100 still reduces technological burdens. A still further technical advantage can be the dynamic creation of a user profile for storage in Table 228-1 and/or user-identifier objects 128 based on the tracking of toggling between block 440 and block 444. Such creation may, for privacy reasons, require the consent of the user 124d. Such dynamic creation can obviate the need for the user 124d to go through the process of creating a profile within their respective user identifier object 128d on their own.

The specific browsing that occurs within block 440 and/or block 444 can be referred to as “signals.” With these signals, curated results 460d and/or tracking of “signals” within the browsing of results 460d can drive users to a tailored booking flow within block 444. For example, where block 440 includes “exploring” boutique hotels near Central Park and visits to the Museum of Modern Art, the system then tailors booking options in block 444 accordingly. This could include offering accommodations near Central Park, as well as options for pre-purchasing museum tickets or arranging limousine services from the hotel to the museum, facilitating a seamless experience when the user decides to “Book Now.”

Overall, the “bookings” search offerings in block 444 are dynamically informed by the user behavior and preferences captured as “signals” during the “explore” phase in block 440. This integration ensures that the default “bookings” offerings are customized based on the initial user interests. For instance, continuing from the scenario in the previous paragraph, the “bookings” at block 444 might propose enhanced services such as upgraded limousine service directly to the Museum of Modern Art, enhancing the personalized user experience.

It is also to be understood that results 460d can be reused across a plurality of schema generators 112d that pair with the functionality offered by intermediation engine 120d. To elaborate, method 400 can be invoked in association with different schema generators 112d paired with intermediation engine 120d. For example, if schema-generator 112d-1 is operated by Japan Airlines (JAL) while schema-generator 112d-2 is operated by All Nippon Airways (ANA), both schema-generators 112d may rely on a single set of results 460d-1, thereby further enhancing overall technological efficiency over the prior art where multiple searches about destination activities are typically performed while browsing for airline booking options. (Likewise, method 400 can also be invoked in a version of system 100d that is modified according to system 100a, where an intermediation engine 120a may be paired with one or more schema-generators 112a). It will also now be apparent that the foregoing machine learning algorithm can be applied to building a common set of results 460d across different schema-generators 112d.

Furthermore, the capability of system 100d to consolidate user data from multiple entry points enhances the depth of user demographic profiling for updating user identifier object 128 and/or Table 2281-1. When devices 116d land on the same hosted pages through various content 122 (such as advertisements in the form of content 112-3) that is sponsored by different one or more schema generators 112d, intermediation engine 120d can capture and store extensive data from these interactions, especially during navigations within block 440 and block 444. This approach can enable the intermediation engine 120d to correlate information from multiple sources to construct a comprehensive ‘super profile’ for each user and for storage within user identifier object d. Such profiles provide a rich, multi-dimensional view of user preferences and behaviors. If a schema generator 112d, such as an airline, for example, hosts a landing page on engine 120d where navigation between block 440 and block 444 can occur, the insights derived may be more narrowly focused, but exceptionally detailed concerning travel preferences and responses to specific airline offerings. This facilitates highly customized service delivery and marketing strategies, tailored to the nuanced needs and interests of each traveler. On the other hand, if intermediation engine 120d hosts the landing page on behalf of one or more schema generators 112d, making use of different results 460d at one or more POPs 118d, then a more rich set of profiles to be associated with user identifier objects 128d can be generated.

In another variant, system 100 (or its variants) may also include a content engine (not shown) hosted by a Destination Marketing Organization (DMO). The DMO content engine may be a content platform 104 and host content 122 itself that includes token 704. Alternatively, the DMO content engine may lie between a platform 104 and one or more schema generators 112 and receive and handle the initial redirect connection at block 404, such that the DMO content engine acts as the intermediation engine 120 managing block 440 (Explore) while one or more schema generators 112 handles block 444 (Booking).

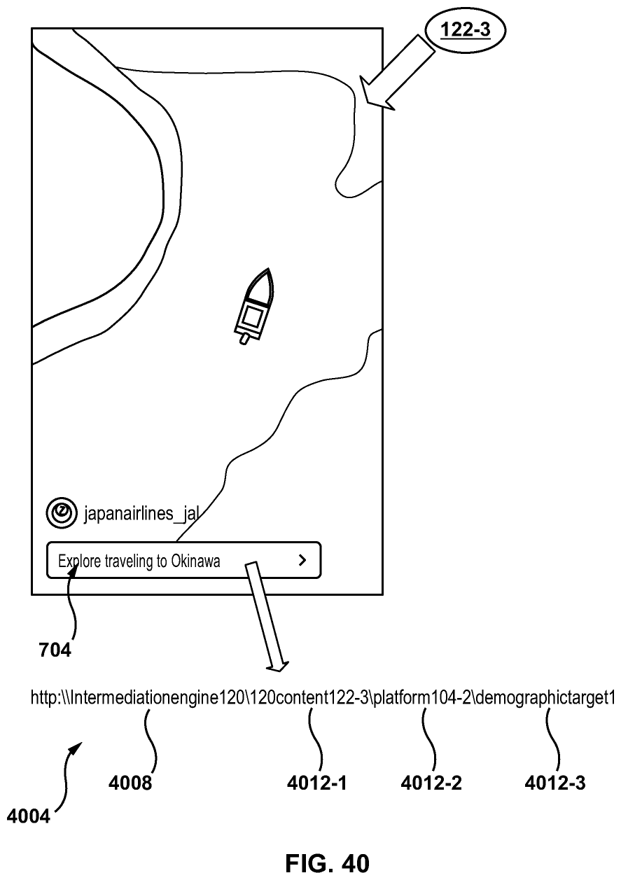

Referring now to FIG. 40, in another embodiment, token 704 can include a uniform resource locator (URL) 4004 that not only redirects at block 404 to intermediation engine 120 via a host name 4008, but also includes multiple path segments 4012 that help tailor results 460d during method 400 and especially at block 440, whether via cached results 460d or by a broader real-time search. Thus, URL 4004 reads: “http: \\Intermediationengine120\content122-3\platform104-2\demographictarget” and includes: a) host name 4008 “Intermediationengine120”; b) first segment 4012-1 which reads: “content 122-3”; c) second segment 4012-2 which reads: “platform 104-2” and d) third segment 4012-3 which reads: “demographictarget1”. URL 4004 is an illustrative example which a person of skill in the art will appreciate includes a host name 4008 as an identifier on network 108 that, at block 404, redirects device 116 from the relevant platform 104 to the intermediation engine 120. The path segments 4012 in URL 4004 identify the content itself, as well as the platform 104 that originated the redirect. The final segment 4012-3 identifies the demographic target on intermediation engine 120 to which the content was directed.

URL 4004 can be helpful where a user identifier object 128 at block 408 may not be known to intermediation engine 120, because the segments 4012 collectively help narrow the demographics of the user 124 that was accessing the content 122 at the time of the redirect. Path segment 4012-3 thus includes the same demographics of users 124 that were indicated to platform 104 at the time of posting content 122-3. Accordingly, intermediation engine 120 is able to infer the demographics of the user 124 that invoked the redirect at block 404, without having full access to the details or identity of the user 124 within user identifier object 128. Path segments 4012 can be encrypted so that identifiable information cannot be ascertained simply by examining the text of URL 4004.

In another embodiment, content 122-3 (or other content 122 including a token 704) may be posted by platform 104-2 (or other platform 104) broadly targeting all client devices 116 without any specific target demographics according to user identifier objects 128. During subsequent performances of block 440 based on selection of token 740, the actual demographic of users 124 that activated token 704 can be ascertained, simply from signals that are gathered, such signals representing the nature of the browsing activities. Thus, a future posting of content 122-3 may now be targeted to the one or more identified demographics. The intermediation engine 120 may process the collected signals to perform user segmentation: multiple clusters of users 124 may be identified, each having specific demographics, and future postings of content 122-3 may be customized according to the clusters of users 124 that have been identified. Thanks to the segmentation, the intermediation engine 120 allows to further tailor search results 460d to specific clusters of users 124, thereby reducing the search domain, and reducing response times and overall network congestion.

The teachings in FIG. 40 are applicable to all variants of system 100 as well as variant token 704c.

Certain aspects of the foregoing discussion have explained how the first results generated at block 440 can be specifically tailored to the geography and/or even uniquely tailored to the user 124. It should also be understood that, likewise, the second results at block 444 can also be tailored to a specific user 124. For example, if user 124 has provided consent to access detailed personal identifying information in user identifier object 128, then various booking options such as fare class, seat class, level of luxury of hotel accommodation, travel dates, and travel duration can be prioritized in the generation of the results at block 444. Furthermore, the various navigations performed by user 124 within the results from block 440 can also be used to infer potential booking option preferences when block 444 is invoked, and the booking options are presented. For example, based on the activity selections 1020 that were browsed, the price ranges of those activity selections 1020 can be tracked, such that when tab 1004-2 is invoked to activate block 444, inferences can be made as to the budget of user 124. In other words, browsing of activity selections 1020 that have a higher cost can lead to the generation of higher-cost fare classes at block 444, while browsing activity selections 1020 that are free or lower cost can lead to the generation of lower-cost fare classes at block 444.

It is to be understood that the first results from block 424 and block 440 (and which can be optionally cached as results 460d) can include, but are not limited to:

1. Local Events and Festivals: Information about upcoming events, festivals, and cultural celebrations in the destination area

2. Local Cuisine and Dining Options: Recommendations for local restaurants, street food vendors, and culinary experiences.

3. Transportation Options: Details about transportation services available in the destination, including public transit, rental cars, ridesharing services, and bike rentals.

4. Accommodation Options: Suggestions for hotels, vacation rentals, hostels, and other lodging options, along with reviews and ratings.

5. Attractions and Landmarks: Information about popular tourist attractions, historical sites, museums, parks, and natural landmarks.

6. Outdoor Activities: Recommendations for outdoor recreational activities such as hiking trails, beaches, water sports, and adventure excursions.

7. Shopping and Markets: Details about local markets, shopping districts, boutiques, and souvenir shops.

8. Nightlife and Entertainment: Suggestions for bars, clubs, theaters, live music venues, and other entertainment options available in the destination area.

9. Local Customs and Etiquette: Insights into local customs, traditions, and cultural norms to help travelers navigate social interactions respectfully.

10. Language and Communication: Basic phrases and language tips for travelers to communicate with locals in the destination area.

11. Health and Wellness: Information about healthcare facilities, pharmacies, fitness centers, spas, and wellness activities available in the destination.

12. Currency and Banking: Guidance on currency exchange rates, banking services, ATMs, and payment methods accepted in the destination country.

13. Travel Tips and Safety Advice: Tips for staying safe and healthy while traveling, including advice on avoiding scams, managing jet lag, and dealing with emergencies.

14. Environmental Considerations: Information about environmental initiatives, eco-friendly practices, and sustainable tourism options in the destination area.

15. Cultural Experiences: Suggestions for immersive cultural experiences such as cooking classes, art workshops, traditional ceremonies, and homestays with local families.

16. Seasonal Activities: Recommendations for seasonal activities and events that vary throughout the year, such as skiing in winter or cherry blossom viewing in spring.

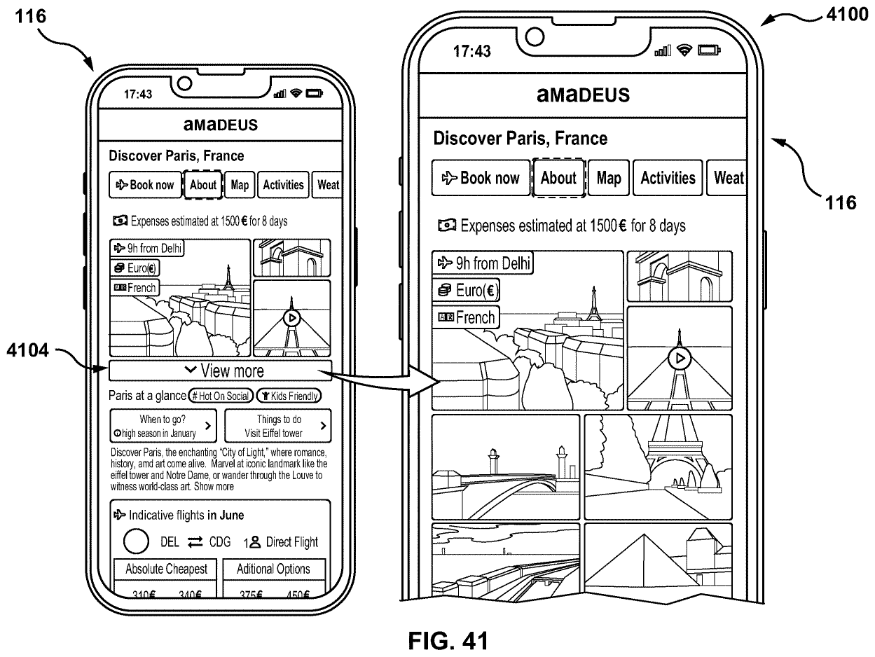

FIG. 41 through FIG. 47 show some specific examples of the above. These examples are not provided to emphasize technical features but rather to illustrate the data that can be maintained in results 460d. These Figures are provided for enablement and full disclosure purposes, but it is to be understood they are non-limiting examples and the technical advantages of this specification are described elsewhere.

Thus, FIG. 41 presents a series of two smartphone screens 4100 that can be generated on client devices 116 depicting various aspects of an interface designed for the discovery and planning of travel to Paris, France. Screens 4100 can be part of results shown at block 440. The leftmost screen provides a succinct overview under the ‘About’ tab with actionable buttons such as ‘Book now’ and additional tabs including ‘Map’, ‘Activities’, and ‘Weather’. Key travel details such as estimated expenses, flight duration from a specified location (Delhi), local currency (Euro), and language (French) are neatly summarized. The central feature, ‘Paris at a glance’, indicates the best time to visit and activities to do, also highlighting family-friendly options and social hotspots, accompanied by a visual thumbnail. An expandable section offers indicative flights for a given month, presenting a range of prices to accommodate budget preferences.

The right screen magnifies the ‘About’ section, emphasizing the ease of navigation to extended information through the ‘View more’ link 4104 on the left-most screen. It mirrors the layout of the leftmost screen, maintaining a cohesive user experience.

These screens 4100 collectively enhance the user's journey of discovering a travel destination by integrating essential travel planning elements into a single, user-friendly mobile application experience.

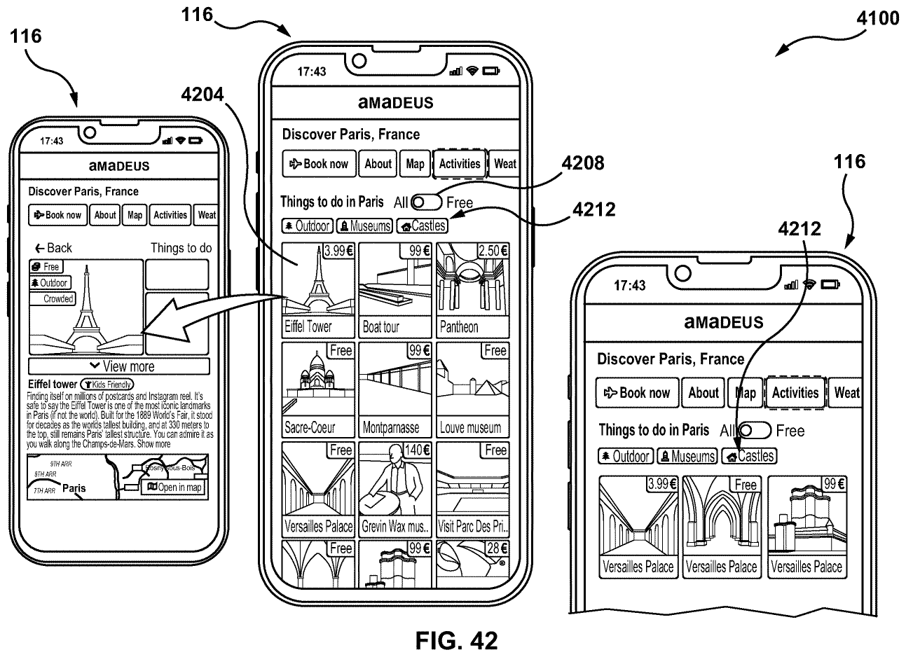

FIG. 42 illustrates a sequence of smartphone screens 4200 from a travel planning application, focusing on the ‘Activities’ feature within the context of discovering Paris, France. Screens 4200 can be part of results shown at block 440. The leftmost screen offers a detailed view of specific activities, such as visiting the iconic Eiffel Tower, marked with user-friendly tags like ‘Free’, ‘Outdoor’, and ‘Crowded’. The interface provides a ‘View more’ option for expanded information and a thumbnail image that encapsulates the essence of the attraction.

The central screen showcases a streamlined filter mechanism that allows toggling on device 116 between viewing all activities or only free activities, enhancing the search experience by enabling budget-friendly planning. The ‘All’ or ‘Free’ toggle-slider 4208 can be used for this filtering. Additional filters categorize activities into ‘Outdoor’, ‘Museums’, and ‘Castles’, illustrated with corresponding images and prices, offering a tailored exploration of Parisian experiences. The ‘Castles’ toggle is labelled at 4212. Selecting the “Eiffel Tower” image 4204 in the middle screen leads to an expanded discussion on the left most screen.

The rightmost screen underscores the application's capability to filter activities based on categories. This intuitive design allows users to quickly sort through various options and identify activities that align with their interests, whether it be outdoor adventures or cultural excursions. It also emphasizes the focus on user-centric design, making the planning process as accessible and personalized as possible.

Collectively, FIG. 42 conveys the depth and flexibility of the travel planning application's ‘Activities’ interface, allowing users to effortlessly customize their Parisian adventure with a few simple taps.

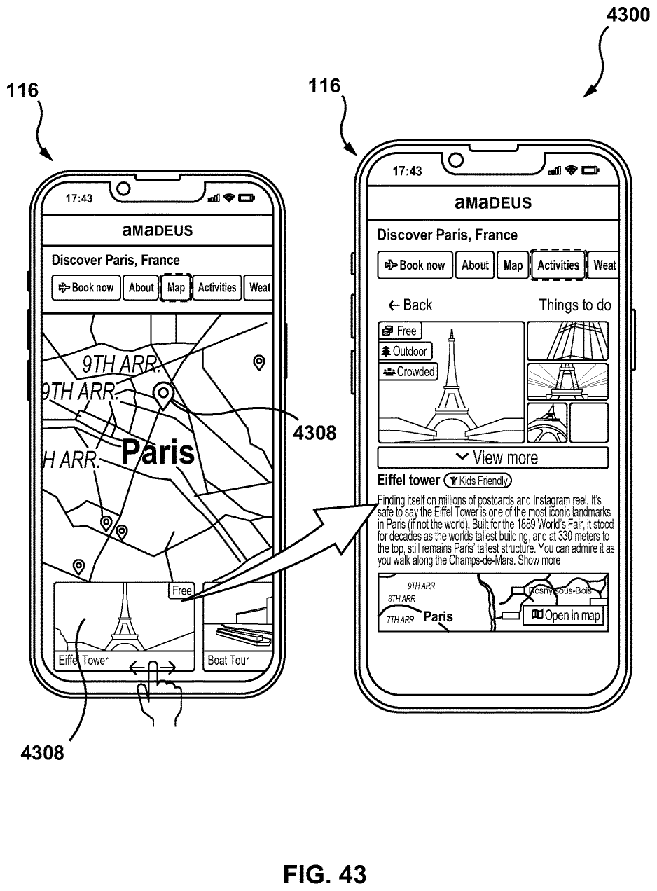

FIG. 43 displays two smartphone screens 4300 from a mobile application, emphasizing the exploration and activity planning functionalities for a trip to Paris, France. Screens 4300 can be part of results shown at block 440.

The screen 4300 on the left highlights the application's map view, pinpointing various attractions within Paris, with a pin 4304 on the map that becomes associated with a plurality of icons 4308. The icons 4308 include the Eiffel Tower and a Boat Tour, suggesting locations of interest that users can explore. This geolocation feature provides a spatial context for planning, allowing users to visualize the proximity of different activities and attractions in relation to each other in the 9th and 7th arrondissements of Paris.

The screen 4300 on the right delves into a specific activity, detailing the Eiffel Tower. The application describes it as ‘Kids Friendly’ and provides key information such as the landmark being free, ideal for outdoor visits, and its popularity leading to crowded scenarios. The description tantalizes the user with the Eiffel Tower's cultural and historical significance and invites further exploration through a ‘View more’ link. This focused view also includes practical features such as weather indicators and direct links to maps, enhancing the user's ability to plan their visit effectively.

Together, FIG. 43 illustrates the application's integrated approach to travel planning, combining practical navigation tools with enriching activity details to create an intuitive and informative user experience.

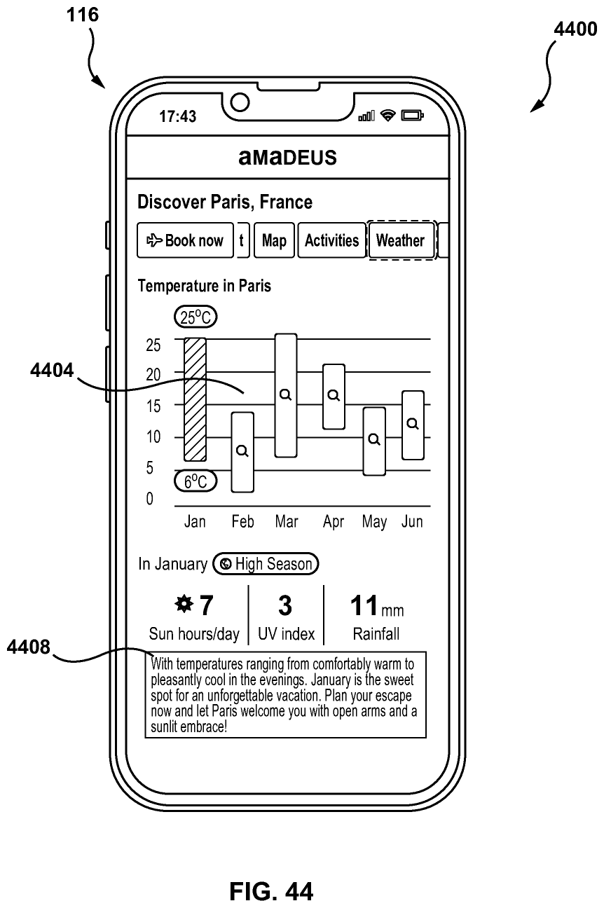

FIG. 44 showcases a smartphone screen 4400 from a travel application's ‘Weather’ tab, providing users with comprehensive climatic details for Paris, France. The interface features a graphical representation of temperature trends 4400 throughout the year, offering a quick visual on the range from the coolest to warmest months. Screens 4400 can be part of results shown at block 440.

Highlighted on the screen is the month of January, indicating it as the high season for tourism. Essential weather statistics for January are neatly displayed, including the average number of sun hours per day, the UV index, and expected rainfall, all critical factors for travelers planning their itineraries.

Beneath the statistics, a brief narrative 4408 underscores January's appeal, describing it as a “sweet spot” for vacation with comfortable temperatures and a city welcoming tourists with “open arms and a sunlit embrace.” This engaging description couples the quantitative data with qualitative allure, enhancing the user's anticipation of the travel experience.

This screen 4400 serves not only as a practical tool for trip planning but also as an invitation to explore the beauty and charm of Paris, encouraging users to book their journey during a favorable season.

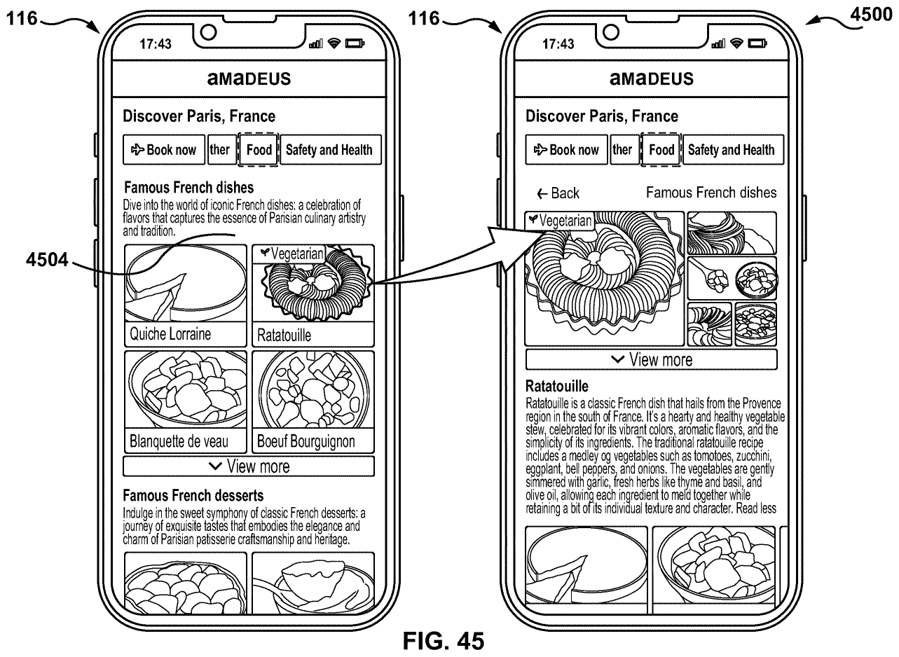

FIG. 45 illustrates a pair of smartphone screens 4500 for display on device 116, providing a glimpse into the culinary delights of Paris, France. Screens 4500 can be part of results shown at block 440.

The left screen introduces a section titled ‘Famous French dishes,’ described as a dive into the “essence of Parisian culinary artistry and tradition.” It displays an array of classic French dishes, including Quiche Lorraine and Ratatouille, each with a corresponding image to visually entice the user. A Vegetarian icon 4504 next to the Ratatouille suggests dietary categorization for easier navigation. Below, a ‘View more’ prompt invites users to delve deeper into the selection, hinting at a broader culinary journey. Additionally, a subsection on ‘Famous French desserts’ teases the sweet conclusion of any French meal.

Expanding on the selection, the right screen focuses on Ratatouille, a traditional dish that epitomizes the vibrancy of French country cooking. It offers a detailed description of the dish's heartiness, its colorful vegetable medley, and the simplicity of its preparation, underscoring the flavors and techniques that make French cuisine globally renowned. A ‘Read less’ option implies that an even more elaborate narrative is available for the gastronomically curious.

Together, the screens 4500 invite users to explore the rich tapestry of French cuisine through an engaging and informative interface, encouraging them to experience the tastes of Paris as an integral part of their travel plans.

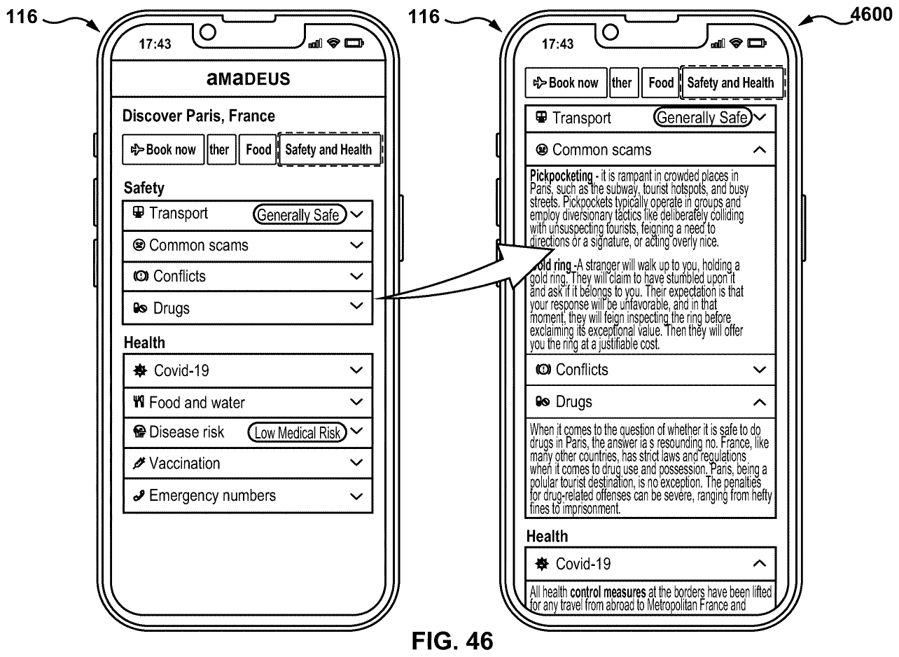

FIG. 46 portrays a sequence of smartphone screens 4600 from a mobile application, offering detailed information on safety and health for travelers exploring Paris, France. Screens 4600 can be part of results shown at block 440.

The left screen is organized into two main sections: ‘Safety’ and ‘Health’. Under ‘Safety’, categories like Transport (noted as ‘Generally Safe’), Common scams, Conflicts, and Drugs are listed, each with a dropdown option for more details. The ‘Health’ section is similarly structured, covering critical issues such as Covid-19, Food and water (highlighted with ‘Low Medical Risk’), Disease risk, Vaccination, and Emergency numbers, indicating the app's comprehensive approach to traveler well-being.

Transitioning to the right screen, the app delves deeper into the ‘Common scams’ category, with specific warnings and descriptions of common scenarios such as ‘Pickpocketing’, prevalent in crowded tourist areas, and the ‘Gold ring’ scam, detailing the modus operandi of scammers. It provides preventive advice to ensure travelers can stay vigilant and safe.

Additional information is provided on drug-related laws under the ‘Drugs’ subcategory, clearly stating the strict regulations and severe penalties for drug offenses in France, ensuring travelers are aware of the local laws.

The ‘Health’ section is briefly visible, with the header for Covid-19 indicating updated information on health control measures, suggesting that the app provides current and relevant health advisories.

Collectively, screens 4600 serve as an educational resource, aimed at safeguarding the health and security of users by equipping them with essential knowledge to navigate potential risks while enjoying their visit to Paris.

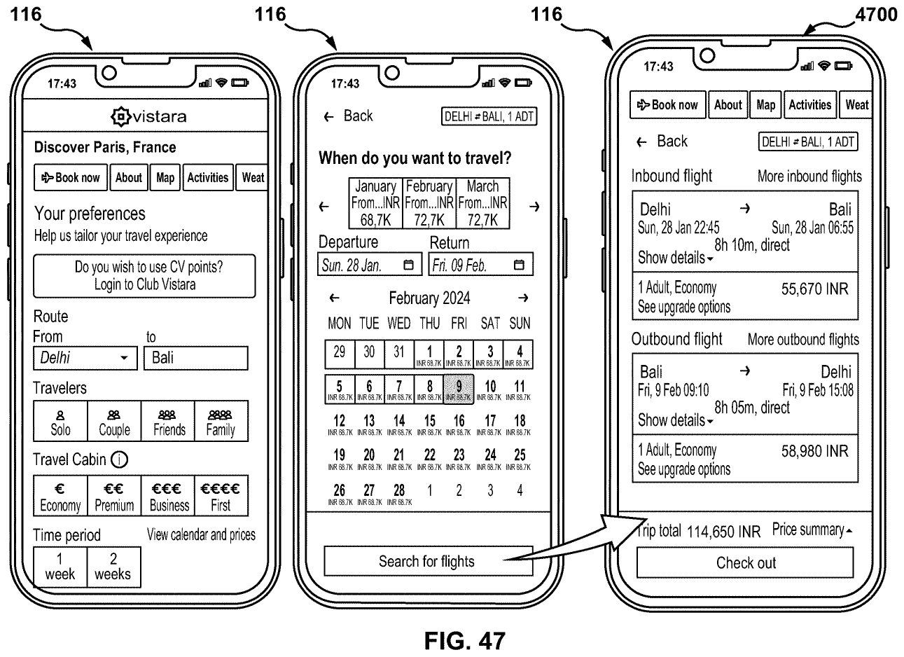

FIG. 47 exhibits three smartphone screens as part of a travel application, guiding the user through the process of booking a flight. While screens on FIG. 41 through FIG. 45 show examples of results shown at block 44, screens 4700 can be part of results shown at block 444 for the building of an actual travel schema.

The leftmost screen focuses on personalizing the user's flight search under the ‘Book Now’ tab. It prompts users to specify preferences such as route selection, with an example of Delhi to Bali, and the number of travelers, indicating options for solo, couple, friends, or family. There is also an option to choose the travel cabin class, ranging from Economy to First. A section for indicating the desired time period for the trip is visible, with choices from ‘1 week’ to ‘2+weeks’, and a button to ‘View calendar and prices’ suggests a user-friendly interface for finding the best deals.

The middle screen displays a calendar view under the header “When do you want to travel?” where users can select their departure and return dates. The calendar provides an overview of months, with the current month highlighted and populated with daily price indicators, enabling users to make informed decisions based on cost and convenience. A ‘Search for flights’ button is prominently placed at the bottom, inviting users to proceed with their chosen dates.

Transitioning to the right screen, users are presented with the selected flight options for both inbound and outbound journeys. Each flight entry includes the departure and arrival times, flight duration, and offers detailed visibility, like ‘Show details’ and ‘See upgrade options’. The price for each leg of the journey is listed, and a cumulative total for the trip is calculated at the bottom. A ‘Check out’ button leads the user towards finalizing the booking.

FIG. 47 exemplifies the comprehensive booking system available at block 444, facilitating users with detailed information and options to customize their flying experience, all contributing to an efficient and tailored travel planning process.

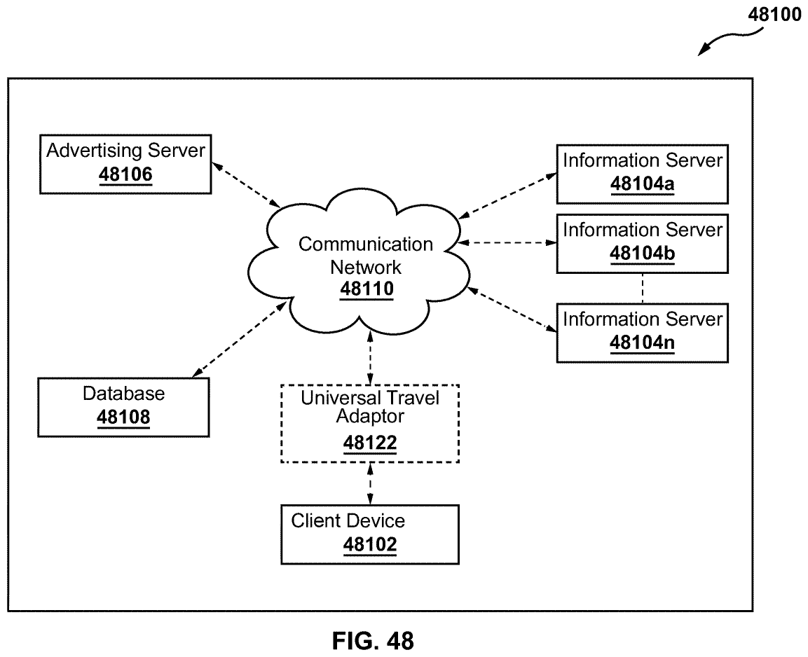

FIG. 48 illustrates a network system 48100 for providing assistance to the user in accordance with the embodiments of the present disclosure. For example, the network system 48100 may comprise a client device 48102, a plurality of information servers 48104a-n, an advertising content server 48106, a database 48108 and a communication network 48110.

Network system 48100 is a variant on system 100, system 100a, system 100b, and system 100d. Likewise, client device 48102 is a variant on client devices 116, database 48108 is a variant on datasets 228. Communication network 48110 is equivalent to network 108.

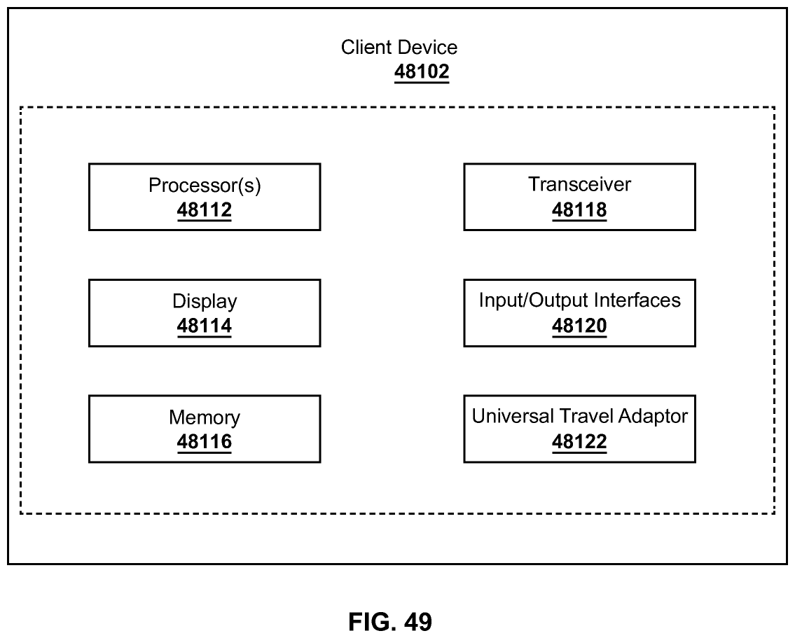

The client device 48102, the plurality of information servers 48104-a-n, the advertising content server 48106 and the database 48108 are communicatively coupled to each other via the communication network 48110. The communication network 48110 may be a wired network or a wireless network or a combination thereof. Further, the client device 48102 may be coupled to the communication network 48110 via a universal travel adaptor 48122. In a non-limiting embodiment of the present disclosure, the universal travel adaptor 48122 may be a part of the client device 48102, as shown in FIG. 49. In another non-limiting embodiment of the present disclosure, the client device 48102 may be an electronic device that possesses the capability to perform computational tasks, process data, and store information. The client device 48102 can be any type of computing device be selected from a group comprising: a laptop, a smartphone, a tablet, a personal computer, television, personal data assistance, wearable devices, etc., but not limited thereto. The client device 48102 may be a versatile computing machine comprising a central processing unit (CPU), memory, storage, input/output devices (such as a keyboard, mouse, and display/touch-display), and connectivity options like USB, Ethernet, and Wi-Fi. The client device 48102 may also employ a touchscreen display, built-in sensors (such as an accelerometer and GPS), and support for mobile applications.

According to an embodiment of the present disclosure, as shown in FIG. 49, the client device 48102 may comprise at least one processor 48112, a display 48114, a memory 48116, a transceiver 48118, an input/output interface 48120, and the universal travel adaptor 48122, but not limited thereto. The at least one processor 48112 may include, but not restricted to, microprocessors, microcomputers, micro-controllers, central processing units, state machines, logic circuitries, and/or any devices that manipulate signals based on operational instructions. In an embodiment of the present disclosure, the processor 48112 may also be implemented as a combination of devices, e.g., a combination of a plurality of microprocessors or any other such configuration. The at least one memory 48116 may be communicatively coupled to the at least one processor 48112 and may comprise various instructions. The at least one memory 48116 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 48112 may be configured to execute one or more instructions stored in the memory 48116. The interface 48120 may include a variety of software and hardware interfaces, for example, a web interface, a graphical user interface, an input device-output device (I/O) interface, a network interface, and the like.

Further, the computing device 48102 may have one or more digital platform applications installed therein to enable a user to access one or more digital platforms. Such platforms are not shown in FIG. 48, but are substantially equivalent to platforms 104 or variants thereon. In an embodiment of the present disclosure, the digital platforms may be described as online ecosystems that utilize digital technologies and the internet to enable exchange of information and services among its participants. These platforms may create a virtual space where users can interact, collaborate, and engage with various activities. These platforms operate in an online environment, leveraging internet connectivity and web-based technologies. The digital platforms typically cater to multiple user groups, such as sender, recipient, consumers, producers, service providers, and advertisers. (As an example of one group, in FIG. 48, advertising content server 48106 can host on behalf of these advertisers. The other groups can participate with the digital platforms with their own servers, not shown in FIG. 48). The digital platforms facilitate transactions and interactions between users by providing the necessary infrastructure, tools, and services. The digital platforms rely on data generated by user interactions to enhance experiences, personalize services, optimize operations, and facilitate targeted advertising. These platforms offer a range of services and applications, such as e-commerce, social networking, content sharing, OTT media services, and on-demand services, but not limited thereto. In a non-limiting exemplary embodiment, the digital platform may be: a social media platform such as, but not limited to, Facebook™, Instagram™, Snapchat™, Twitter™, WhatsApp™, which enables users to connect, share media items, and engage with others; or a streaming application, such as, but not limited to, Netflix™, Prime Video™, or Disney+Hotstar™, which provides a platform for streaming image content, audio visual content including shows, movies, and other forms of content.

At present various photo applications enable a user to capture media items such as photos and/or videos. In a non-limiting embodiment of the present disclosure, a photo application may be selected from a group of: a software application or mobile app that allows the user to capture photos and/or record videos via camera, and/or manipulate media in various ways, but not limited thereto. The user may send a media item to one or more contacts or may feed or upload the media item on the digital platforms. The media item may depict/refer to at least one destination. Recipient or viewing users can view the posted media item and provide reactions e.g. like, dislike, rating, commenting, or emoticons at any time. Upon viewing, the user may like the destination depicted in the media item and may wish to visit or travel to the destination. The present invention provides an interactive travel assistance to a user for planning the travel to a destination depicted in a media item, if desired.

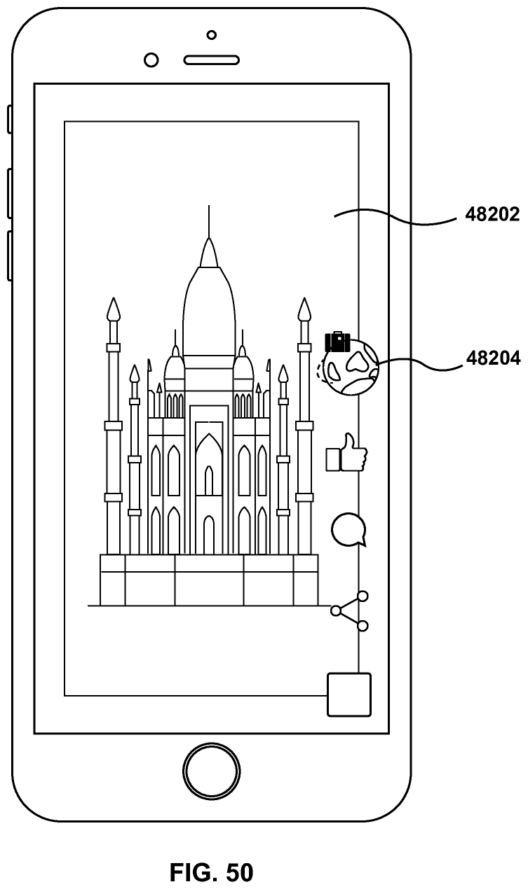

In an embodiment of the present disclosure, a media item 48202, from the platforms, may be presented to a user based on his/her profile via a digital platform, as shown in FIG. 50. The profile of the user may comprise one or more of: interests and/or preferences of the user, travel history of the user, web history of the user, profile of the user on digital platforms, interactions of the user with digital platforms, emotional and/or sentimental profile of the user, demographic details of the user and personal data of the user stored on one or more computing devices. In another embodiment of the present disclosure, the media item 48202 may be presented to the user randomly. In yet another embodiment of the present disclosure, the media item 48202 may be presented to the user based on his/her current geo-coordinates. Further, the profile of the user may be dynamically updated based on activities performed by the user on the digital platforms. In a non-limiting embodiment of the present disclosure, the activities such as interactions i.e., liking, commenting, sharing, following, and purchasing may generate data that may be collected and stored by the platform. The data may also comprise information related to type of content with which the user engages, and preferences and/or interests of the user, etc. The data may be analyzed using algorithms and/or machine learning techniques to gain insights into the user's preferences and/or interests. These insights may be used to update the user's profile.

In an exemplary embodiment, the interests and/or preferences of the user may define specific areas, topics, activities, or choices that the user may find appealing or prefer over others. Interests and/or preferences may be determined using various methods. In an example, the user may directly declare his/her interests and/or preferences through surveys, questionnaires, or profile settings, where he/she may provide information about his/her likes, dislikes, hobbies, or favorite activities. Alternatively, the user's behavior such as interactions, clicks, searches, and patterns of engagement, may be analyzed to infer the interests and preferences. In another exemplary embodiment, implicit feedback such as analyzing the content consumed, products purchased, or articles read, may be used to get the insights for interests and/or preferences. Additionally, social interactions within networks or online communities may be examined to determine the interests and/or preferences of the user.

In an exemplary embodiment of the present disclosure, the travel history of the user may define the user's past travel experiences, including destinations visited and the relevant details associated with the trips. The travel history may be determined based on booking history of the user such as booked flights, accommodations, or other travel services through online platforms or agencies. The travel history may comprise information such as details of destinations, travel dates, and itineraries. In another embodiment, travel experiences shared by the user on social media platforms or through photo-sharing websites such as posts, check-ins, or uploaded photos may be analyzed to gather information about the travel destinations and activities.

In an exemplary embodiment, the web history of the user may be determined based on one or more of: history logs of the websites visited by the user, cookies and caches, using website analytics which may use any analytics tool to track the user's integration with the sites, and a history of the user's search queries. Such web history can be maintained as part of user identifier object 128.

In an exemplary embodiment, the profile of the user on the digital platforms may represent an individual's online identity within a specific platform. It may provide details about the user's background, preferences, activities, and interactions within the platform. Such profiles of the user can be maintained as part of user identifier object 128.

This may include basic information such as the user's name, username, profile picture, age, gender, location, occupation, and interests and any required identifying details. The profile also maintains a history of the user's activities, including posts, comments, likes, shares, and messages. Further, preferences and settings specific to the platform, such as language and content preferences, also contribute to the profile.

In an exemplary embodiment, interactions of the user with digital platforms refer to the various ways in which individuals engage, communicate, and interact within the digital platform. In an embodiment, interaction may be through content consumption, where users browse websites, view articles, watch videos, or listen to audio content. They may also engage in active participation by commenting on posts, sharing content with others, or expressing their opinions through likes, ratings, or reviews. This also comprises engagement in conversations through messaging features, participation in group discussions, or networks based on shared interests. In an embodiment, transactions and e-commerce activities are also important interactions on the digital platforms.

In an embodiment, emotional and/or sentimental profile of the user may refer to emotional traits, preferences, and sentiments that reflect the user's personal experiences and feelings within the context of the digital platforms. The emotional profile indicates the user's positive or negative reactions to different media items on the platform. By understanding emotional and/or sentimental profile, more personalized experiences and tailored content may be provided to the user.

In an embodiment, the demographic details of the user may comprise information such as age, gender, location, education, occupation, and other relevant factors. These details can enable better understanding of the user and tailor experiences, recommendations, and advertisements to align with their demographic profile.

Further, after displaying the media item 48202 to the user, the processor 48112 may determine whether the media item 48202 i.e., image and/or video depicts at least one destination. In a non-limiting exemplary embodiment, the image may be an image of a painting or drawing of the at least one destination. The at least one destination may refer to a specific place or location that may be of interest to the user for various purposes such as tourism, business, leisure, or exploration. The at least one destination may be a city, a region, a country, or even a specific landmark or attraction within a larger geographical area, an architectural landmark, a museum, a theme park, a shopping district, a culinary specialty, an outdoor adventure opportunity, a vibrant cultural event, or popular tourist hotspot known for its cultural heritage, historical significance, natural beauty, or recreational activities. In response to determining that the media item 48202 depicts the at least one destination (such as Taj mahal as shown in FIG. 50), the processor 48112 can display the travel button 48204 over the media item 48202, as shown in FIG. 50. In an embodiment, the travel button 48204 can also be referred to as travel icon, which can be a graphical representation or symbol that the user can click or select or tap on to access information related to the at least one destination.

In an embodiment, upon determining that the media item 48202 depicts the at least one destination, the processor 48112 can determine whether the media item 48202 is an authenticated media item or not. Particularly, the processor 48112 can determine whether the media item 48202 is depicting a real-word destination or not. In an embodiment, the authenticity of the media item 48202 can be determined based on metadata that provides information about origin and creation of the media item 48202. In another embodiment, any third-party tool can be used to check the authenticity of the media item 48202. In another embodiment, the digital platform can verify the authenticity of the media item 48202 and can associate information/label with the media item 48202 which can indicate the authenticity of the media item 48202. The processor 48112 can analyze the associated information to determine whether the media item 48202 is authenticated or not. In response to the determination that the media item 48202 is the authenticated media item, the processor 48112 can display the travel button 48204 over the media item 48202.

In another embodiment, upon determination that the media item 48202 depicts the at least one destination, the processor 48112 can display the travel button over the media item 48202 based on an engagement of the user with the media item 48202. In an embodiment, the user's engagement with media item 48202 can comprise active interaction, involvement, and interest demonstrated by the user when interacting with the media item 48202. The engagement can include a wide range of actions and behaviors exhibited by the user corresponding to the media item 48202. The user can comment, share, like, dislike, or rate the media item 48202 on the digital platforms to express his/her opinions, thoughts, emotions, or reactions. In another embodiment, the engagement can also include emotional responses of the user to the media item 48202 i.e., laughter, surprise, anger, empathy, or other emotions. The emotional responses signify the engagement and indicate a strong impact of the media item 48202 on the user. The engagement can also include amount of time spent by the user for watching, interacting, or viewing the media item 48202, as well as actively participating in discussions, providing feedback, and sharing the media item 48202 with others. In another embodiment, to display the travel button 48204, engagements of other users with the media item 48202 can also be considered. The number of likes, shares, and comments received by the media item 48202 can be tracked to determine the engagement of other users with the media item 48202. Higher numbers of likes, shares, and comments generally suggest greater engagement. In an embodiment, the engagement of the user can be measured using various analytical methods. In an example, the engagement can be measured by tracking the likes, shares, and comments of the user. In another example, the processor 48112 can determine an engagement score based on the engagement of the user and display the travel button 48204 if the engagement score exceeds a predefined threshold.

In another embodiment, upon determination that the media item 48202 depicts the at least one destination, the processor 48112 can display the travel button 48204 over the media item 48202 based on determination whether the media item 48202 is the authenticated media item as well as based on the engagement of the user or others with the media item 48202. In another embodiment, the processor 48112 can display the travel button 48204 over the media item 48202 based on one or more predefined criteria such as whether the media item 48202 matches with the profile of the user, but not limited thereto. The processor 48112 can determine whether the media item 48202 is matching with the profile of the user and upon determination that the media item 48202 matches with the profile of the user, the travel button 204 can be displayed on the media item 48202. In yet another embodiment, for displaying the media item 48202, the processor 48112 can determine whether the media item 48202 is the authenticated media item and whether the media item 48202 matches with the profile of the user. In response to the determination, the travel button 48204 can be displayed on the media item 48202.

In an embodiment, displaying the travel button 48204 can comprise enabling an already displayed travel button or freshly displaying the travel button. In an example, enabling the travel button 48204 can comprise making the already displayed button 48204 visible and interactive to allow the user to engage with it. This can also comprise activating a previously hidden or disabled icon based on the predefined criteria. Further, enabling the already displayed travel button 48204 can also comprise changing visual appearance of the button 48204 i.e., changing its color, opacity, or adding an indicator to signify its active state, but not limited thereto. For example, the button 48204 can be previously dimmed indicating that the function associated with the button is currently unavailable and it can become fully colored or highlighted indicating that the function associated with the button 48204 is now available. Whereas, freshly displaying the travel button 48204 can comprise rendering a new button 48204 on the display interface for the first time when the one or more predefined criteria are met. The fresh travel button 48204 can be displayed on appropriate locations on the media item 48202.

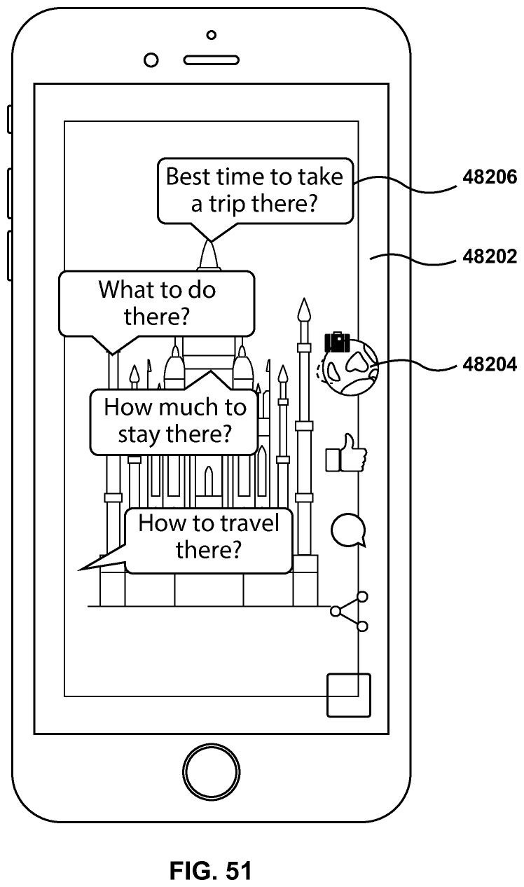

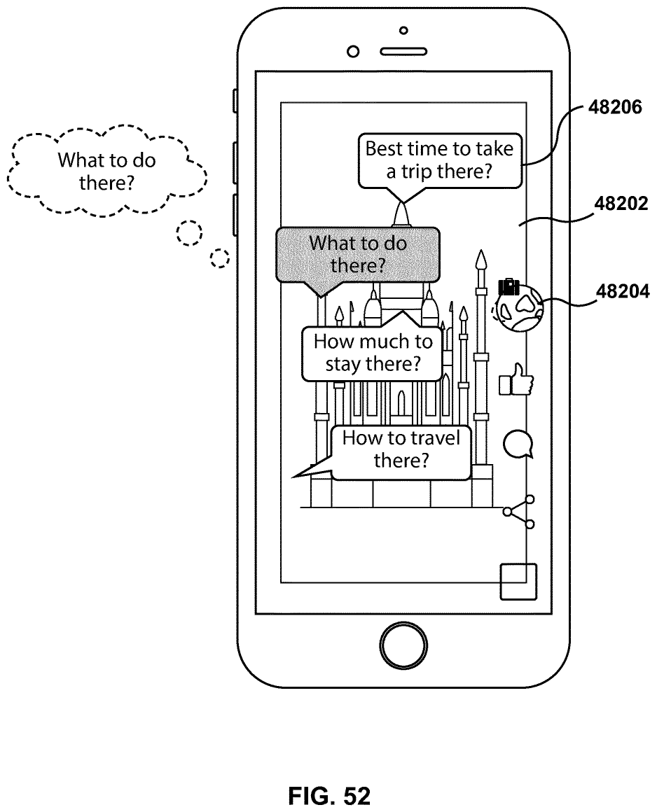

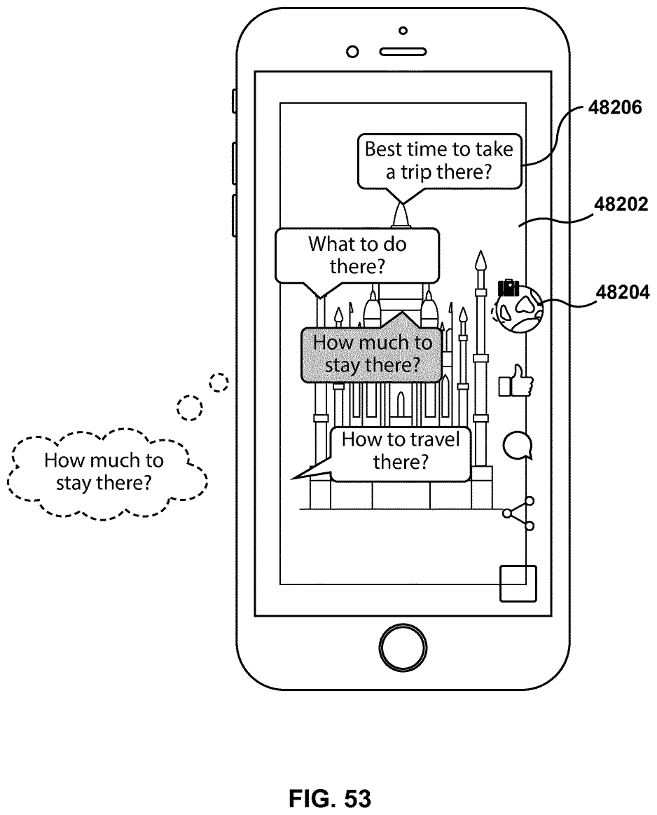

After displaying the travel button 48204 on the media item 48202, the processor 48112 can receive an input selection indicative of selection of the travel button 48204 by the user. In response to receiving the input selection indicative of the selection of the travel button 48204, the processor 48112 can render a plurality of selectable overlays 48206 over the media item 48202 to assist the user to plan the travel to the at least one destination, as shown in FIG. 51. The plurality of the selectable overlays 48206 can be associated with the at least one travel destination depicted in the media item 48202. In an embodiment, each of the plurality of selectable overlays 48206 associated with the at least one travel destination is a hyperlink corresponding to a category selected from a group comprising: dining and cuisine, attractions and activities, accommodation, shopping, transportation, and travel period. Each of the selectable overlays 48206 provides context, details, and/or interactive features related to the at least one destination location. In an embodiment, the selectable overlays 48206 can be in the form of text or icons which can provide details about points of interest, landmarks, dining and cuisine, attractions and activities, accommodation, shopping, transportation available at the destination. The selectable overlays 48206 can also provide labels, descriptions, ratings, reviews for the destination and its associated landmarks, dining and cuisine, attractions and activities, accommodation, shopping, transportation, etc. The selectable overlays 48206 can provide interactive features to allow the user to engage with the destination. The user can click or tap or touch on a specific overlay 48206 to access additional information, as shown in FIGS. 52 and 53. The selectable overlays 48206 associated with the at least one destination enhance the user's experience and understanding of the destination by providing relevant, interactive, and visually appealing information.

In an embodiment, the one or more selectable overlays 48206 among the plurality of selectable overlays 48206 can be augmented reality overlays, which can overlay digital information or virtual objects onto the real-world view of the destination. The AR overlays can comprise 3D models, informational tags, or interactive elements that can improve the user's perception and understanding of the destination.

In an embodiment, the processor 48112 can render the plurality of selectable overlays 48206 based on one or more factors. The one or more factors can be one or more of: the profile of the user, the at least one destination, weather, season, etc., but not limited thereto. In one embodiment, the processor 48112 can fetch the plurality of selectable overlays 48206 from a predefined list of selectable overlays and can render the fetched plurality of selectable overlays 48206. In another embodiment, the processor 48112 can dynamically generate the plurality of selectable overlays 48206 based on one or more of: the profile of the user, the at least one travel destination, weather, season, etc., but not limited thereto.

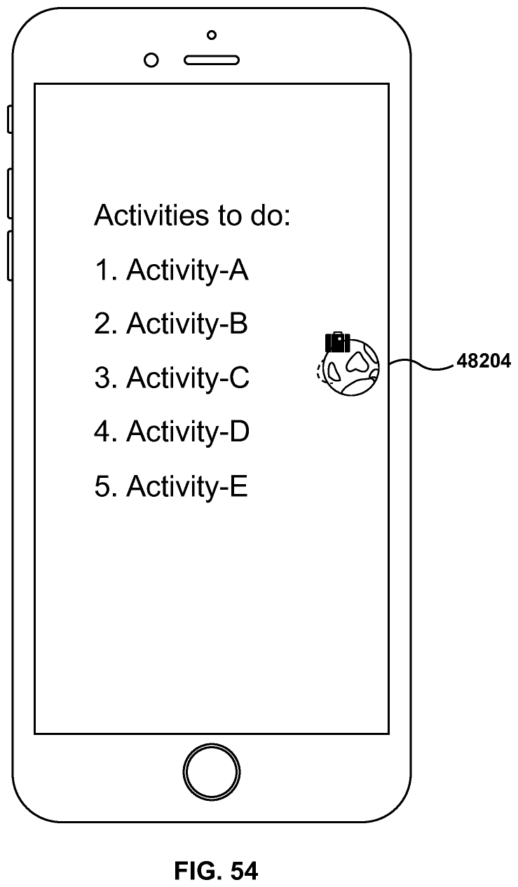

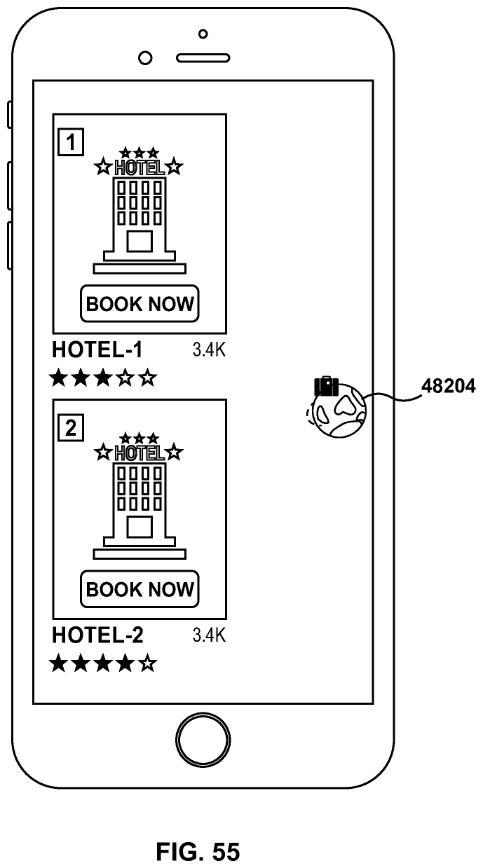

Upon rendering the plurality of selectable overlays 48206, the user can select or tap or click on one or more of the plurality of overlays 48206 to obtain information related to the at least one destination. The processor 48112 can receive an input selection indicative of selection of a selectable overlay 48206 from the plurality of selectable overlays 48206. In response to the selection of the selectable overlay 48206, the processor 48112 can generate travel assistance content information corresponding to the selected overlay 48206 and present the generated travel assistance content information to the user for planning travel to the at least one travel destination, as shown in FIG. 54 and FIG. 55. In an embodiment, the travel assistance content information is generated based at least in part on a profile of the user.

In an embodiment, to generate the travel assistance content information corresponding to the selected overlay 48206, the processor 48112 can fetch information available for the selected overlay 48206 from one or more information servers 48104 via a universal travel adaptor 48122 and determine the travel assistance content information from the available information based on the profile of the user. To determine the travel assistance content information from the available information based on the profile of the user, the processor 48112 can use data filtering techniques to determine the relevant information based on the profile of the user. In another embodiment, to generate the travel assistance content information corresponding to the selected overlay 48206, the processor 48112 can only fetch relevant information available for the selected overlay 48206 from one or more information servers via the universal travel adaptor 48122 based on the profile of the user. In an embodiment, the universal travel adaptor 48122 can be a software plug-in which can enable fetching of the information from the one or more servers. In an example, the universal travel adaptor can utilize one or more of techniques such as, but not limited to, Application Programming Interfaces (APIs), web scraping, database queries, direct server access, etc., to fetch the information from the one or more servers. In an embodiment, to generate the information, the processor 48112 can access the database 48108 and retrieve the relevant information based on the profile of the user. In an embodiment, information can be fetched from the one or more servers 48104 and stored in the database 48108 periodically. Universal travel adapter 48122 can thus be a variation of the previously mentioned digital travel storefront (DTS) in relation to QR-code token 704c.

In an embodiment, the one or more servers 48104 act as sources of information related to the at least one destination. In an embodiment, the one or more servers 48104 can be one or more of: destination information servers, transportation servers, accommodation servers, weather information severs, travel review servers, local information servers, or any other sever that can provide information related to the at least one destination for planning travel to the at least one destination, but not limited thereto. Indeed, servers 48104 collectively serve as a source of data for block 424 of method 400 or for block 432 of method 400.

In an embodiment, the destination information servers can provide information about attractions, landmarks, local transportation options, local customs, etc., but not limited thereto. The transportation servers can provide transportation related information, such as information related to schedule, route, and/or fair of one or more of; flight, train, bus, and vehicle rental services, but not limited thereto. Further, the accommodation servers can provide information about hotels, vacation rentals, hostels, and other lodging options available at the destination, to enable the user to select accommodation based on one or more of: price, location, amenities, and reviews, but not limited thereto. Further, the weather information servers can provide up-to-date weather forecasts, historical climate data, and weather-related information for the at least one destination. This can assist the user to plan his/her travel dates, carry appropriate clothing, and anticipate any weather-related challenges, but not limited thereto. Furthermore, the travel review servers can provide reviews, ratings, and personal experiences shared by other users for the at least one destination. Furthermore, the local information servers can provide local information related to the at least one destination. The local information can correspond to local events, festivals, cultural activities, dining and cuisine options, shopping options, etc., but not limited thereto.

In response to presenting the information to the user corresponding to the selected overlay 48206, the user can perform certain actions corresponding on the presented travel assistance content information corresponding to the selected overlay 48206. In an exemplary embodiment, the actions performed by the user on the travel assistance content information can be any one of: booking accommodation, making transportation arrangements, opting for attraction and/or activities, making reservations for dining, buying tickets for local events and/or festivals, seeking additional recommendations and/or information, but not limited thereto. Such actions indicate preferences and interests of the user.

The processor 48112 can receive one or more inputs indicative of one or more actions performed by the user on the travel assistance content information. A skilled person would appreciate the fact that actions performed by the user corresponding to one type of information related to the destination for travel planning can have interconnected effects on other aspects of the travel planning. For example, the choice of accommodation can impact transportation decisions and vice versa. If the user selects a hotel located in a specific area, the local transportation options for convenient access to attractions can also change. In another example, if the user makes reservation for local dining and cuisine, this can also influence the choice of accommodation. It would be wise to recommend accommodations in the areas known for the authentic local dishes. Since, the inputs provided by the users for one type of information can have a cascading effect on the rest of travel assistance information, the processor 48112 can dynamically generate travel assistance content information for the remaining selectable overlays 48206 based on the one or more actions performed by the user. In another embodiment of the present disclosure, the processor 48112 can also dynamically update the profile of the user based on the one or more actions performed by the user. This can provide the travel assistance content information according to the interests and/or preferences, constraints, and desired experiences of the user.

In an embodiment, the processor 48112 can generate such dynamic information by fetching information from the servers 48104 in response to selection of the selectable overlay 48206. In another embodiment, the processor 48112 can access the database 48108 and retrieve the relevant information based on the profile of the user. In an embodiment, information can be fetched from the one or more servers 48104 and stored in the database 48108 periodically.

In a non-limiting embodiment of the present disclosure, when the media item 48202 is a generic media item depicting more than one destination, one of the selectable overlays 48206 can provide a list of destinations to the user for selection of one destination of interest. In an embodiment, the list of destinations can be provided based on one or more factors, but not limited to, whether travel possibilities exist to the destinations, travel origin/geo-location of the user, cost of the travel, but not limited thereto. In an embodiment, the media item 48202 can depict a beach where travel is possible. Thus, a user can get the list of top beaches as the destinations. For example, the user can get a proposal for Nice or Capri or Bali, but not limited thereto. In another embodiment, the media item 48202 can depict a beach and the user can get the list of beaches based on the current geo-location of the user. For example, a user based in Paris can get a proposal for Nice or Normandy or Marseille but not limited thereto. Further, upon selection, the processor 48112 can also dynamically generate the travel assistance content information corresponding to the overlays 48206 based on the destination selected by the user.

In this manner, by presenting the travel assistance content information to the user, the present disclosure enables the user to make informed decisions and find suitable accommodations and transportation for effective travel planning that aligns with the preferences, constraints, and desired experiences of the user.

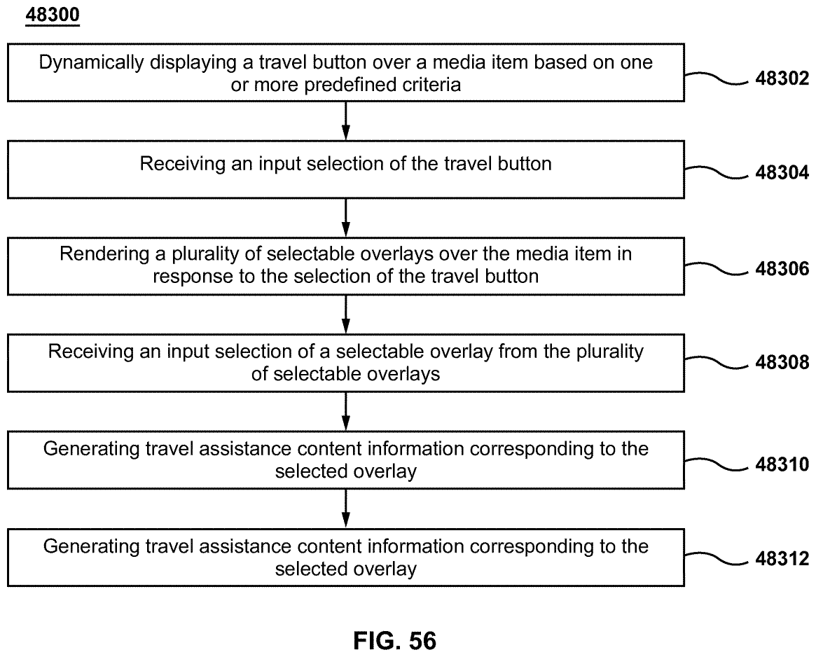

FIG. 56 is a flow diagram illustrating an exemplary method 48300 providing interactive travel assistance to a user. Method 48300 can be performed on client device 48102. The blocks of the flow diagram shown in FIG. 56 have been arranged in a generally sequential manner for ease of explanation; however, it is to be understood that this arrangement is merely exemplary, and it should be recognized that the processing associated with method 48300 (and the blocks shown in FIG. 56) can occur in a different order (for example, where at least some of the processing associated with the blocks is performed in parallel and/or in an event-driven manner).

At block 48302, the method recites dynamically displaying a travel button 48204 over a media item 48202 based on one or more predefined criteria. The media item 48202 comprises an image or a video of at least one travel destination. In an non-limiting embodiment, the block 48302 i.e., displaying a travel button 48204 over a media item 48202 based on one or more predefined criteria comprises determining whether the media item 48202 is an authenticated media item 48202 and displaying the travel button 48204 on the media item 48202 in response to the determination that the media item 48202 is the authenticated media item 48202. In a non-limiting embodiment of the present disclosure, the method comprises displaying the media item 48202 on a client device 48102 based on one or more of: the profile of the user, one or more search requests from the user; and geo-coordinates of the user.

In another non-limiting embodiment, the block 48302 i.e., displaying a travel button 48204 over a media item 48202 based on one or more predefined criteria comprises displaying the travel button 48204 on the media item 48202 based on engagement of the user with the media item 48202. In another non-limiting embodiment, the block 48302 i.e., displaying a travel button 48204 over a media item 48202 based on one or more predefined criteria comprises determining whether the media item 48202 is an authenticated media item 48202, determining engagement of the user with the media item 48202 in response to the determination that the media item 48202 is the authenticated media item 48202, and displaying the travel button 48204 on the media item 48202 based on the engagement of the user with the media item 48202.

In another non-limiting embodiment of the present disclosure, the block 48302 i.e., displaying a travel button 48204 over a media item 48202 based on one or more predefined criteria comprises determining whether the media item 48202 is matching with the profile of the user and displaying the travel button 48204 on the media item 48202 in response to th determination that the media item 48202 is matching with the profile of the user. In another non-limiting embodiment of the present disclosure, the block 48302 i.e., displaying a travel button 48204 over a media item 48202 based on one or more predefined criteria comprises determining whether the media item 48202 is an authenticated media item 48202, determining whether the media item 48202 is matching with the profile of the user in response to the determination that the media item 48202 is the authenticated media item 48202, and displaying the travel button 48204 on the media item 48202 in response to the determination that the media item 48202 is matching with the profile of the user.

At block 48304, the method recites receiving an input selection of the travel button 48204. At block 48306, the method recites rendering a plurality of selectable overlays 48206 over the media item 48202 in response to the selection of the travel button 48204. The plurality of the selectable overlays 48206 is associated with the at least one travel destination. Further, each of the plurality of selectable overlays 48206 associated with the at least one travel destination is a hyperlink corresponding to a category selected from a group comprising: dining and cuisine, attractions and activities, accommodation, shopping, transportation, and travel period. In a non-limiting embodiment of the present disclosure, the block 48306 i.e., rendering a plurality of selectable overlays 48206 comprises fetching the plurality of selectable overlays 48206 from a predefined list of selectable overlays. In another non-limiting embodiment of the present disclosure, the block 48306 i.e., rendering a plurality of selectable overlays 48206 comprises dynamically generating the plurality of selectable overlays based on the profile of the user and/or the at least one travel destination.

At block 48308, the method recites receiving an input selection of a selectable overlay 48206 from the plurality of selectable overlays 48206. At block 48310, the method recites generating travel assistance content information corresponding to the selected overlay 48206. In a non-limiting embodiment of the present disclosure, the block 48310 i.e., generating travel assistance content information corresponding to the selected overlay 48206 comprises fetching information available for the selected overlay 48206 from one or more information servers via a universal travel adaptor and determining the travel assistance content information from the available information based on a profile of the user. In a non-limiting embodiment of the present disclosure, the profile of the user comprises one or more of: interests and/or preferences of the user, travel history of the user, web history of the user, profile of the user on digital platforms, interactions of the user with digital platforms, emotional and/or sentimental profile of the user, demographic details of the user and personal data of the user stored on one or more computing devices.

At block 48312, the method recites presenting the travel assistance content information to the user for planning travel to the at least one travel destination. The travel assistance content information is generated based at least in part on a profile of the user. The method further comprises receiving one or more inputs indicative of one or more actions performed by the user on the travel assistance content information corresponding to the selected overlay 48206. The method further comprises dynamically generating travel assistance content information corresponding to at least one of the plurality of selectable overlays other than the selected overlay based on the one or more actions performed by the user. In a non-limiting embodiment of the present disclosure, dynamically generating travel assistance content information can comprise updating the previously generated travel assistance content information corresponding to the remaining selectable overlays based on the one or more actions performed by the user. Further, in response to the one or more actions performed by the user on the travel assistance content information corresponding to the selected overlay 48206, the method comprises dynamically updating the profile of the user.

Furthermore, the generated travel assistance content information, the one or more actions performed by the user on the travel assistance content information can be saved and securely stored on the digital platforms providing the media item 48202 or the database 48108 or the client device 48102 to allow the user to re-access it at a later time. This also includes storing the information related to the destination, activities, accommodation, dining and cuisine, attraction, etc., which are of the user's interest, to allow the user to conveniently revisit. This can also be used to plan future travel.

In this manner, the disclosed techniques utilize advanced algorithms and data processing techniques to dynamically search, generate and provide relevant travel information to the user on the client device 48102. By analyzing various factors such as the user profile including, but not limited to, the user's interest and/or preferences, location, budget, constraints, desired experiences, and travel requirements, the disclosed techniques intelligently narrow down the search space to generate and present the most relevant and suitable information in terms of options for travel planning. Further, the intelligent and relevant generation of precise search criteria for providing travel assistance to the user significantly reduces the computational burden on the client device 48102 and improves the performance and efficiency. The client device 48102 is not required to process a vast amount of irrelevant or mismatched search results, resulting in faster response times and improved overall performance. Further, the reduced computational load also leads to optimized battery utilization, enhanced battery life and enhanced performance. Furthermore, the disclosed techniques provide real-time and updated information related to the destination, which enables the user to adapt the travel plans promptly and make informed decisions, contributing to a more efficient and enjoyable travel experience. Furthermore, by generating and presenting to the user relevant, adapted and accurate travel assistance information, the techniques minimize the need for manual searching, filtering and sorting of information. This not only saves time for the user but also reduces load and makes the travel planning process more seamless and user-friendly. Overall, the disclosed techniques provide results in the reduced search space, improved computational efficiency, optimized battery utilization, and real-time streamlined and relevant information presentation, which enhance the performance of the client device 48102 and enable efficient and effective travel planning.

In an embodiment, the one or more selectable overlays 48206 among the plurality of selectable overlays 48206 can be augmented reality overlays, which can provide digital information or virtual objects onto the real-world view of the destination. Accordingly, the disclosed techniques can be implemented and extended to virtual environments i.e., Metaverse. Further, the disclosed techniques can provide the travel assistance content information within the virtual realms that can replicate the real-world destination depicted in the media item. This can allow the user to efficiently plan and explore the destination in the virtual world. The user can engage in the activities corresponding to the destination, participate in virtual events, and explore the destination in the virtual landscapes, but not limited thereto.

In an embodiment, the user profile and other data associated to the user can be encrypted using encryption protocols to safeguard and/or prevent unauthorized access to the user information. Further, the communication between the client device 48102 and the information servers 48104 can be encrypted to secure the user's data.

Variations, combinations, and subsets of the embodiments discussed herein are contemplated and will now occur to those skilled in the art. For example, “travel button 48204” and “token 704” are functionally equivalent, facilitating the same user interaction across various systems (e.g., system 48100 of FIG. 48, systems 100, 100a, and 100b) in any computing environment to initiate the redirect connection at block 404. These components are adaptable to enhanced input devices 204 and/or input/output interface 48120. For instance, if input devices 204 include a microphone, then travel button 48204 and/or token 704 could be integrated into applications like Shazam™, which identifies media such as music, movies, advertising, and television shows from short samples. Upon media identification, the user interface can present travel button 48204 or token 704 to initiate methods 400 or 42300, contextualizing the experience relative to the identified media. For example, identifying the song “London Calling” by “The Clash” within Shazam™ can set the destination parameter at block 416 to “London.” Extending to sensory-based input devices as one input device 204, a sensor capable of detecting scents could, upon recognizing the smell of durian fruit from a New York restaurant kitchen, suggest destinations in Southeast Asia known for durian cultivation, thereby enhancing user engagement and application utility in travel planning. Furthermore, a sensory-based input device 204 in the form of a tactile sensor that can mimic human perception of textures or tactile surfaces is also contemplated. For instance, a texture-detecting input device 204 could “handle” a fabric that the sensor identifies as Irish linen or Kashmiri pashmina, and accordingly system 100 (and its variants) could suggest travel destinations such as Dublin or Srinagar, respectively, where these textiles are traditionally crafted. Thus, the detected texture can lead to locating a database association with a specific geographic location or cultural artifact.

Further variations can include integration of advanced personalization algorithms within datasets 228 and applications 224 in association with user identifier objects 128 that are capable of dynamically tailoring travel content. The algorithms can include comprehensive analytics to track pathways of users 124 through the digital storefront of intermediation engine 120 (and its variants), from initial interaction to potential travel booking, optimizing the user journey based on these insights. These algorithms can thus utilize a combination of user activity data, preferences, and demographic insights gathered during interactions between client devices 116 and intermediation engine 120 (and its variants). By analyzing these data points, intermediation engine 120 can adapt its content display and recommendations in real-time, providing travel options and related media that are relevant to their specific interests and needs. For instance, if a user frequently explores destinations in tropical climates, the storefront could prioritize showing content related to beach resorts, summer festivals, and water sports activities in similar locales. Additionally, the personalization within engine 120 (and its variants) can utilize machine learning techniques to predict and suggest new travel destinations or activities based on emerging patterns, further enhancing engagement.

It is also contemplated that travel button 48204 and/or token 704 can be deployed across any application on client devices 116 as one of a plurality of engagement buttons (also known as social engagement features). Engagement buttons can be defined as interactive tools within a digital interface that facilitate user interaction by enabling actions such as liking, sharing, commenting, or forwarding content. These buttons serve as direct calls to action, enhancing user engagement by simplifying the process of participating in social interactions and promoting content across various platforms. By integrating these features, applications can increase user involvement, extend content reach, and potentially drive more personalized and contextually relevant user experiences, thereby enhancing the overall effectiveness of digital communication strategies. Travel button 48204 and/or token 704 can thus be incorporated into or be placed alongside any existing or future suite of engagement buttons that can be deployed across any application executing on client devices 116.

It will now be understood that travel button 48204 and/or token 704 that triggers the redirect connection can be implemented in different ways, including a selectable uniform resource locator (“URL”) or in other embodiments a QR code that embeds the URL connection. Additionally, in configurations where digital media, such as images from providers like Getty Images, are used within an application, the travel button or token can be offered as a feature that accompanies the use of these media at no additional cost. This model incentivizes developers and content creators to use images with the travel button or token by providing enhanced content access, thus integrating the button as part of a value exchange where users access premium content for free in exchange for engaging with the travel-related functionalities of intermediation engine 120.

It is to be recognized that features and aspects of the various examples provided above can be combined into further examples that also fall within the scope of the present disclosure. In addition, the figures are not to scale and may have size and shape exaggerated for illustrative purposes.

1-17. (canceled)

18. An intermediation engine for generating local search results to store in a cache of a point of presence (POP) comprising:
an interface for connecting, via a core network, to:
a plurality of content platforms for hosting content tagged with a destination parameter;
a plurality of POPs each maintaining a cache and associated with an origin parameter; each POP accessible to a plurality of devices matching the origin parameter and configured to access the content;
a plurality of schema generators for generating itineraries based on flight routes between the origin parameters and the destination parameter; and
a processor connected to the interface for generating local search results to store in the cache for each POP based on:
the content hosted on the content platforms; and
the flight routes generated by the schema generators;
the local search results being accessible to the devices local to the POP via a redirect triggered within the content; the local search results including a travel schema including a selected flight route corresponding to the origin parameter and the destination parameter; and the local search results being dynamically updated when the selected flight route changes.

19. The intermediation engine of claim 18 wherein the search results include a prepopulated partial travel itinerary including at least one of departure dates or return dates based on the selected flight route.

20. The intermediation engine of claim 18 wherein the local search results further include an accommodation booking and wherein the local search results are dynamically updated when availability of the accommodation changes.

21. The intermediation engine of claim 18 wherein the redirect triggered within the content comprises a selectable uniform resource locator (URL) or a QR code.

22. The intermediation engine of claim 18 wherein the content is further tagged with an activity parameter and the local search results further include an activity booking and wherein the local search results are dynamically updated when availability of the activity booking changes.

23. The intermediation engine of claim 18 wherein the local search results include a graphical interface comprising a first tab showing the selected flight route and a second tab showing accommodation or activity data generated using the schema generators.

24. The intermediation engine of claim 23 wherein the processor is configured to use an algorithm to refine the accommodation or activity data on the second tab based on historical navigation patterns of the local search results by devices associated with the POP.

25. The intermediation engine of claim 18 wherein the intermediation engine is co-located with one of the schema generators.

26. The intermediation engine of claim 25 wherein at least one additional intermediation engine is co-located with another one of the schema generators.

27. A point of presence (POP) comprising:
an interface for connecting, via a core network, to:
a plurality of content platforms for hosting content tagged with a destination parameter;
a plurality of devices having an origin parameter and configured to access the content;
a plurality of schema generators for generating itineraries based on flight routes between the origin parameter and the destination parameter;
an intermediation server for generating local search results based on the content hosted on the content platforms and the flight routes generated by the schema generators; and
a cache for storing the local search results; the local search results being accessible to the devices via a redirect triggered within the content; the local search results including a travel schema including a selected flight route corresponding to the origin parameter and the destination parameter; the local search results being dynamically updated by the intermediation server when the selected flight route changes.

28. The point of presence of claim 27 wherein the search results include a prepopulated partial travel itinerary including at least one of departure dates or return dates based on the selected flight route.

29. The point of presence of claim 27 wherein the local search results further include an accommodation booking and wherein the local search results are dynamically updated when availability of the accommodation changes.

30. The point of presence of claim 27 wherein the redirect triggered within the content comprises a selectable uniform resource locator (URL) or a QR code.

31. The point of presence of claim 27 wherein the content is further tagged with an activity parameter and the local search results further include an activity booking and wherein the local search results are dynamically updated when availability of the activity booking changes.

32. The point of presence of claim 27 wherein the local search results include a graphical interface comprising a first tab showing the selected flight route and a second tab showing accommodation or activity data generated using the schema generators.

33. The point of presence of claim 32 wherein the processor is configured to use an algorithm to refine the accommodation or activity data on the second tab based on historical navigation patterns of the local search results by devices associated with the POP.

34. The point of presence of claim 27 wherein the intermediation engine is co-located with one of the schema generators.

35. The point of presence of claim 34 wherein at least one additional intermediation engine is co-located with another one of the schema generators.

36. A network search system comprising:
a core network;
a plurality of content platforms connected to the core network for hosting content tagged with a destination parameter;
a plurality of points of presence (POP) connected to the core network, each POP maintaining a cache;
a plurality of devices connected to each POP and associated with an origin parameter;
a plurality of schema generators connected to the core network for generating itineraries based on flight routes between the origin parameters and the destination parameter; and
an intermediation engine for generating local search results to store in the cache for each POP based on:
the content hosted on the content platforms; and
the flight routes generated by the schema generators;
the local search results being accessible to devices local to the POP via a redirect triggered within the content; the local search results including a travel schema including a selected flight route corresponding to the origin parameter and the destination parameter; the local search results being dynamically updated when the selected flight route changes.
